(19) United States
(12) Patent Application Publication
(10) Pub. No.: US 2012/0014491 A1
(43) Pub. Date: Jan. 19, 2012

(54) Nuclear fusion power plant having a liquid reactor core of molten glass that is made laseractive and functions as a tritium breeding blanket which is capable of acousticly compressing/confining fuel so that it radiates and triggers outgoing laser cascades that will reflect from the blast chamber's spherical inside wall and return like photonic Tsunamis, crushing, heating, and causing thermonuclear ignition of the fuel so that heat engines and piezoelectric harvesters can convert the released energy into electricity

(76) Inventor: Mike Deeth, Washburn, WI (US)

(21) Appl. No.: 12/803,901

(22) Filed: Jul. 9, 2010

Related U.S. Application Data
(60) Provisional application No. 61/270,649, filed on Jul. 13, 2009.

(51) Int. Cl. G21B 1/00

(52) U.S. Cl. 376/103

(57) ABSTRACT

A nuclear fusion power plant having a spherical blast-chamber filled with a liquid coolant that breeds tritium, absorbs neutrons, and functions as both an acoustical and laser medium. Fuel bubbles up through the sphere's base and is positioned using computer guided piezoelectric transducers that are located outside the blast-chamber. These generate phase-shifted standing-waves that tractor the bubble to the center. Once there, powerful acoustic compression waves are launched. Shortly before these reach the fuel, an intense burst of light is pumped into the sphere, making the liquid laser-active. When the shockwaves arrive, the fuel temperature skyrockets and it radiates brightly. This, photon-burst, seeds outgoing laser cascades that return, greatly amplified, from the sphere's polished innards. Trapped within a reflecting sphere, squeezed on all sides by high-density matter, the fuel cannot cool or disassemble before thorough combustion. The blast's kinetic energy is absorbed piezoelectrically.

### REFERENCES CITED

### U.S. Patent Documents

| | | | |
|---|---|---|---|
| 5,659,173 | August 1997 | Putterman et al. | 250/361 |
| 4,608,222 | August 1986 | Brueckner | 376/104 |
| 4,735,762 | April 1988 | Lasche | 376/102 |
| 4,634,567 | January 1987 | Holland et al. | 376/152 |
| 4,328,070 | May 1982 | Friedwardt | 376/102 |
| | | M. Winterberg | |
| 4,569,819 | February 1986 | Constant V. David | 376/101 |
| 5,022,043 | June 1991 | Ralph R. Jacobs | 372/95 |
| 7,212,558 | May 2007 | Brian J. Comaskey | 372/51 |
| US 2007/0002996 A1 | January 2007 | Neifeld | 376/100 |
| US 2004/0141578 A1 | July 2004 | Enfinger, Arthur L. | 376/100 |
| US 2007/0237278 A1 | October 2007 | Lamont | 376/100 |
| US 2008/0063132 A1 | March 2008 | Birnbach | 376/107 |
| US 2008/0037694 A1 | February 2008 | Dean, JR. et al. | 376/146 |
| US 2005/0135531 A1 | June 2005 | Ulrich Augustin | 376/100 |

### International Patents

| | | |
|---|---|---|
| WO96/36969 A1 | 17.05.1996 | BROWNE, Peter, Finlay (GB) |
| WO97/49274 A2 | 11.06.1997 | LO, Shui-Yin (AU/US) |
| PO1481848 A | 25.05.1973 | Wojskowa, et al. (PO) |

### Other Publications

“An Introduction to Inertial Confinement Fusion”, “A Case for Nuclear-Generated Electricity”, “Lasers by Siegman”, www.morgan-electroceramics.com, “Introduction to Mechanical Properties of Matter”, “Foundations of Radiation Hydrodynamics”, “Physics of Shock Waves and High-Temperature Hydrodynamic Phenomena”, “Nuclear Weapons Frequently Asked Questions by Carey Sublette”, Wikipedia.org, “Mechanical Behavior of Materials/Engineering Methods for Deformation, Fracture, and Fatigue by Norman E. Dowling”, “Nuclear Power by Harry Henderson”, “Foundations of Materials Science and Engineering by William Smith”, “Piezoelectric Ceramics: Principles and Applications”, “Reactors with Molten Salts: Options and Missions”, “Energy Harvesting Technologies”, “Single-Bubble Sonoluminescence”, “Cavitation and Bubble Dynamics”, “The Physics of Inertial Fusion”, “Laser Plasma Interactions 5: Inertial Confinement Fusion”, “Principles of Fusion Energy”

### FIELD OF INVENTION

This invention, which claims the benefit of provisional application 61/270,649, relates to the overall design and operation of a nuclear fusion power plant. More specifically, ideas from inertial confinement fusion (ICF), sonoluminescence, and piezoelectric energy harvesting are combined. The result is a reactor with better containment, lower ignition temperature, increased gain, higher thermonuclear burn yield, and more efficient energy conversion.

### BACKGROUND OF INVENTION

Energy availability has always played a role in socioeconomic development, and, according to Nobel laureate Rick Smalley, it is the single most important challenge facing humanity. The stability of each country, and the world at large, depends on the continued availability of reasonably priced energy. The per capita energy consumption in the various regions of the world correlates with each regions wealth, health and general education level. World energy consumption has increased dramatically over time and is projected to continue increasing, to meet the needs in the developing world. This growth in energy demand will be exacerbated by the almost doubling of the world's population expected to occur within the next 50 years. The proportion of electric power to total energy used is also expected to grow during this time period.

Continued dependence on fossil fuels, the primary source of energy both in the United States and the world at large, is a problem. There are several ways to screw up. We might run out or at least run low in regions with high demand. That will lead to economic disruptions and most likely to armed conflicts. Or maybe we will not run out and instead trash the planet through pollution, like the Gulf of Mexico oil spill, and global warming.

There are a lot of potential sources of alternate energy. However, only six seem to have real feasibility at making significant contributions to our energy supply. These are hydroelectric, biomass, geothermal, wind, solar, and nuclear. There are others such as tidal power and ocean temperature difference, but they are pretty low on the practicality scale, so we will focus on the aforementioned six.

Of the non-fossil fuel power sources, water power seems to have the least potential for further growth. Hydroelectric dams have already been built in the most likely places, and new ones are opposed because of their disruption of the environment.

Biofuels need land to grow on, but this means either displacing agricultural lands, which is bad for the hungry poor, or converting forests into fields, which is bad for the environment. Growing plants store carbon in their roots, shoots, and leaves. When I look at a tree I know half its dry weight comes from carbon, and that's going to end up in the atmosphere when its cut down, so there is a huge “carbon debt” embedded in biofuels.

The global geothermal heat capacity, from over a million heat pumps, is estimated at 28 GW and is growing by about 10% annually. Geothermal electric power is far less efficient and accounted for 0.3% of global electricity production in 2007, and is growing by only 3% annually. The average worldwide geothermal gradient is 25-30 degrees C. per km of depth. Outside of a tectonic plate boundary, wells would have to be drilled several kilometers deep. Geothermal fluids drawn from the deep earth may carry a mixture of gases with them, notably carbon dioxide and hydrogen sulfide. When released to the environment, these pollutants contribute to global warming, acid rain, and noxious smells in the vicinity of the plant. In addition, the dissolved gases in the hot water from geothermal sources may contain trace amounts of dangerous elements such as mercury, arsenic, and antimony which, if disposed of into rivers, can render their water unsafe to drink. And, the hydraulic fracturing process has been known to trigger earthquakes; more than 10,000 seismic events measuring up to 3.4 on the Richter Scale occurred over the first 6 days of water injection at a plant in Basel, Switzerland.

Wind and solar suffer from low energy density and intermittent supply. It is difficult to save the energy from windy or sunny days to be used on calm or cloudy days, so energy systems employing wind and solar need significant conventional backup capacity. Solar power offers clean energy and useful heating, but it lacks the concentration to feed the needs of cities and large factories.

With the exception of hydroelectric and nuclear, none of the alternatives offer concentrated dependable energy that is clean and free of greenhouse gases.

Conventional power sources kill thousands of people each year with pollution. A 1000-megawatt coal-burning power plant burns more than two million tons of coal in a year. Ironically, because coal contains radioactive trace elements, even when a coal plant uses scrubbers or precipitators to filter out 95 percent of its particulate emissions, it still introduces more radioactive material into the atmosphere than does a nuclear plant. By substituting for fossil fuel plants, U.S. nuclear plants in 1991 saved 145 million tons of coal, 265,000 barrels of oil, and 1.7 trillion cubic feet of natural gas, and in the process they keep about 430 million tons of carbon dioxide out of the atmosphere.

Emissions from burning fossil fuels (especially carbon dioxide) trap heat in the earth's atmosphere and are leading to a rise in the average world temperature. Global warming is having a devastating effect on coastal communities, agriculture, and other areas.

That leaves nuclear, but with no nuclear fission plants ordered in the United States since 1974, it is clear that growth in the American nuclear fission industry has stalled if not reversed. One reason is obviously the decline in public confidence following the accidents at Three Mile Island, Chernobyl, and, most recently, the tsunami in Japan.

Fission is just too dangerous, if nuclear power is to rescue us, it will have to be through fusion. The basic concept in fusion is to get two atoms close enough together so they merge into one bigger atom. This is accomplished by getting them close enough together so that the short-range attractive strong nuclear force overcomes the long-range repulsive electrostatic force. When two light nuclei fuse, their combined masses will generally be slightly smaller mass than the sum of their original masses. The difference in mass is released as energy according to Albert Einstein's mass-energy equivalence formula E=mc².

The risk of a runaway reaction in a fusion reactor is zero, since there is only a tiny amount of fuel inside the reactor at any one time, and fusion reactions cannot proceed without fuel. Significant deviations from the normal (optimal) operating conditions will only make the reaction rate slower and more inefficient. This is an inherent level of safety; no elaborate failsafe mechanisms are required. In comparison, a fission reactor is inherently dangerous; it typically contains enough fuel to last several years, and any deviation from the normal (precarious) operating parameters could potentially lead to a runaway meltdown situation.

The risk of radioactive contamination from fusion reactors is low since they do not require huge stockpiles of radioactive materials. In fact, in a typical fusion reaction, tritium would be the only radioactive substance. If a reactor breeds tritium at the same rate it burns tritium, a stockpile is not even necessary. Even if there is a leak, the Beta radiation (electrons) emitted from tritium are not as dangerous as fission neutrons. Electrons cannot penetrate as deeply as neutrons, and as a consequence they are harmlessly stopped before crossing the first layer of dead skin cells. Our lungs do not absorb hydrogen gas, so even breathing the radioactive tritium gas is relatively safe. In addition, the radioactive half-life is so short that after 100 years less than 1% of the radioactivity remains.

Earth's oceans contain a truly enormous deuterium energy reserve, one that could power mankind for more than a hundred billion years. The deuterium in one gallon of seawater has as much energy as 300 gallons of gasoline, and fifty cups of seawater has more energy than two tons of coal. However, it is not the deuterium, but the supply of neutron absorbing lithium, that places an upper limit on this reserves potential. Nevertheless, there is enough lithium, using only the amount dissolved in seawater, to supply the world's energy demand for 60 million years.

Even though controlled nuclear fusion has been a goal of scientists for several decades, with billions of dollars spent to develop this energy resource, it has yet to become commercially viable.

Two technical approaches to fusion power are currently under large scale research and development, magnetic confinement fusion (MCF) and inertial confinement fusion (ICF). These form the basis of a large number of fusion research programs. Magnetic confinement techniques, studied since the 1950s, are based on the principle that charged particles such as electrons and ions, i.e., deuterons and tritons, tend to be bound to magnetic lines of force. Thus the essence of the magnetic confinement approach is to trap a hot plasma in a suitably chosen magnetic field configuration for a long enough time to achieve a net energy release, which typically requires an energy confinement time of about one second. In the alternative ICF approach, fusion conditions are achieved by heating and compressing small capsules of fuel, to the ignition condition by means of tightly focused energetic beams of charged particles or photons. In this case the confinement time can be much shorter, typically less than a millionth of a second.

The current invention, Bubble-confined Sonoluminescent-laser Fusion (BSF), produces densities and temperatures comparable to ICF but with longer confinement times.

MCF plasmas at reactor conditions are very diffuse, because the maximum plasma density that can be confined is determined by the field strength of available magnets. Typical plasma densities are on the order of one hundred-thousandth that of air at Standard Temperature and Pressure (STP). The Lawson criterion is met by confining the plasma energy for periods of about one second.

In the ICF approach, small capsules or pellets containing fusion fuel are compressed to extremely high densities by intense, focused beams of photons or energetic charged particles. Because of the substantially higher densities involved, the confinement times for ICF can be much shorter. In fact, no external means are required to effect the confinement; the inertia of the fuel mass is sufficient for net energy release to occur before the fuel flies apart. Typical burn times and fuel densities are 10⁻⁹ s and 5×10³² ions/m³, respectively. These densities correspond to a few hundred to a few thousand times that of ordinary condensed solids. ICF fusion produces the equivalent of small thermonuclear explosions in the target chamber. An ICF power plant design, therefore, must deal with very different physics and technology issues than an MCF power plant, although some requirements, such as tritium breeding, are common to both. Some of the challenges facing ICF power plants include the highly pulsed nature of the burn, the high rate at which the targets must be made and transported to the beam focus, and the interface between the driver beams and the reactor chamber.

In inertial fusion the fuel is compressed and heated using driver beams. Achieving ignition requires a large amount of energy to be precisely controlled and delivered to the fuel target in a very short time, and the target must be capable of absorbing this energy efficiently. To produce net energy, the ICF system must have gain, i.e., more energy output than was used to make, compress, and heat the fuel. Driver efficiency and capsule design and fabrication are therefore important issues for an ICF reactor.

The necessary energy can be delivered to the fuel by a variety of possible drivers. The four types of drivers receiving the most research attention are solid state lasers, KrF lasers, light-ion accelerators, and heavy ion accelerators. The leading driver for target physics experiments worldwide is the solid-state laser, and in particular the Nd:glass laser. The Nd:glass laser was the first driver to deliver the power density and irradiance that ICF required, around 1E20 W/m², and it has remained in the forefront because of its high performance, reliable technology, and ease of maintenance. In addition, new Nd:glass technology, replacing flash lamp pumping with higher efficiency laser diode pumping, has recently become available.

Two types of ICF targets have been investigated known as direct and indirect drive targets. Direct-drive targets absorb the energy of the driver directly into the fuel capsule, whereas indirect-drive targets use a cavity, called a hohlraum, to convert the driver energy to x-rays which are then absorbed by the fuel capsule. In either case the capsules typically consist of a small plastic or glass sphere filled with tritium and deuterium—more sophisticated targets use multiple layers of different materials with the objective of making the process of ablation and compression more efficient. The indirect-drive method can tolerate greater inhomogeneities in driver illumination, albeit at the expense of the efficient delivery of energy to the capsule. In general, indirect targets have lower gains than direct-drive targets, and therefore require higher efficiency drivers. Indirect-drive targets are also more complex, but they impose less stringent requirements on the focusing and uniformity of driver energy delivered to the target. Direct-drive targets are conceptually simpler than indirect drive targets, and at low to medium laser intensity they have higher overall energy-coupling (laser to fuel capsule) efficiency, but at high intensity severe energy losses occur, due to laser backscatter, or reflection. (see FIG. 24)

The concept of indirect drive originated at Livermore around 1975, but most of the details remained secret for many years. The hohlraum used to support the capsule was typically a small metal cylinder a few centimeters across and made of a heavy metal such as gold. Laser beams were focused through holes onto the interior surfaces of the cavity rather than directly onto the capsule. The intensity of the laser energy would evaporate the inner surface of the cavity, producing a dense metal plasma. The laser energy would then be converted into x-rays, which would bounce about inside the cavity, being absorbed and reemitted many times, rather like light in a room where the walls are completely covered by mirrors. These bouncing x-rays would strike the capsule many times and from all directions, effectively smoothing out the irregularities that were present in the original laser beams. Although some energy is lost in the conversion, x-rays can penetrate deeper into the plasma surrounding the heated capsule and couple their energy more effectively than longer-wavelength light, so the implosion proceeds more uniformly.

The largest current MCF experiment is the Joint European Torus (JET). In 1997, JET produced a peak of 16.1 MW of fusion power (65% of input power), with fusion power of over 10 MW sustained for over 0.5 sec. In 2008, construction began on the experimental reactor ITER, designed to produce several times more fusion power than the power put into the plasma over many minutes. The production of net electrical power from fusion is planned for DEMO, the next generation experiment after ITER.

The major problems experienced with magnetic containment is maintaining effective plasma containment at ignition temperatures, finding suitable “low activity” materials for reactor construction, demonstrating secondary systems including practical tritium extraction, and building reactor designs that allow their reactor core to be removed when its materials become embrittled due to the neutron flux. Practical commercial generators based on the tokomak concept are far in the future.

The most critical shielding requirement is the protection of the superconducting coils (SCC) from excess nuclear heating, radiation damage, dose, and neutron fluence. In tokamak reactors, the SCCs operate at cryogenic temperatures (4 K). Each watt of thermal power deposited in the magnets by neutrons and secondary gamma rays requires ˜500 watts of refrigeration power to remove the added heat. For reactors designed to produce 1-10 GW of fusion power, an attenuation factor of 10⁵ to 10⁶ is required in the blanket-shield to assure heating rate limits are not exceeded in the coils. In general, an inboard shield thickness of more than a meter is required to achieve this reduction.

In inertial ablation, fusion temperatures and densities are attained within a small BB size fuel target that is blasted with a focused laser beam. If more than a few milligrams of fuel is used (and efficiently fused), the explosion could destroy the machine, so theoretically, controlled thermonuclear fusion using inertial confinement would be done using tiny pellets of fuel which explode several times a second. During these explosions the fuel really has no confinement at all, it simply flies apart, but it takes a certain length of time to do this, and until then it can fuse. The High Power laser Energy Research facility (HiPER) is undergoing preliminary design for possible construction in the European Union starting around 2010.

Problems with ICF's present stage of development are associated with the complicated and cumbersome mechanics required for aiming and firing the lasers which must be aligned to within 50 microns (less than the thickness of a piece of paper) on super-cooled targets flying on optically tracked injection trajectories several meters away, the enormous energy spikes needed to power the lasers, energy recovery, control of neutron damage, and reduction of firing time cycle. For Laser Fusion there are two critical elements on the path to achieving practical IFE. First, a reliable, durable laser that can meet the IFE requirements for efficiency needs to be produced. Second, higher gain targets that can be readily fabricated in large numbers need to be designed. One of the goals for NIF is to reduce the firing time to 5 hours. Previous devices generally had much longer cooling down periods to allow the flashlamps and laser glass to regain its shape after firing caused thermal expansion, limiting use to one or fewer firings a day. Another major challenge for NIF is to control laser-plasma interaction effects with only a modest (10-20%) energy penalty.

Most mainline systems (except for liquid-metal-wall ICF reactors, such as HYLIFE) have steel first walls, which are necessary to maintain a good quality vacuum and to endure the intense x-ray and neutron radiation. The first walls of all such reactors will be highly radioactive (2 to 5 billion curies). In addition, these first walls will require replacement every few years because of neutron-induced damage, either from helium embrittlement or from atomic displacements. Because both neutron energy and neutron population are reduced in the steel first walls of these reactors, neutron multipliers (such as lead or beryllium) or isotopic enrichment of Li-6 are usually required to achieve acceptable tritium breeding ratios. The same applies to magnetic fusion reactor chamber walls. For example, the STARFIRE tokamak walls will have a radioactivity of more than 5 billion curies and must be replaced every four or five years.

The current invention (BSF) has a “compact blanket” design, where the blanket (protective layer of neutron absorbing material) comes before the first wall, instead of after it. This alone is enough to reduce neutron-induced radioactivity in the chamber wall by several orders of magnitude.

The yields obtainable from ICF targets increase with the amount of driver energy. The rate of this increase is much greater than linear, so that any doubling of the input (driver energy) would produce way more than twice as much output (fusion energy). Ideally, to maximize efficiency, the reactor should operate at the highest yield it can withstand, even if this means operating at a lower repetition rate. As a bonus, operating at a lower repetition rate makes it easier to pump out vaporized material between pulses. But, it should be noted that, in general, the only way ICF systems can handle high yields is by using compact blankets.

The conventional scheme for inertial confinement uses the same laser for both compression and heating of the capsule. More recent work has demonstrated that significant savings in the overall energy requirements for laser drivers are possible using a technique known as “fast ignition.” Fast ignition has separate stages for compression and for heating, using one laser to compress the plasma, followed by a very intense fast-pulsed laser to heat the core of the capsule after it is compressed. At the same time, advances in solid state lasers have improved the “driver” systems' efficiency by about ten fold, almost making even the large “traditional” (volume ignition) machines practical. The laser-based concept has other advantages as well. The reactor core is mostly exposed, as opposed to being wrapped in a huge magnet as in the tokamak. This makes the problem of removing energy from the system somewhat simpler, and should mean that a laser-based device would be much easier to perform maintenance on, such as core replacement. Additionally, the lack of strong magnetic fields allows for a wider variety of low-activation materials, including carbon fiber, which would reduce both the frequency of such neutron activations and the rate core irradiation. In other ways the program has many of the same problems as the tokamak; practical methods of energy removal and tritium recycling need to be demonstrated, and in addition there is always the possibility of new previously unseen problems arising.

Despite optimism dating back to the 1950s about the wide-scale harnessing of fusion power, there are still significant barriers standing between current scientific understanding and technological capabilities and the practical realization of fusion as an energy source. Research, while making steady progress, has also continually thrown up new difficulties. Therefore the question of whether or not an economically viable fusion plant is even possible cannot be answered with certainty.

But one thing is certain, if BSF performs as expected it would not merely be better than some of our current energy producing technologies, it would be far superior to all of them. BSF is not incremental on current technology, it is a giant leap into unexplored territory. It represents a transformational technology that is capable of disrupting the status quo and changing the energy landscape. Transformational energy technologies have the potential to create new paradigms in how energy is produced, transmitted, used, and/or stored. The world needs transformational energy-related technologies to overcome the threats posed by climate change and energy security. These threats arise from our reliance on traditional use of fossil fuels and the dominant use of oil in transportation.

### PRIOR ART

U.S. Pat. No. 5,695,173 discloses a way of using acoustical energy to focus on and collapse a gas bubble suspended in a liquid. The implosion, if done correctly, is accompanied by a brief flash of light. Sonoluminescence is the term used to describe this type of energy conversion. The method described is capable of amplifying acoustic energy by more than eleven orders of magnitude, to produce brief (less than 100 picoseconds) pulses of light with wavelengths between 200 and 700 nanometers, but the bubbles described here were quite small (ambient <5 microns) and only produced about 100 milliwatts each.

U.S. Pat. No. 4,608,222 discloses a fusion method using lasers and minute (0.01-0.1 cm) hollow shells of solid density cryogenic D-T. A 500 megawatt reactor would require 10 laser units pulsing at 34/sec repetition rate.

U.S. Pat. No. 4,735,762 discloses a fusion reactor design that ignites a D-T target that is embedded in a large mass of liquid lithium, sending the lithium spalling outward to have its kinetic energy converted directly into electricity by work done against a magnetic field.

U.S. Pat. No. 4,634,567 discloses a method of manufacturing hollow glass microspheres, approximately 3 mm in diameter and coated with an ablative polymer resin tamper material of high atomic number, such as tungsten or titanium, to be used as inertial fusion targets.

U.S. Pat. No. 4,328,070 discloses a fusion method using black body radiation to ablatively drive a target trapped in a small cavity. The idea leads to greatly reduced drive power and relaxed focusing requirements. An interesting side note is that if the target is imploded at greater than 50 km/sec the photon losses through the pusher wall will be insignificant.

U.S. Pat. No. 4,569,819 discloses a way to generate electricity by detonating nuclear bombs inside of a large underground cavern. The cavern is protected from blast damage by an inner wall having a plurality of segments designed to recoil like shock-absorbers.

U.S. 2007/0002996 discloses a tabletop fusion generator using collapsing bubbles and lasers.

U.S. 2004/0141578 discloses a nuclear fusion reactor comprising a spherical reaction chamber with a mirrored interior surface filled with a nuclear fusible gas medium that is also a laser medium with means to produce a spherical acoustic wave pattern centered within the reactor chamber to produce intense acoustic compressions with subsequent radiation at the center of the chamber, sufficient to synchronously produce a spherical laser pulse focused at this center causing ignition and fusion.

U.S. 2007/0237278 discloses an inertial fusion reactor with inner and outer reactor chamber walls. Water, because of its incompressible nature, is circulated between the walls and prevents the inside wall from being blown apart by the nuclear blast. The blast energy boils the water creating steam to power turbines.

U.S. 2008/0063132 discloses a method of extracting electrical energy, in the form of high voltage DC, directly from the plasma of an ICF reactor.

U.S. 2008/0037694 discloses a system and method for creating liquid droplet impact forced collapse of laser nanoparticle nucleated cavities for controlled nuclear reactions.

WO 97/49274 discloses a method of generating nuclear fusion, whereby bubbles of a gas of about 10 micron diameter, contained in heavy water, are expanded by use of a vacuum to about 100 microns in diameter. The subsequent thermal cooling and collapse of the bubbles is augmented by a uniform pressure externally applied and acting on the bubbles through the heavy water. Symmetry in the bubbles' shape is imparted by the addition of heat from a laser as the bubbles continue to contract. High pressures and therefore temperatures are achieved, sufficient to generate nuclear fusion in specific materials.

WO 96/36969 discloses an apparatus for generating nuclear power comprises (i) a solid or liquid medium in which a converging shock wave will propagate towards a focus, (ii) shock wave generation means for launching a converging shock wave into said medium so that the shock wave converges towards the focus, and (iii) fusion fuel either distributed within the converging medium or confined to a focal cavity in said medium. The converging medium is such as to be capable of reducing the volume of a shock wave wholly by convergence of the shock wave towards a focus so that the energy per particle in the converged shock wave exceeds the threshold value for effecting fusion in said fuel.

PO 1481848 discloses a process for thermonuclear laser micro fusion, comprising the steps of recompressing a globule of solidified D-T to the order of 15-25 times by means of a precompression explosion within a time of the order of 10⁻⁷ seconds and thereafter subjecting the globule to laser radiation impulses for a duration of the order of nanoseconds thus to effect initiation of thermonuclear micro fusion process at a total compression of the order of 10³-10⁴.

R. J. Burke and J. C. Cutting, “Direct Conversion of Neutron Energy and Other Advantages of a Large Yield per Pulse, Inertial-Confinement Fusion Reactor”, proposed that an ICF target be located at the center of a large solid lithium sphere—typically 60 cm in radius—which would be entirely brought to the plasma state by a yield of 80000 MJ or more. Some of the fusion yield could be converted to electricity by work done by the expanding gas on superconducting magnetic fields and the blast would be contained with a chamber 12 meters in radius, by filling the chamber with a liquid spray.

It should be noted that direct electrostatic conversion schemes are generally only useful for recovering energy from unconfined ions. Most of the fusion energy is in the uncharged neutrons, making it unrecoverable by this approach.

In magnetic confinement schemes, like those mentioned above, neutron collisions in the first wall reduce the energy available for tritium production via ⁷Li. For this reason, magnetic fusion reactors typically must have (1) a neutron multiplier and (2) isotopically-enriched lithium. For example, the STARFIRE tokamak has a 5-cm-thick lead zircate neutron multiplier between two 1-cm-thick steel walls and, in addition, the lithium in the breeding blanket must be isotopically enriched to 60% ⁶Li. Since ⁶Li is the minor isotope of lithium, and the tokamak blanket volumes are large, such enrichment could be a major expense.

U.S. Pat. No. 5,022,043 discloses a HIGH-POWER DIODE-PUMPED SOLID STATE LASER WITH UNSTABLE RESONATOR. The idea of this patent is to use a large number of semiconductor lasers, coupled with tapered optical fibers, to deliver huge surges of pump light to remotely located gain medium.

U.S. Pat. No. 7,212,558 discloses LIQUID HEAT CAPACITY LASERS. Laser systems empowered by heat capacity technology have a high value at the present time, especially when operated in the extremely high power “burst mode” regime. This patent extends the concept of HEAT CAPACITY LASERS to include hot liquids, flowing at high speeds, as an improvement over conventional (solid state) gain medium. Related to this is, U.S. Pat. No. 6,931,046, which describes a liquid laser using Nd³⁺ glass as the gain medium.

U.S. 2005/0135531 discloses a NUCLEAR FUSION REACTOR AND METHOD TO PROVIDE TEMPERATURE AND PRESSURE TO START NUCLEAR FUSION REACTIONS. The idea introduced here is that, a spherical cavity, filled with a fluid (oil or water) and in contact with piezoelectric actuators, can create pressure waves capable of igniting bubbles of fusible fuel that are positioned at the center of the sphere, so that the initial pressure waves are amplified and electrical energy can be extracted from them using piezoelectric harvesting techniques. Unfortunately, according to Yuri Didenko & chemistry professor Kenneth Suslick, this approach is unlikely to work because the temperatures attainable in acoustically driven single-bubble cavitations in liquids will be substantially limited by the endothermic chemical reactions of the polyatomic species inside the collapsing bubble. Much of the energy of the collapsing bubble is used to tear molecules apart. The extraordinary conditions needed to initiate nuclear fusion will be very difficult to obtain by acoustically driven single-bubble cavitations in liquids such as water or acetone, Suslick says, although the possibility of fusion in molten salts or liquid metals cannot be ruled out. In fact, U.S. Pat. No. 4,333,796 describes such a reactor, using hot liquid metal, which is immune to the above problem, but locating and moving the fuel might be a problem for a reactor that requires a large spherical cavity.

The idea of using physical mechanisms to harness nuclear blast energy is not new, in the 1950s the design for a nuclear pulse rocket was investigated. The design, codenamed Project Orion, was carried out at General Atomics. The idea was to explode small nuclear warheads in proximity of a large steel pusher plate attached to the spacecraft with shock absorbers. A number of engineering problems were found and solved over the course of the project, notably related to crew shielding and pusher-plate lifetime. The system appeared to be entirely workable when the project was shut down in 1965, the main reason being given that the Partial Test Ban Treaty made it illegal.

Of all the machines that have been employed over the last 50 years in an attempt to ignite a fusion reaction (tokamak, stellarator, z-pinch, spherical pinch, magnetized target fusion, laser, ion or electron beam, spheromak, etc.) none have succeeded in producing more energy than what they consumed. As a consequence, fusion research has recently changed its direction, towards self-ignition. This requires that the a particles be retained within the plasma itself so that the heat generated by them is of such an extent to compensate for bremsstrahlung and other losses. Once ignition is achieved at one point of the plasma, it will then propagate and burn the rest of it.

As will be seen more fully below, the present invention is substantially different in structure, methodology and approach from that of the prior fusion reactors and solves the problems with other reactors in a unique way.

### BRIEF SUMMARY OF THE INVENTION

This invention, Bubble-confined Sonoluminescent-laser Fusion (BSF), tackles some of the problems that a fusion power plant must overcome in order to become commercially viable, such as: safety, construction cost, energy production capacity, power conversion efficiency, operating expenses, and expected plant lifetime.

A reactor would not be safe if it let dangerous 14 MeV combustion neutrons escape and cause long term radioactivity in the surrounding structural materials. Even low-energy neutrons are dangerous and unstable, undergoing beta-decay (n→p+β⁻+υ+0.782 MeV) with a half-life of about 12 minutes, when outside of a nucleus. To prevent this, prior to ignition, the fuel is positioned in the center of the reactor, in the blast zone, surrounded by a blanket that contains neutron absorbing lithium. It is noteworthy that, to a close approximation, the blanket's effectiveness can be determined just from its thickness and composition, without considering its distance from the fuel. The reason for this is that the average distance of an escaping neutron's flight path will be the same regardless of where the path begins. It follows that the total blanket volume can be reduced by bringing it closer to the fuel, since, for a fixed blanket thickness, the total amount of lithium required is proportional to the square of the blanket's distance from the fuel. Compared to conventional (distant blanket) designs, BSF is several orders of magnitude better at containing dangerous neutrons, and it is cheaper too, since the amount of neutron absorbing ⁶Li (the major blanket expense) can be greatly reduced (see FIG. 5), especially when you consider that the blanket contains other elements that block the path of these neutrons, slowing them down and greatly extending the time available for Li collisions.

It is believed that pre-compressing the fuel acoustically at a low (easy to compress) temperature will allow a subsequent laser compression to achieve a higher final density then would be attainable without pre-compression. This is important because a denser fuel collides more often, leading to faster burn rates, which ultimately means the confinement time for a given burn-up fraction can be lowered. There are two options for pre-compression, (1) quickly with shock waves which heat the fuel but do not suffer from compression instability, or (2) slowly (adiabatically) maximizing the density. To reach ignition temperatures the pre-compressed fuel is blasted with a laser pulse that further compresses and heats it.

After the fuel reaches a minimum ignition temperature self-heating takes over and the temperature rapidly climbs. During the self-heating period the ignited fuel is unable to cool; its atoms are still confined, unlike the situation in ICF where the fuel immediately disperses. In BSF, the fuel is surrounded by an imploding wall of dense viscous liquid that confines it for a longer period of time; any outwardly directed expansions must first overcome the inwardly directed kinetic energy of the acoustic compression. Even electromagnetic energy is prevented from escaping the local vicinity; x-rays are absorbed by the lead in the blanket which causes local ionization and increased pressure, other frequencies are transparent to glass but get reflected from the sphere's shiny metal innards and return a few nanoseconds later. Breakdown occurs in the high-z material that surrounds the fuel, resulting in an increase in the local pressure because each additional ionized electron must reach thermal equilibrium (average kinetic energy) independent of the other particles. This causes the high-z material to expand in volume, compressing the low-z material. For example, consider a situation in which a volume of fuel (D-T atoms) is surrounded by Pb atoms. If these two regions start off with equal particle densities and they are quickly heated to a state of complete ionization, then the total number of particles in the D-T region would double (1 nucleus+1 electron) but increase 83 fold (1 nucleus+82 electrons) in the Pb region, making the Pb region expand, compressing the D-T region by a factor of about 41. Furthermore, if fuel is initially a gaseous bubble (with a relatively low particle density) surrounded by liquid Pb, then the final fuel compression would be even greater, a product of the initial ratio of particle densities and the differential ionization compression factor.

The extended confinement time allows the fuel to self-heat. Electrically charged fusion products (ions and electrons) quickly thermalize (give up their kinetic energy) locally. Neutrons, being uncharged, interact less and thermalize farther away. Even so, most neutrons will thermalize in the not too distant neighborhood, because of the increased density, which shortens the average free path flight distance, and because of the absorption, reflection, and moderation properties of the Li, Pb, and H. In addition, the fuel will be unable to cool efficiently by electromagnetic radiation since the sphere's polished metal surface reflects back into the fuel which is located at the center focal point of the sphere. This lowers the ideal ignition temperature from 4.3 keV (ICF) to 1.6 keV (BSF), and makes volume ignition of the fuel possible. (see FIG. 12)

During combustion, one neutron is released per tritium (D+T→⁴He+n). These neutrons are absorbed in the blanket and transmute (n+⁶Li→⁴He+T) back into tritium, restocking the tritium fuel supply. The net result is that deuterium and lithium are burnt exothermically (22.37 MeV) producing helium and tritium. Due to ⁷Li fragmentation and Pb neutron multiplication, BSF is expected to produce significantly more tritium than it consumes, giving BSF an advantage over ICF. The reason for this is that BSF neutrons go directly into the blanket, whereas the neutrons in ICF must pass thru several centimeters of metal (first wall) before even reaching the blanket, and on their journey across they decrease in both number and energy.

Attaining tritium self-sufficiency might be fusion's most difficult challenge. There are no practical, external sources of tritium, so fusion plants must breed their own; current inventories are extracted from heavy-water reactors, which produce 1.7 kg/year, and this supply will peak around 2025 at a mere 27 kg, enough to run a 1GW fusion plant for six months. Ironically, for an unlimited fuel source, fuel supplies (short-term) will determine how quickly fusion plants can be brought online and how effective fusion can be toward addressing our current worldwide energy crisis. Two key parameters, that influence how long it takes to produce enough tritium for a subsequent plant's start-up, are the fractional burn-up rate (low burn-up fractions require extra fuel-cycles, leading to higher retention-times and greater fuel losses through beta decay) and the trapped (inside the blanket) inventory size. Due to BSF's compact blanket, it has a higher tritium breeding ration, smaller trapped inventory, and larger burn-up fraction than other fusion methods, making it fusion's best hope for quick widespread implementation.

BSF can achieve a higher power conversion efficiency than conventional power plants that rely solely on thermal cycles. The reason for this is that heat engines are notoriously inefficient. The theoretical maximum efficiency of any heat engine depends only on the temperatures it operates between. An ideal heat engine such as the Carnot heat engine has a maximum theoretical efficiency of: 1−(cold temp.)/(hot temp). In the real world, mechanical friction and engine heat loss prevent achieving this ideal limit. For modern fossil-fuel plants that operate at 500° C. (770° K) the theoretical maximum efficiency is 59% but after losses the overall efficiency is about 40%. Nuclear fission power plants, which operate at a lower temperature (670° K) to avoid damaging the fuel rods, can only achieve overall efficiencies of around 30%. BSF has the potential for operating at a much higher temperature, the consequence of hotter burning fuel and plumbing that is located safely outside the burn zone. In fact, BSF has to run hotter just to prevent its coolant from freezing. But most of the gain in efficiency is expected to come from BSF's piezoelectric energy harvesters, which get hammered by a large portion of the blast's energy and have conversion efficiencies of over 70%.

Caution needs to be taken when operating at high temperatures, thermal conduction and radiation heating can ignite some grease or oil lubricants (ignition typically in the 260 to 370° C. range), many types of paints (ignition typically in the 245 to 455° C. range), some types of electrical wiring insulation (typically, 425 to 590° C. surface temperature range), and other combustible materials. The FLiBe temperature could also decompose concrete, so providing an insulation barrier, such as metal liners, in the design should be examined.

In addition to what was mentioned above, BSF has laser diodes that pump directly into the hot glass that circulates through the sphere. This makes all of the laser energy available for thermal recovery, unlike the situation in ICF where external flash tubes create significant amounts of non-recoverable low level waste heat.

It is an additional object of the invention to be scalable and to accommodate large yields. The only other mainline high-yield ICF reactor proposal is HYLIFE. Others are limited to lower yields by blast-wave constraints or by x-ray erosion of the chamber wall. With high fusion yields, operation at much higher target gains is made possible, leading to lower recirculating power fraction and higher net plant efficiency.

BSF utilizes a fundamentally different approach to blanket geometry and energy conversion, which makes possible a unique combination of high efficiency, high power density, and low radioactivity. By turning the conventional blanket “inside out” (i.e., the containment system is outside the lithium moderator), and choosing a blanket geometry that produces the maximum shock-induced kinetic energy and maximum neutron absorption per unit mass, it is possible to contain very large fusion yields in a structure that is mostly transparent to the kinetic blast and well shielded from neutron-induced radioactivity.

Another advantage BSF has over ICF is that it does not require a timeout for cool-down and recovery after each firing. The high precision laser optics that ICF uses must cool for several hours between firings to recover from thermal expansion. BSF has a firing cycle that is limited only by how fast the fuel can be fed into the center of the reactor.

In order to get a uniform compression the fuel must be compressed simultaneously and with equal force on all sides. ICF addresses this problem by using 192 individually focused laser beams. BSF solves the problem by compressing with spherical waves which by their nature completely cover all directions of space uniformly.

The problem of maintaining a durable long-life container is nullified—the coolant used in BSF functions as a temporary, regenerative container, encapsulating the fuel. As a bonus, this eliminates the cost of fabricating an unending supply of expensive throw-away target pellets. Fuel detonation only occurs where it is safe, at the center of the sphere, after being transported there by flowing coolant and acoustic pressure. When the fuel ignites, everything in the vicinity turns to transient plasma that harmlessly remolecularizes and is recycled. The metal sphere functions as a secondary containment structure, well protected behind several meters of glass. The glass mixture contains lithium that protects the metal sphere by absorbing neutrons. It also contains lead that absorbs x-rays and prevents the surface of the sphere from being vaporized by the intense radiation that accompanies each thermonuclear explosion. The reactor chamber resides within a larger spherical structure. The inside surface of the larger structure is covered with ceramic tiles (the piezoelectric transducers), and an incompressible liquid coolant fills the gap between the tiles and the blast chamber, making the blast chamber walls more or less transparent to the intense shock waves that follow thermonuclear detonation. In addition, the metal sphere has its own internal circulation system to prevent overheating which can lead to structural fatigue. Taking all this into consideration, it can be shown that the blast chamber can easily withstand the required impulse, even if it is constructed of ordinary materials.

The reactor chamber and circulation system have no moving parts, so they should be maintenance free, and because they are well shielded from nuclear damage they should last for hundreds of years, unlike other reactors which need periodic core replacements. The significance of this should not be ignored, chamber walls exposed to damage rates of 35 dpa/yr (displacements per atom per year) will require replacement every 5-7 years. Assuming that only the inner structural walls need to be replaced at 30% of the original reactor vessel cost, then about 5% of the plants lifetime must be devoted to replacement activities.

Their are two primary fuels being considered. The first is a gas composed of deuterium and tritium. Gases in general are highly compressible and easier to heat to high temperatures. The second is a liquid, lithium hydride, composed of tritium and deuterium isotopes. This has the advantage of a higher starting fuel density, even higher than liquid hydrogen.

If a suitable molten salt cannot be found, then the coolant would most likely be a glass mixture composed of Si (Silicon), O (Oxygen), Li (Lithium), Pb (Lead), and a rare earth element possibly neodymium. Neither of the fuels being considered will react chemically with the glass mixture. With the exception of lithium, the elements in the glass mixture have low neutron absorption cross sections. Therefore the glass will not be contaminated with unwanted transmuted elements. Both oxygen and lead have “magic” nuclei and are very stable. Of all glasses, flint glass (glass with a high lead content) is the best electrical insulator and is also a very good thermal insulator. These are ideal qualities, preventing the fuel from rapidly cooling. The lead lowers the softening temperature of the glass, making it roughly 100 times lower viscosity than ordinary soda glass. Dissolved bubbles are not trapped, they quickly rise to the surface during degassing, and the mixture's minimum circulation temperature is lowered. A lower temperature reduces the amount of “thermal line broadening” (AKA Doppler smearing), making higher laser gains possible.

### Firing-Cycle Timeline (Example: 15 Second)

T=−10, a bubble of fuel is injected into the middle of the feed pipe below the base of the sphere and flows upward with the molten glass “coolant” mixture. T=−5, the bubble enters the sphere. Piezoelectric transducers begin oscillating, creating either standing waves or pressure gradients to guide the bubble, like a tractor beam. T=−5 to −0.005, the rising bubble is guided by several things: Gravity (fuel is lighter than glass), toroidal convection currents (the result of cooling the sphere's outer shell), coolant flow (in at the bottom and out at the top, and faster in the center of the feed pipe), acoustics (pressure gradients create buoyancy forces). T=−0.005, the piezoelectric transducers surrounding the outside of the sphere and submerged in a cool bath of hydraulic fluid launch a series of powerful compression waves. T=−0.0005, laser diodes, which shine through fiber optic cables into the sphere, are turned on. The light that is not immediately absorbed is quickly reflected multiple times from the highly polished, electroplated, surfaces inside of the sphere. This guarantees that everything inside the sphere is saturated with laser light and leads to a population inversion in the rare-earth elements. T=−0.00005, as compression waves arrive they cause a sonoluminescent flash in the fuel. For a tiny bubble, the burst would be extremely bright, since its radiant intensity is proportional to the forth power of its absolute temperature, and extremely short, lasting about 100 picoseconds with frequencies distributed in correspondence with the fuel's blackbody radiation temperature. If we could watch, this 100 ps pulse of light would form a spherical shell ˜2 cm thick speeding away from the fuel, taking about 20 nanoseconds to reach the reflective surface of the sphere 5 meters away. T=−0.00005 to 0, the photons emitted from the hot fuel pass through the saturated mixture and become amplified as they travel, this is the “super radiant laser” effect. When these photons return from the spheres internal reflective surface, things get complicated. The hydrogen becomes metallic and is no longer transparent. Ponderomotive forces squeeze the fuel, and resonance absorption increases. Inverse Bremsstrahlung photon absorption converts laser energy into thermal energy via electron-ion collisions. The glass breaks down due to self-focusing. The fuel gets hot. etc. T=0, thermonuclear ignition occurs. Everything within a few centimeters of the fuel becomes extracohesive (plasma at solid density). T=0 to 5, after ignition, about half the energy is in the form of a thermonuclear blast pressure wave that exits the blast chamber and gets absorbed after traversing the inter-chamber hydraulic fluid by a wall of piezoelectric crystals that are stacked and tiled so as to efficiently harvest kinetic energy. The rest of the energy, in the form of superheated molten glass, gets pumped out of the reactor and into heat exchangers to feed turbines. In addition, because the laser diodes output was pumped directly into the reactor it can be reclaimed in the thermal cycle, instead of contributing to “low grade” waste heat. After the impulse, piezoelectric harvesters prevent the wall from alternating in tensile and compressive stress due to under-damped ringing. If unchecked, this “ringing” could shorten the useful fatigue lifetime of the chamber wall.

T=5, end of cycle.

DETAILED DESCRIPTION (Table of Contents)

| | |
|---|---|
| Optical properties inside BSF's reflective sphere | [0079] |
| Low temperature volume ignition | [0085] |
| Fuel detection (horizontal x & y) | [0090] |
| Fuel detection (vertical z-axis) | [0098] |
| Acoustic transport of fuel | [0103] |
| Fuels | [0120] |
| Coulomb barrier | [0139] |
| Nuclear reactions | [0144] |
| Combustion | [0158] |
| Radiation implosion | [0165] |
| Advantages of compression | [0169] |
| Methods of compression | [0171] |
| Lawson criterion | [0182] |
| Gas laws | [0191] |
| Target design | [0224] |
| Rayleigh-Taylor Instabilities | [0226] |
| Yields | [0239] |
| Coolant (circulation speed) | [0254] |
| Other coolant materials | [0265] |
| Blanket Neutronics | [0279] |
| Tamper and target design | [0290] |
| Ionization | [0295] |
| Differential ionization assisted fuel compression | [0299] |
| Acoustic waves | [0307] |
| Shock boundary crossing & reflections | [0320] |
| Spherical compression | [0329] |
| Sonoluminescence (maximizing) | [0346] |
| Opacity | [0352] |
| Lasing | [0364] |
| Laser Diode Pumping | [0401] |
| Gain material (selection of) | [0406] |
| Potential Problems with Large, Hot, Spherical Laser Cavities | [0411] |
| Breakdown and heating of a gas under the action of a | [0418] |
| concentrated laser beam | |
| Absorption of a laser beam and heating of a gas after initial | [0425] |
| breakdown | |
| Laser Heat & Pressure | [0430] |
| Interacting Laser Energy (ICF vs. BSF) | [0440] |
| Thermal conductivity | [0444] |
| Specific heat capacity | [0459] |
| Thermal expansion | [0462] |
| Chemical properties compatibilities | [0467] |
| Glass | [0473] |
| Tritium breeding | [0488] |
| Piezoelectricity | [0495] |
| Energy Harvesting | [0527] |
| Degassing | [0537] |
| Units & Standards | [0544] |
| BRIEF DISCRIPTION OF VIEWS | |
| DESCRIPTION OF THE PREFFERED EMBODIMENTS | [0545] |
| CLAIMS | |
| ABSTRACT | |

### Optical Properties Inside BSF's Reflective Sphere

One of the most significant advantages that BSF has over ICF is its superior containment, both of matter and of energy. As a result, the fuel in a BSF reactor can be ignited using less energy and burnt more thoroughly, producing higher gains. There are obvious reasons for the claim that BSF has superior fuel containment ability, but what justification is there to support the claim of BSF's superior energy retention?

In a BSF reactor, the fuel is located deep within a transparent liquid blanket. Radiant energy cannot escape from the vicinity of the fuel unless the blanket (ie. glass) is transparent to radiation of that frequency. This situation creates an energy barrier at the fuel-glass interface, a type of green-house effect. Initially the fuel absorbs a large influx of laser energy coming from specific rare-earth elements in the doped glass mixture. After absorbing this narrow-band energy, the heated fuel reradiates in a broad-band spectrum, but since the glass and fuel are not equally transparent in all frequencies, energy gets deposited where the two meet. This ionizes the boundary layer of glass and smooths Rayleigh-Taylor instabilities. In addition, ionization produces extra electrons that as particles, each, contribute equally to the local pressure, and intensify the matter-containment grip, like a boa constrictor.

Even if the fuel is emitting electromagnetic radiation transparent to glass, the fuel will still not cool unless this radiation escapes another energy barrier, the reflective sphere, which is perpetually returning EMR to the fuel.

The efficacy of this reflective energy-retention mechanism depends on several things: the size of the fuel bubble, the distance of the fuel from the center of the sphere, the material used for constructing the mirror, and the quality of the mirrored surface. (see FIGS. 7, 8, 11)

Almost any metal could be used for the sphere's shiny inside surface. When matter is in a metallic state, the outermost electrons are so loosely bound that they become free. In metals at room-temperature these free electrons form a plasma, which is a true Fermi gas. This electron plasma accounts for the conductance and reflectivity of metals.

An observation worthy of attention, is the fact that, because of spherical geometry, a ray of light inside the sphere has its path confined, bouncing on a single plane that it cannot leave. That plane is determined by the ray's origin, the first point of reflection, and the sphere's center. A close examination reveals that if a ray of light passes close to the center it will return after two reflections, revisiting the same approximate location. This observation appears prominently in the simulation results (FIG. 11), which show an unexpectedly high two-reflection reabsorption rate. This (high two-reflection reabsorption rate) improves the sphere's overall energy retention ability, allowing off-center target ignition. Also, since there is extra leeway to position the fuel, a less stringent control system is required.

### Low Ignition Temperature Makes Volume Heating a Viable Option.

Thermonuclear ignition and burn of a plasma occurs when internal heating by fusion products exceeds all energy losses such that no further external heating is necessary to keep the plasma in the burning state. Ignition requires a certain temperature, depending on the fusion fuel and the relevant loss mechanisms. Here we show the ideal ignition temperature of a deuterium-tritium plasma when we restrict ourselves to electro-magnetic radiation losses by bremsstrahlung emission. Certainly there are other important loss mechanisms, like thermal conduction and mechanical work, which tend to increase the ignition temperature, but at temperatures below 5 keV these other loss mechanisms are, in comparison, insignificant toward cooling, and so, it is in this sense that the term ideal is used.

A power balance relationship exists between the heat gained by fusion alpha-particles and that lost due to Bremsstrahlung cooling. Self-heating and ignition take place when the temperature exceeds this balancing point (the red dots, in FIG. 12). For ICF, the ideal ignition temperature is 4.3 keV. In comparison, BSF ignites at 1.6 keV. The reason they differ by so much is that BSF prevents radiant losses through the use of an internal reflective mirror which enables most of the radiant losses to be reabsorbed. The idea behind Radiant Energy Reabsorption is to slow losses down enough so that self-heating can cause an accumulation that leads, through positive feedback, to an eventual ignition.

The gain resulting from uniform heating can be estimated as [Gain]=[17.6 MeV/9.6 key]*[burn efficiency]*[laser coupling efficiency]. Here the 17.6 MeV fusion energy released by a DT reaction is divided by the thermal energy of two ions and two electrons at 1.6 keV, 4(3/2)1.6, and then, even if we plug in the much lower values of burn efficiency (˜0.3) and laser coupling (η=0.1), taken from an old ICF source, we still get a gain of 55, which is much more than the gain of 30 required for large scale commercial power production.

But we expect to do much better. Large and dense targets can be optically thick, so that DT ignition occurs at temperatures as low as 1 keV, well below the ideal ignition temperature of 4.3 keV. Such low temperature ignition partially compensates for the disadvantage of whole fuel heating. Recent advances in laser diode technology make 75% electrical-to-optical efficiencies typical, and, unlike the situation in ICF, where the fuel instantly flies apart, BSF's fuel cannot disperse, so a larger percentage of the fuel should burn. In fact, the burn efficiency for non-cryogenic, high-gain, room temperature, high-pressure gas, volume ignited targets, according to results from Lawrence Livermore National Lab in 2008, should be 50% or greater. If we use the more realistic values of η=0.5 and Burn=0.6, then Gain=550.
Note 1—it is important to notice that both the heating power-gain and the cooling power-loss depend only on the temperature and the square of the density. The n² dependence is due to the fact that both fusion reactions and bremsstrahlung emission involve the encounter of two particles. The power balance is therefore determined uniquely by temperature, independent of density.
Note 2—Bremsstrahlung is the main mechanism of radiation emission, with a volumetric power loss of 5.34E−23 n² T^{0.5} erg/s/cm³.
Note 3—BSF's lines run parallel to ICF's because the scale is logarithmic and the values are multiples of each other. BSF's 98% reabsorption is equivalent to reducing ICF's losses to only 2% of its normal value. The numbers on the right side of the diagram are the percent reabsorption, and these values are in the range of results arrived at through computer simulations (FIG. 11) of bubble size, bubble offset, and mirror quality, for gold & silver plated 5-meter radius mirrors.
Note 4—the calculation for alpha-particle heating can be found on page 19 of “The Physics of Inertial Fusion.” It has less than 0.25% error for temperatures ranging from 0.2 to 100 keV.

We see that in comparable cases for the same laser energy, the radius of strongest compression is much larger and the efficiency is much lower for spark ignition than for volume ignition. The difficulties of spark ignition were described by the initiator of the isobaric spark-ignition scheme himself, Meyer-ter-Vehn 1996. Volume ignition works like a diesel engine, and there is—apart from the favorable reabsorption of bremsstrahlung because of the very low temperature—a large amount of “additional driver energy” coming from self-produced alpha-particle reheating. Detailed calculations (Li & He, Martinez-Val et al, 1994) include additional self-heating by neutrons, and, instead of assuming local thermal equilibrium, they find the ions are at a much hotter maximum temperature, for example of 200 keV, with electrons having only 80 keV and the background blackbody radiation 8 keV.

### Archimedean Spiral Detector

BSF is very tolerant of fuel positioning misalignment (FIG. 11). Even if the fuel is located several centimeters from the sphere's center the ignition proceeds with no significant degradation. This is a significant advantage over direct-drive ICF, which requires that the laser be focused within 50 microns of the fuel. Still, for BSF, a question remains, how can anything, and especially a tiny transparent bubble of fuel, be located when its deep inside the reactor, buried within several meters of molten glass?

Although sound (sonar) could be used to track the bubble's position, a more obvious choice uses light. However, to be effective, the light should have a wavelength that is transparent to molten glass and be different from the background thermal radiation that is constantly being emitted from the hot glass. Furthermore, it might be advantageous to transmit and detect in multiple frequencies, as this would allow the sensors to operate at higher sampling speeds with less signal interference. Light from a deuterium arc lamp would probably make an excellent source, since the frequency match between emitter and absorber is in this case perfect.

You would think that, in this harsh environment, designing the optics necessary to pinpoint the fuel accurately from fifteen meters away would be problematic. Fortunately, BSF's method of detection, called multi-occultation triangulation, does not rely of precision optics. This method does not form images like a camera, it mathematically constructs a picture of the bubble using direct line-of-sight information, neither lens nor mirrors are used. It gathers information in a binary yes/no format, either a sensor sees the pulse of light emitted or it doesn't. An occultation is an event that occurs when one object is hidden by another object that passes between it and the observer. In this case, an occultation occurs when the bubble of fuel blocks (absorbs or deflects) some of the light coming from a single specific optical-fiber emitter so that at least one of the sensors located on the opposite side of the sphere can detect the missing pulse. It is this, absence of light, that signals the presence of fuel. During a multi-occultation event an objects position can be found by triangulation.

Locating the bubble's position to millimeter resolution requires using an array containing hundreds of emitter/detector elements. Each element must either detect the light conditions on the inside and transmit them for analysis to the outside, or transmit externally generated signals (pulses of light) to the inside, or both. The signals are carried through fiber optic cables, and each fiber terminates inside the sphere after passing through a fiber-filled pinhole aperture, an eye on the inside. These fibers should be arranged in a pattern that maximizes coverage, while at the same time, minimizes over-sensing (a redundant condition where a large number of emitter/detector pairings correspond to a small volume of space). After testing several patterns, including squares, hexagons, and concentric circles, it was found that an Archimedean spiral (FIG. 6) had the best, most uniform, distribution of sense locations throughout the sphere's entire inside area. (see FIGS. 13, 14, & 15)

Because the inside of the sphere is so highly polished, false sensor readings can occur; an echo (reflected pulse) might get confused with an initial pulse. However, this can be avoided if the pulses are sampled in a sufficiently short window-of-time and/or each pulse is followed by a damping (die-off) period. Since it takes light about 300 ns (speed of light in glass with index ˜1.5)(2×30 m) to make one round trip between the top and bottom sensors, an echo will lag behind the initial pulse by 300 ns. This leaves plenty of time to distinguish an echo from the initial sensor pulse, since lasers can switch on/off in less than 3 nanoseconds. In fact, by time-multiplexing, a whole barrage (about 100 pulses from 100 different emitters) could be sent in one burst without fear of echo interference. After such a barrage, a sensor time-out period would be required so that the inside of the sphere could return to darkness. How quickly the signal fades depends mostly on the mirror quality. If the signal strength diminishes by 5% after each reflection then after 15 microseconds it will have reflected one hundred times and the intensity would be reduced to 0.5% (0.95¹⁰⁰) of its original intensity.

After the bubble is initially located, it is no longer necessary to scan the entire sensor field. Future scans should be restricted to the bubble's perimeter, because changes in occultation occur there and nowhere else. This, narrowing of the field, would lead to a tremendous speedup in the number of scan-iterations per second, because the only emitter/sensor pairs worth scanning are those having line-of-sight paths that cross close to the bubble's current perimeter. This would allow a complete picture of the fuel boundary to be taken several thousand times per second, so that the dynamics of these bubbles could be studied in real time and in great detail.

In contrast to the durable, well protected, spiral detector of a BSF reactor, the final optics of ICF reactors are vulnerable, exposed to shrapnel, condensation, neutrons, soft x-rays, and hot plasma can erode their surfaces, so they would need periodic replacement. Designs using Direct Drive have less of a shrapnel threat, but more transparent vacuum chamber interfaces than Indirect Drive. Activation may affect maintenance procedures, and hence the projected Cost Of Energy, which is inversely proportional to the fractional time the plant is able to operate. Activation issues can also affect decommissioning.

The biggest problem for ICF's final optics is that there is no scheme yet proposed for either Direct Drive or Indirect Drive that has complete credibility. Optics protection is still one of the weak areas for laser driven ICF.

### Conceptual Layout of Vertical Linear Sensor Arrays

Although the reactor is designed with hi-resolution spiral sensor arrays residing at the top and bottom, the exact location of a bubble can still be hard to pinpoint if it is close to the center of the reactor, because there is a higher degree of triangulation uncertainty caused by small angle approximation errors as the bubble moves farther away from the sensor elements.

To a large extent, the vertical linear sensor arrays (VLSAs) are responsible for finding the z-component of the bubble's location—the horizontal x & y components are found using the spiral sensors. Higher-resolution sensing can be achieved by turning individual fibers in a bundle on/off. The VLSAs are dual purpose, a secondary role is to supply the laser pump flux.

FIG. 10 shows a bubble starting to pass between sensor elements F5 and F7, blocking the light that would normally pass between them. This occultation will be detected when this pair of sensors/emitters gets scanned during the next sensor sweep.

The arrows in FIG. 10 are meant to represent the flow of fluid by natural convection currents, caused when hot glass comes into contact with the cooler metal of the sphere.

FIG. 9 shows where the F-crosssection of FIG. 10 is taken from (dotted box), and how multiple VLSAs can be combined. Each VLSA has a narrow field-of-view, taken from a specific viewing angle. These views combine, overlapping in the center, so that even if a bubble of fuel is not in the exact center of a vertically rising glass column, it will still be likely to detect it by at least one of these arrays. In addition, having multiple arrays increases both the sensor resolution and the maximum rate of laser pumping.

### Fuel Movement & Positioning

The inside of an active BSF thermonuclear reactor is an inhospitable place, to reach the center requires passing thru five meters of molten glass, and no physical object can withstand the intense pressures and temperatures that accompany a detonation. So how can a bubble of fuel be quickly and accurately positioned dead-center before each blast without destroying the positioning mechanism?

The answer is that the bubble's placement is controlled remotely using acoustic pressure that is generated from a safe distance away.

There are other ways of transporting the fuel. For instance, the fuel could be encapsulated at one end of a rod made from solidified coolant of sufficient length to span the width of the reactor. In this form, it could then be inserted directly into the sphere, like a large artillery shell being rammed into a gun's firing chamber. Another way of getting fuel to the center is by controlling the 3-dimensional flow of coolant inside of the sphere, using valves that regulate the flow coming from multiple inlets and going to multiple outlets. In this scenario the fuel would bubble up from the base of the sphere and be carried along with some quantity of displaced coolant. But, both of these fuel transport methods have problems in that their control mechanisms would be exposed to harsh environmental conditions. In addition, the first method limits the choice of coolant to materials that can be cast into solid rods of suitable quality, and the second method might have a difficult time coping with fluid turbulence.

The preferred method of fuel locomotion is via acoustical transport. The underlying idea is based on the observation that when a bubble is immersed, or exposed to variations in pressure, it will rapidly accelerate until it reaches a terminal velocity V_{T}. The terminal velocity is determined by a balance between the buoyant force F_{B}, and the drag force F_{D}. At the terminal velocity, F_{B}=F_{D}.

Buoyancy is what causes boats to float. Fluid pressure increases with depth below the surface, so that submerged objects will feel different pressures on their tops and bottoms, with the pressure on the bottom being greater. This difference in pressure causes the object to be pushed upward, the normal direction when gravity is involved, but buoyancy can be artificially created and made to point in any direction. The buoyancy force is:

F_{B}=(ρ_{B}−ρ_{G})g(4/3)πr³

The other force controlling the bubble's terminal velocity was drag, which depends on the fluid viscosity μ, bubble radius r, and velocity v. The drag also varies, indirectly, with temperature and pressure. According to Stokes' Law, the frictional drag force is:

F_{D}=6πμrv

If a particle is rising or falling in a viscous fluid by its own weight due to gravity, then a terminal velocity is reached when this frictional force combined with the buoyant force exactly balance the gravitational force. The resulting velocity is given by:

V_{T}=(2/9)[(ρ_{B}−ρ_{G})/μ]gr²

where:

F_{B} is the force due to the difference between weight and buoyancy (in N)

F_{D} is the frictional force acting on the bubble/fluid interface (in N)

ρ_{B} is the density of the bubble (in kg m⁻³)

ρ_{G} is the density of the glass (in kg m⁻³)

g is the acceleration of gravity (in m s⁻²)

r is the radius of the bubble (in m)

μ is the viscosity of molten glass (in kg m⁻¹ s⁻¹)

v is the velocity of the bubble (in m s⁻¹)

V_{T} is the terminal velocity of the bubble (in m s⁻¹)

The reason large bubbles rise faster than small ones (FIG. 16) is that the drag force is proportional to cross-sectional area (r²) while the buoyant force is proportional to volume (r³). Drag is felt along the entire surface area of contact. Viscosity is a measure of this adhesive/cohesive or frictional fluid property that is responsible for the resistance to flow that appears when layers of fluids attempt to slide by one another.

When an object accelerates from rest its velocity can be written as a function of time:

v(t)=V_{T}[1−ê(−gt/V_{T})]

which asymptotically approaches the terminal velocity V_{T}. If we integrate this expression with respect to time, we get the total distance traveled as a function of time, thus:

d(t)=V_{T}t−(V_{T}²/g)(1−ê[−gt/V_{T}])

A liquid that is held stationary in a gravitational field will develop a pressure gradient, ∇P=ΔP/Δs=ρg, where s is the submersion depth, ρ is the density of the fluid, and g is the strength of gravity. There are other ways to produce the same pressure gradient, for instance, by using a centrifuge, or, as in the case of BSF, by using acoustic waves.

If BSF uses 500 Hertz acoustic waves for its method of bubble locomotion, the bubbles would change directions 500 times per second. They would also pulsate at this same frequency, moving slowly when compressed and quickly when expanded. (FIG. 17) A high-speed close-up view would show the bubble ratcheting toward its destination, a fraction of a millimeter at a time. Even though the bubble spends exactly half of its time being pushed in one direction and the other half being pushed back in the opposite direction, the bubble can still be positioned anywhere we desire because it travels faster when heading in the direction we want it to move.

For small bubbles, the natural oscillating resonance has a much higher frequency than the pressure fluctuations used to control the bubble's size and motion, but these high-speed oscillations quickly fade out due to the influence of fluid viscosity and sound being radiated away, so that after the bubble reaches equilibrium it will only feel the influence of the pressure gradient, which acts upon it like an artificial gravity source.

The natural, gravitational (g=−9.8 m/s²), pressure gradient in a molten glass (ρ=3860 kg/m³) BSF reactor would be, ∇P=37828 kg m⁻² s⁻². To create this same gradient acoustically, using a 500 Hertz triangular wave, would require that the gradient change from +g to −g once every 10 meters of wavelength, so each of these background pressure gradients would span 5 meters and have a pressure swing ΔP from start to finish of 5*∇P (1.86 atmospheres). The piezoelectric actuators used in BSF are capable of producing pressures of over a million atmospheres, so there should be no trouble creating artificial g-forces greater than this 1 G example. In addition, it is a simple matter to temporarily increase the ambient pressure throughout the reactor, so that greater pressure swings would be possible. For example, if the ambient pressure is increased to 60 atm then the same 500 Hertz triangular waveform could produce a pressure gradient that is equivalent to 10 Gs. Furthermore, it is not unreasonable to expect a BSF reactor to withstand this amount of pressure, other reactors (high-pressure fission) routinely operate beyond 300 atm.

Molten glass (silicon based) is not the best fluid to achieve high-speed bubble locomotion, it has a viscosity of ˜10,000 Pa s @750° C., a million times thicker than water at 20° C., 0.01 Pa s. Nevertheless, even in molten glass, controlled 1+ mm per second movement is possible. This, however, is inadequate for BSF. So, unless this method of acoustic bubble transport can be improved, the reactor will need to use a cooling fluid that is a little less viscous.

FLiBe at 615° C. has the same viscosity as water. This makes it possible for even tiny (150 micron=0.15 mm) DT bubbles to be moved through it at the blinding speed of over 2 cm/s when acoustically driven to 95% of ambient (60 atm) at 50 Hertz. This speed of locomotion is acceptable for BSF, but a higher viscosity fluid would still be preferred for other reasons (preventing Rayleigh-Taylor instabilities).

The validity of these findings is, however, not beyond question, as several assumptions were made without full justification. For example, Navier-Stokes' equation can only be solved for laminar flow around small hard spherical particles in a continuous viscous fluid. According to our current level of understanding, those qualifications cannot be dropped without losing confidence in the result. Nevertheless, using sound to move bubbles is not science fiction, it has already been demonstrated in the lab; sonoluminescent experiments have been used to trap and hold bubbles stationary, and other (dynamics) experiments cause them to travel in almost perfect spirals. Therefore it is reasonable to expect that a more powerful and accurately controlled acoustic driver should be able to move the bubbles quicker and position them more accurately.

A good model, to base the design of this acoustical control system on, can be found in an article titled, “Control of Asynchronous Dynamical Systems with Rate Constraints on Events,” by professor Stephen Boyd of Stanford University. The article describes how to analyze very complex dynamical systems that, for example, are asynchronous, include logic variables, have rate constraints on events, have various nonlinearities, structured uncertainties and unknown delays. The example used in the article relates to the design of a computer system capable of accurately controlling (in real time) the position (in space & time) of various weights (of different possibly unknown masses) attached by a network of springs (of different or unknown strengths) using forces that can be applied discretely (in direction, magnitude, and duration) to some of the weights. Although a large amount of computer power is required, the mathematical model used in this example would only need slight modifications, to enable its use in a BSF plant, where it would generate, and interact with, an acoustical field sufficient to be used for the control of bubble locomotion.

### Fuels

Hydrogen, consists of two natural isotopes: protium (¹H), and deuterium (²H, D, or heavy hydrogen) which occurs in nature in a concentration of 0.015% (one atom in 6760 of light hydrogen). Light hydrogen participates in fusion reactions extremely slowly (that's why the sun is still around). Deuterium fuses much more readily. In smaller stars, known as brown dwarfs, only deuterium fusion can occur. All of the deuterium in the universe today was created in the first three minutes of the Big Bang. The unstable super heavy isotope tritium (T, ³H) rapidly decays (its radioactive half-life is 12.355 years) and thus exists in nature only in minute quantities. It is usually produced by ⁶Li+n→T+⁴He.

H₂ liquid density 0.07 g/cm³ (4.2×10²² atoms/cm³)

H₂ melting point 23.57° K

Lithium (Li), element 3, is distributed widely throughout nature. It is one of only three elements to have existed since the beginning of the Universe, having been synthesized during the

Big Bang. Lithium ranks 35th in order of abundance of the elements in the crust of the earth, being slightly less abundant than copper, but more abundant than lead. Natural Li consists of two isotopes ⁶Li (7.42%) and ⁷Li (92.58%).

Li Density 0.534

Li Melting Point 180.54° C.

Li Boiling Point 1342° C.

Lithium is used in nuclear weapons in the form of lithium hydride. It can be used in weapons simply as a convenient means of storing deuterium fusion fuel (lithium hydride contains more hydrogen per unit volume than liquid hydrogen does), or it can serve as an essential fusion fuel in its own right.

Lithium hydrides are white crystalline solids. The term “lithium hydride” may refer specifically to a compound of light hydrogen or may be used generically to refer any lithium-hydrogen compound regardless of hydrogen isotope. They are usually prepared by direct reaction between hydrogen and metallic lithium at elevated temperature. Lithium hydrides have no known solvent. ⁶Li has low mass and high neutron absorption cross-section in the 0.1-1.0 MeV range.

LiH Density: 0.82 ¹H, 0.92 ²H, and 1.02 ³H in g/cm³

LiH Melting Point 620° C.

Because of the high temperatures and densities required for fusion, the fuel has to be in the plasma state—a hot, highly ionized, electrically conducting gas. If the temperatures are high enough, the thermal velocities of the nuclei become very high. Only then do they have a chance to approach each other close enough so that the Coulombic repulsion can be overcome and the short-range attractive nuclear forces (effective over femtometer distances ˜10⁻¹⁵ m) can come into play.

The Coulomb barrier for ¹H is B≈1.44*q1q2/r1r2 MeV, where q_{1,2} and r_{1,2} are the charges and radii of the particles in units of the elementary charge and the nuclear radii in fm (10⁻¹⁵ m) respectively. The temperature that ¹H must be heated so that it overcomes the Coulomb barrier is 3.6e9 K, which is not a realistic prospect at the moment. Luckily there are other isotopes of hydrogen with heavier nuclei making the Coulomb barrier easier to overcome, though the yield is lower.

Even if the energy of the particles is slightly less than that required to overcome the Coulomb barrier, fusion processes can still occur via tunneling. However, the closer the particle energy is to overcoming the Coulomb barrier, the more tunneling processes are likely, FIG. 20. The chance of tunneling decreases rapidly with increased atomic number and mass, thus providing a first simple explanation for the fact that fusion reactions of interest for energy production on earth only involve the lightest nuclei.

Under these conditions matter tends to fly apart very quickly unless constrained in some way. In the sun this is done by gravitational forces. As gravity is not a terrestrial option, the central problem is to devise other means of confinement so that conditions of high temperature and density are maintained simultaneously for a sufficiently long time. However, the higher the temperature and density, the more difficult it becomes to confine the plasma. It therefore makes sense to look for situations where the requirement for confinement—and correspondingly temperature and density—is as low as possible. This is directly linked to the question of which fusion reaction is the most readily achieved under these conditions.

The key to understanding nuclear (fission or fusion) energy is knowledge of the binding energy of the nuclei. Mass and Energy are connected through ΔE=Δmc², so it is possible to determine the change in energy if one knows the mass of the various products and reactants.

The nuclear binging energy is the energy required to break a nucleus into free nucleons (protons & neutrons). In general, binding energy represents the mechanical work which must be done against the forces which hold the object together, disassembling the object into component parts separated by sufficient distance that further separation requires negligible additional work. Nuclear binding energies are millions of times greater than the electrical binding energies of chemical reactions. The net binding energy of a nucleus is that of the nuclear attraction, minus the disruptive energy of the electric force. This energy corresponds to the mass defect Am, as related by Einstein's famous equation ΔE=Δmc², expressing the equivalence of energy and mass. The mass of an atom's nucleus, as measured by mass spectrometer, is always less than the sum of the masses of the constituent protons and neutrons, FIG. 19.

The energy released from a nuclear reaction can be calculated, as the difference in the total mass of the nuclei that enter and exit the reaction. To calculate the energy released from ²H+³H+⁶Li→⁴He+³H+⁴He, we only need to know the masses of ²H, ⁴He, and ⁶Li. The atomic masses of ²H, ⁴He, and ⁶Li, are 2.0141017778(4), 4.00260325415(6), 6.015122795(16) respectively, so the difference between mass of reactants (8.0292245728) and the mass of products (8.0052065083) is 0.0240192197 (in atom mass units=1.6606×10⁻²⁷ kg), which corresponds to 22.4 MeV, using the fact that 1 amu=931.5 MeV.

The nuclear force is stronger but has a shorter range than the electric force. For light nuclei, attractive binding energy is much stronger than the mutual repulsion force of a few protons. For nuclii heavier than iron, each proton is repelled by (at least 25) other protons, while the nuclear attractive force only binds close neighbors.

As nuclei grow bigger still, this disruptive effect becomes steadily more significant. By the time plutonium is reached (94 protons), nuclei can no longer accommodate their large positive charge, but emit their excess protons quite rapidly in the process of alpha radioactivity—the emission of helium nuclei, each containing two protons and two neutrons (Helium nuclii are an especially stable combination.) The process becomes so rapid that still heavier nuclei are not found naturally on Earth, FIG. 21.

Small nuclei can combine to form bigger nuclei, but in combining such nuclei, the amount of energy released is much smaller then one would expect from the mass differences involved. The reason is that while the process gains energy from letting nuclear attraction do its work, it has to invest energy to force together positively charged protons, which also repel each other with their electric charge.

Once iron is reached—a nucleus with 26 protons—this process no longer gains energy. In heavier nuclei, we find energy is lost, not gained by adding protons. Overcoming the electric repulsion (which affects all protons in the nucleus) requires more energy than what is released by the nuclear attraction (effective mainly between close neighbors.) Energy could actually be gained, however, by breaking apart nuclei heavier than iron.

The fusion reaction of deuterium and tritium turns out to be the easiest approach to fusion because of a relatively large cross section and very high mass defect. When these two nuclei (of the hydrogen isotopes) fuse, an intermediate nucleus consisting of two protons and three neutrons is formed in the process. This nucleus splits immediately into a neutron of 14.1 MeV energy and an α-particle of 3.5 MeV. This fusion reaction has the advantage that the fuel resources are virtually unlimited. FIG. 22 demonstrates that at all temperatures the deuterium-tritium (DT) reaction gives the largest reaction rate and is therefore the easiest fusion route.

In fact, the reactivity of DT is 24-25 orders of magnitude greater than the p-p chain, which is the dominate reaction inside the Sun, at a central temperature of 1.3 keV. It may come as a surprise to learn that the specific power of fusion reactions at the center of the Sun is only 0.018 W/kg, that is, about 1/50 the metabolic heat of the human body.

Other advanced fuels were considered, like p+¹¹B→3α+8.6 MeV and D+3He→α+p, but, unfortunately, both of these reactions have much smaller cross-sections in the low-energy range that BSF is expected to operate in. And, on top of that, the often mentioned selling feature “does not involve radioactive fuel or release neutrons” is inconsequential when the fuel is being burnt in a BSF reactor.

The DT reaction is by far the most important one for present fusion research. Comparing all these fuels, the DT reactivity has a broad maximum at about 64 keV; it is 100 times larger than that of any other reaction at 10-20 keV and 10 times larger at 50 keV. The second most probable reaction is DD at temperatures T<25 keV, while it is D³He for 25<T<250 keV. The reactivity of p¹¹B equals that of D³He at temperature about 250 keV, but at such very high temperatures other reactions (such as T³He, p⁹Be, D⁶Li) have reactivity comparable to that of p¹¹B, but these are less interesting for controlled fusion because the fuels involved either contain rare isotopes or generate radioactivity.

### Coulomb Barrier

In order to fuse, two positively charged nuclei must come into contact, overcoming the repulsive Coulomb force. FIG. 20, shows how potential energy varies with the radial distance as two heavy nuclei of hydrogen (D & T) closely approach each other.

The important electrostatic force between two isolated particles of charge qₐ and q_{b} separated by a distance r in free space is determined by Coulomb's Law, given by

F_{c,a}=(¼ πε₀)(qₐq_{b}/r³)r

for the electrostatic force felt by particle a; here ε₀ is the permittivity of free space and the factor 4π is extracted from the proportionality constant by reason of convention.

The potential energy associated with moving a particle of charge qₐ from a sufficiently distant point to within a distance r of a stationary charge of magnitude q_{b}, for this charge configuration is, V(r)=Z₁Z₂e²/r, where Z₁ and Z₂ are the atomic numbers (for hydrogen both are one) and e is the charge of an electron. The important value is when r equals the distance of “contact” when the separation equals to the sum of the two nuclear radii. A useful approximation to the Coulomb barrier occurs at r=Rₚ(Aₐ^{1/3}+A_{b}^{1/3}) where A_{a,b} are the mass numbers and Rₚ=(1.3−1.7)×10⁻¹⁵ m denotes the radius of a proton which cannot be assigned a definite edge for quantum mechanical reasons.

The potential voltage at the Coulomb barrier is of the order of millions of electron-volts, for deuterium ions, this energy can be calculated to be about 0.4 MeV. According to classical mechanics, only nuclei with energy exceeding such a value can overcome the barrier and come into contact. Instead, two nuclei with relative energy ε<V_{Coulomb} can only approach each other up to the classical turning point r_{turning-point}=Z₁Z₂e²/ε.

Quantum mechanics, however, allows for tunneling a potential barrier of finite extension, thus making fusion reactions between nuclei with energy smaller than the height of the barrier possible. Thus, even at very low energy, the nucleus possesses a small, though finite, probability of compound formation with another nucleus. This compound can decay into fusion products and hence, some fusion reactions will also occur at room temperature, though at an insignificant rate.

### Nuclear Reactions

T+T→⁴He+2n +11.32 MeV 0.

D+TΔ⁴He+n +17.588 MeV (n=14.070 MeV) 1.

D+D→³He+n +3.2689 MeV (n=2.4497 MeV) 2.

D+D→T+p +4.0327 MeV 3.

³He+D→⁴He+p +18.353 MeV 4.

⁶Li+n→T+⁴He +4.7829 MeV 5.

⁷Li+n→T+⁴He+n −2.4670 MeV 6.

Reaction 5 (⁶Li+n) has a significant cross section at all neutron energies, but it has a large cross section below 1 MeV with a peak of 3.2 barns at 0.24 MeV. At higher energies endothermic spallation reactions tend to occur instead, above 4 MeV the neutron is far more likely to split the ⁶Li nucleus into ⁴He and D.

The endothermic reaction 6 (⁷Li+n) does not occur at all if the neutron energy is less than the energy deficit, and is only significant with neutron energies above 4 MeV. Above 4.5 MeV ⁷Li has a much larger cross section for breeding tritium than does ⁶Li.

There are a number of side reactions that can also occur in fusion fuel, especially with the very energetic 14.07 MeV fusion neutrons, which can cause spallation or fragmentation of target nuclei due to their enormous kinetic energy. Among these are:

D+n→p+2n −2.224 MeV 7.

⁶Li+n→⁴He+D+n −1.474 MeV 8.

⁶Li+n→⁴He+p+2n −3.698 MeV 9.

³He+n→T+p +0.7638 MeV 10.

⁷Li+n→⁶Li+2n −7.250 MeV 11.

Reactions 7 and 9 are significant in causing a modest amount of neutron multiplication (10-15% amplification of 14 MeV neutrons), and aiding in the rapid attenuation of highly energetic neutrons.

Since fusion fuel contains a very high density of very light atoms with good scattering cross sections, we should expect neutrons entering the fuel to be rapidly moderated (In nuclear engineering, a neutron moderator is a medium which reduces the velocity of fast neutrons, thereby turning them into thermal neutrons).

In pure deuterium, moderation takes only 9 collisions to fully thermalize 14.07 MeV neutrons (“thermal” here means on the order of 20 KeV), a process essentially complete in 0.25 nanoseconds at a fuel density of 75 g/cm³.

Rapid moderation occurs in lithium deuteride fuel as well. Reaction 5, the production of tritium from lithium-6 has a very large cross section peak at 246 KeV (8.15 barns). It averages only 0.77 barn from 0.02 to 0.15 KeV and 1.1 barns from 1 to 14.1 MeV. Multi-group neutron calculations show that in ⁶LiD fuel at a density of 200 g/cm³ about half of all tritium production occurs with neutrons moderated to the range of 0.15-1.0 MeV. 50% of 14.07 MeV neutrons are absorbed to form tritium within 0.075 nanoseconds after emission, rising to 70% at 0.15 nsec. Most of the rest become thermalized with a lifetime of 0.40 nsec before capture.

Clearly fusion neutrons give their energy up very quickly to the fusion fuel, and relatively few escape the fuel without undergoing substantial moderation. We can also conclude that the production of tritium from lithium-6 is a rapid, efficient process.

Lithium hydride (LiD+LiT) is a “dry” fuel with more convenient physical properties than the low boiling point DT fuel. Even more important than its high D/T content (>25% by weight), and high atom density (0.103 moles/cm³, higher than liquid hydrogen), is the fact that lithium isotopes can also provide additional fusion fuel. Probably all fusion weapons since Ivy Mike have used lithium hydrides of varying isotopic composition as fusion fuel. Given the convenience of its physical properties, the cheapness of lithium, and the high energy content resulting from the nuclear reactions lithium undergoes, it would be hard to find a better fuel.

If lithium becomes mixed with the DT fuel, either intentionally (as a fuel additive) or through diffusion of the coolant, then the following reactions can take place after sufficiently high temperatures are reached: ⁷Li+³H→2α+2n, 6_{Li+}²H→(α+³H+p) or (⁶Li+n+p).

If FLiBe is used as a coolant, then the high-energy alpha particles released from lithium's transmutation can react with beryllium, ⁹Be+α→(¹³C)*→¹²C+n, which is the same reaction that many fission reactors use to generate neutron sources. The source is usually composed of a mixture of metallic beryllium with a small quantity of an alpha particle emitter, such as a compound of radium, polonium, or plutonium. Beryllium is also a neutron multiplier, when hit by 2.7 MeV (threshold) neutrons, ⁹Be+n→2α+2n (−1.67 MeV). Another reactions with Be is, ⁹Be+n→⁷Li+³H.

Gamma rays also participate in nuclear reactions. They are produced by the decay of excited nuclei and by nuclear reactions. In the case of inelastic scattering, some of the kinetic energy of the incident neutron is used in the excitation of the target nucleus. The excited nucleus then decays by gamma emission. For low energy neutrons (˜0.1 to 10 MeV) elastic scattering predominates, while for neutrons of energy greater than 10 MeV, inelastic scattering is predominant

Because gamma rays have no mass and no charge, they are difficult to stop and have a very high penetrating power. A small fraction of the original gamma stream will pass through several feet of concrete or several meters of water. Gamma rays are shorter in wavelength and contain more energy than X-rays, which are produced when orbiting electrons move to lower energy orbits or when fast-moving electrons approaching an atom are deflected and decelerated as they react with the atom's electric field (called Bremsstrahlung). Lead is the preferred shielding material. Of the stable elements, Pb has the highest atomic number (Z=82), most electron energy levels, and it requires the most energy (88 keV) to remove its innermost electron. For X-rays between 75-900 keV, the recommended shield thickness is 1.0-51.0 mm of Pb. There are four methods of attenuating gamma rays: photoelectric effect (<1 MeV, ejects β⁻), Compton scattering (>0.1 MeV, fractional energy lost in passing), electron/positron pair production (when a high energy gamma passes close to a heavy nucleus, the gamma completely disappears, and a β⁻β⁺ pair form, with kinetic energy equal to 1.02 less than that of the gamma), and photodisintegration (two examples are ⁹Be+γ→(⁹Be)*→2α+n (requires 1.67 MeV) and ²H+γ→p+n (requires 2.23 MeV)).

### Combustion

Early on in the nuclear fusion weapons program it became apparent that direct heating of pure deuterium could not establish ignition conditions, even fission bombs are not hot enough for this. Adding extremely costly tritium to the ignition zone as a “starter fuel” was required, the easily combustible tritium could in principal raise the fuel to deuterium-deuterium fusion temperatures.

Simulations, using unconfined (inertially compressed) fuel, show that even at ignition temperature, if the D-T gas or lithium hydride is only compressed to liquid H density, the fuel will not fuse fast enough for efficient combustion before the expanding mass disassembles. The fuel must be compressed by a factor of 10 or so for the reaction to be sufficiently fast.

For D-T gas bubbles, reaching MeV kinetic energies is a transient non-equilibrium phenomena, linked to the duration of the bubble collapse. Specifically, a slow bubble collapse would allow thermalization of kinetic energy, precluding relatively high temperatures. Accordingly, the faster the bubble collapse, the higher the resulting bubble nuclei temperature.

Unlike a high explosive, a fusion reaction will not go to completion in a narrow zone behind the ignition front, instead the fuel will continue to burn until quenched by the expansion of the fuel mass.

The fact that most of the fusion energy is released as neutron kinetic energy is a problem. This means that most of the energy will be deposited in a fairly large region outside of the combustion zone, making propagation of the zone more difficult.

Compressing the fuel by a factor of 1000 (for example), reduces the dimensions by a factor of 10. This has several important consequences. First, the fuel has greater opportunity to burn before disassembly. Second, the MFPs (mean free-flight path distance) for neutrons decrease by a factor of 1000, and for photons by a factor of a million. Neutron heating thus occurs in a narrower zone, assisting the propagation of the burn region, while photon absorption becomes an important heating mechanism—effectively eliminating bremsstrahlung loss.

The net result is that compression does indeed make a big difference in the feasibility of propagating a thermonuclear combustion wave.

### Radiation Implosion

The idea Teller developed is now known as radiation implosion. Blackbody radiation emission evaporates material from an opaque pusher/tamper around the fusion fuel. The expansion of this heated material acts like a rocket engine turned inside out—the inward directed reaction force drives the fuel capsule inward, imploding it.

Since entropic heating makes compression much less effective, it is very unfavorable to allow thermal radiation to heat the fusion fuel prior to compression. If an opaque radiation shield is placed around the fuel to protect it from heating, the evaporation of the shield and a resulting implosion is inevitable.

The ignition problem for the radiation implosion approach now resembles the efficiency problem in fission bombs. The efficiency of the fusion burn is determined by the fusion rate, integrated over the duration of confinement. The fusion process is usually shut down when the fuel capsule undergoes explosive disassembly in a manner similar to that of a fission core. If the reaction is highly efficient it may burn up so much fuel that the rate drops off to a negligible value despite the increasing temperature before disassembly occurs.

Unlike the fission bomb though, convenient efficiency equations cannot be analytically derived. The energy release in a fission reaction is governed by a simple exponential function of time. In contrast fusion reactions are not chain reactions, and the way reaction rate varies with temperature is not simple. Further the energy release in deuterium is due to many different reactions, each with a different rate, and the composition of the fuel continuously changes. An adequate treatment of efficiency necessarily relies on numerical simulations.

### Advantages of Compression

The fundamental purpose of compression is to allow the reaction to proceed swiftly enough for a large part of the fuel to burn before it disassembles. Compression achieves this in two ways. First, for a fixed amount of fuel at constant temperature, the reaction rate increases in direct proportion to its density. Second, compression will cause the temperature to increase, and with it the cross-sections of the thermonuclear reactions. As an example, the pace-setting cross-section of D-D reactions increase 6.7 fold when the temperature is doubled from 5 to 10 keV.

These are not the only advantages however. Compressing the fuel reduces the neutron collision mean free path. The MFP in liquid deuterium for the 14.1 MeV neutrons produced by the D-T reaction is 22 cm. A 1 kg sphere of liquid deuterium would be 22.4 cm across, most 14.1 MeV neutrons generated within this mass would escape without even a single collision. If this sphere were compressed 125-fold, its diameter would shrink to 4.49 cm but the MFP would now be only 0.18 cm. Few neutrons would escape without depositing most of their energy in the fuel mass.

### Methods of Compression

Simply applying these pressures suddenly will not actually compress it very much. Sudden pressure jumps produce intense shock waves that expend shock energy about equally between heat and kinetic energy, with a negligible portion going to compression. A better, more efficient, way to compress is to divide the pressure increment into a series of shock waves, each providing a modest pressure increase ratio, and minimal entropic heating. Alternatively, an appropriately shaped continuous pressure rise can produce true adiabatic compression. Actually there is not much difference between these two options. Continuous adiabatic compression is the limiting case of an infinitely large number of infinitely weak shocks producing no entropic heating. And in practice, any continuous pressure gradient of this magnitude will tend to break up into a sequence of discrete shocks.

Efficient compression can raise the temperature of the fuel to a few million degrees K. This is hot enough to create a measurable D-D fusion reaction in the compressed fuel, but by itself it does not result in a thermonuclear reaction that is rapid enough to be useful.

To achieve efficient fuel burn up the fuel must be heated to the point where the rate of self-heating becomes significant, triggering a rapidly accelerating combustion process. The denser the fuel mass, the less energy is required to reach this point.

In ICF experiments, how hot the fuel must be is determined by the density, and the achievable confinement time. A simple model predicts that D-D heated to 12 million ° K and compressed to 100 g/cm³ will burn up (80%) in 20 nanoseconds after a 60 ns latency period, where the temperature slowly climbs to 30 million K. Once 30M ° K is reached the temperature abruptly climbs upwards. The D-T reaction rate is about 100 times faster than the D-D reaction, for moderate thermonuclear temperatures. Since D-T reactions take place at much higher rates and much lower temperatures, it is much easier to achieve the necessary ignition conditions. That is why D-T mixtures are the only fuel being considered.

Considerable heating occurs near the center of a convergent shock wave implosion, where the shock wave converges in principal to a mathematical point of unlimited temperature.

Once ignited, the thermonuclear reaction is self-heating. Since the reaction rate increases with temperature, feed-back is established that causes the power output rise steeply. When more than half of the fuel has burned the temperature cannot rise much more since most of the energy has already been released. The depletion of fuel then catches up, and the power output levels off, then begins a somewhat less rapid decline. The period during which the majority of the fuel is burned amounts to a mere 20 nanoseconds or so. All this assumes of course that the fuel hasn't disassembled to quench the reaction.

During burn, the neutron energy is deposited in the blanket in a time that is short compared to a hydrodynamic response time, raising central pressures to over a million atmospheres and launching a strong shock wave. The shock wave efficiently transports energy outward from the center of the blanket before any significant fluid motion develops. The energy behind the shock wave is in the form of both kinetic energy with outward-directed velocity and internal energy, or pressure.

At fuel densities on the order of 100 g/cm³, the maximum temperature can rise to about 350 million degrees K. Under these conditions the pressure tips 100 terabars (100 trillion atmospheres). This tremendous temperature and pressure is initially confined to the fusion fuel. It propagates into the tamper as a Marshak wave (a radiation driven compression wave), compressing and accelerating the tamper material outward.

Pressures of this magnitude are capable of generating an outgoing compression wave in the tamper with a velocity of several millimeters per nanosecond. This rate of expansion is so fast that even during the extremely short period when the thermonuclear reaction is near its peak, the density of the fuel could drop significantly and impair overall efficiency. It helps considerably if the tamper is still imploding rapidly when the reaction ignites, since pressure of a few terabars will be necessary to simply bring the implosion to a halt.

Compressing fuel efficiently to high densities requires that the fuel have relatively low entropy. At the start of the compression process, a relatively small amount of heat will increase the entropy significantly and reduce the efficiency of the entire compression process, which is why the initial shock pressure must be carefully controlled.

Molecular dissociation of DT can be a source of enhanced compressibility and has been expected to occur in the pressure regime near 1.0 Mbar. For comparison, a simulation that did not account for dissociation reported a density of 0.65 g/cm³ after a 1.0 Mbar shock, but measurements taken under the same conditions reported a density of 1.05 g/cm³. Dissociation is an energy sink (it takes energy to break the molecular bonds), so some of the energy transmitted to the fuel from the first shock will be used for the process. The more energy required for dissociation, the lower the temperature of the shocked fluid, and, consequently, the higher the shocked density.

### Lawson's Criterion

In addition to providing a sufficiently high temperature to enable the particles to overcome the Coulomb barrier, that temperature must be maintained for a sufficient confinement time and with a sufficient ion density in order to obtain a net yield of energy from a fusion reaction. The overall conditions which must be met for a yield of more energy than is required for the heating of the plasma are usually stated in terms of the product of ion density and confinement time, a condition called Lawson's criterion, but a more useful figure of merit is the “triple product” of density, confinement time, and plasma temperature.

The idea behind the Lawson criterion is as follows: Consider your kitchen oven. The temperature maintained in the oven depends on both the rate at which electricity (or gas) supplies heat and the rate at which the heat leaks away. If the oven were poorly insulated, the heat would be rapidly conducted to the surrounding air, thereby cooling the oven. In just the same way, the temperature at the center of the Sun, about 1.3 keV, is determined both by the rate at which fusion in the core produces heat and by the rate at which this heat is conducted outward to the surface of the Sun, where it is radiated in the form of sunlight. The Sun can sustain its fusion reactions in part because it is so large that heat is conducted away slowly. To create a practical fusion reactor, we must compensate for size by burning the fuel quickly and/or using good insulation to prevent rapid heat conduction.

The confinement time (τ_{conf}) is a measure of how fast a system loses energy to its environment. In nuclear fusion devices τ_{conf} is defined as the time the plasma is maintained at a temperature above the critical ignition temperature. Confinement times should be sufficiently long, in order to recover, through fusion, the energy invested into heating the plasma. Confinement times for BSF are expected to be several orders of magnitude longer than those of ICF. ICF targets disassemble at the speed of sound, so τ_{conf-ICF}≅R_{target}/4c_{sound}, whereas τ_{conf-BSF}=W_{fuel}/Pₗₒₛₛ, where W_{fuel} is the energy content of the fuel, and Pₗₒₛₛ is the rate of energy loss.

Even if the temperature is high enough to overcome the coulomb barrier to nuclear fusion, a critical density of ions (n_{D} deuterium, n_{T} tritium) must be maintained to make the probability of collision high enough to achieve a net yield of energy from the reaction. In the case of a 50-50 mixture of DT, the ion density equals the electron density (nₑ), and the energy density of both together is given by W_{fuel}=3nₑk_{b}T, where k_{b} is the Boltzmann constant.

The volume rate of fusion is Fᵣₐₜₑ=n_{D}n_{T}<σv>_{Temp}=¼ nₑ²<σv>_{Temp} where σ is the fusion cross section, v is the relative velocity, and <>_{Temp} denotes an average over the Maxwellian velocity distribution at that temperature.

The volume rate of heating by fusion equals Q_{α}Fᵣₐₜₑ, where Q_{α} is the kinetic energy of the reaction's alpha-particle (3.5 MeV), the other reaction product, a 14.1 MeV neutron, escapes and is useless toward heating the fuel.

The criterion that the rate of fusion heating exceeds the rate of heat losses can be expressed:

¼ nₑ²<σv>_{Temp}Q_{α}, >3nₑk_{b}T/τ_{conf}, or

nₑτ_{conf}>12k_{b}T/<σv>_{Temp}Q₆₀.

For example, the Lawson's criteria for ICF targets, assuming temperatures of approximately 5 keV, would be: nₑt_{conf}≧2×10¹⁴ s/cm³ for D-T, and nₑt_{conf}≧5×10¹⁵ s/cm³ for D-D.

Although the ion temperatures and densities are expected to be slightly lower, it might still be easier for BSF to satisfy Lawson's criteria, compared to ICF, because the confinement times for BSF are very much longer.

### Gas Laws

The gaseous state is the simplest form of matter to analyze. This is fortunate, since under the extreme conditions encountered in chemical and nuclear explosions, matter can usually be treated as a gas regardless of its density or original state.

P=pressure in atmospheres

V=volume in liters

N=number of particles (molecules)

k=Boltzmann's constant (1.380E−23 J/K°)

T=temperature in Kelvin

The Pressure in a given volume of gas is proportional to the average particle kinetic energy (K.E.) and the particle density.

P=(2/3)K.E./V

Now the thing we call temperature is simple the average kinetic energy of the particles of a gas. A constant of proportionality is used to convert kinetic energy, measured in joules or ergs, into degrees Kelvin (K). Together these considerations give us the Ideal Gas Law:

PV=NkT

The average particle kinetic energy (KEₚ) of a gas at temperature T is then:

KEₚ=(3/2)kT

An “ideal gas” is one in which there are no interactions (that is, repulsive or attractive forces) between gas particles.

If, in the process of absorbing energy, the particles in a gas only change their rotations, vibrations, and velocities, then they behave ideally, but if they absorb energy internally by other processes, like ionization, then they are not behaving like an ideal gas. When conditions are such that attractive forces become significant (near liquid or solid condensation points) the ideal gas law also breaks down.

In a mixture of particles of different types, each type of gas molecule will be in equilibrium with every other type of gas molecule. That is, they will have the same temperature—the same average kinetic energy. If each type of particle has a different mass from the others, then each must also have a unique average velocity for the kinetic energies of each type to be equal. One implication of this is that when a gas becomes ionized, the electrons knocked loose become separate particles and will come into thermodynamic equilibrium with the ions and un-ionized atoms. Since they are much lighter than atoms or ions, their velocities will be much higher.

If we assume an equilibrium condition when deriving the Ideal Gas Law, then the total kinetic energy will get divided equally among the three spatial directions of motion. These spatial directions are called the “degrees of freedom” of a monatomic perfect gas. Since the kinetic energy of a particle in such a gas is 3kT/2, each degree of freedom accounts for kT/2 energy per particle. This is also true of polyatomic gases, which have additional degrees of freedom (e.g. from vibration and rotation). Each available degree of freedom will have kT/2 energy when in equilibrium. This is the theorem of “equipartion of energy.”

To reach equilibrium between different particles and different degrees of freedom in a system, the different parts of the system must be able to exchange energy. The rate of energy exchange determines how long it takes to establish equilibrium. The length of this equilibrating period is called the “relaxation time” of the system. A complex system will typically have several relaxation times for different system components.

The relaxation time is determined by how frequently a member of a degree of freedom can be expected to undergo an energy exchange event, and how effective that event is in transferring energy.

For particles of similar mass, a single collision can transfer essentially all of the kinetic energy from one particle to the other. The relaxation time for bringing two populations of particles with different kinetic energies into equilibrium is thus the average time between collisions. In air at normal temperatures and pressures, this time is about 0.1 nanoseconds. At higher densities and temperatures, the distances traveled between collisions is shorter, and the velocities are higher, so the time is correspondingly shorter.

The actual distribution of particle energies can be described statistically, using the Maxwell-Boltzmann law, as a function with a roughly bell-shaped curve, peaking (most probable energy) at kT.

There are three types of gas, Boltzmann, Bose, and Fermi, each having a different distribution.

An ideal gas with additional degrees of freedom has a larger internal energy than does a monatomic gas at the same temperature. This internal energy is proportional to the absolute temperature. This allows us to establish a constant for each gas that describes how much thermal energy is required to raise its temperature a fixed amount. This constant is called the “specific heat.”

There are actually two commonly used specific heat definitions for gases, the specific heat at constant volume (cᵥ) and the specific heat at constant pressure (cₚ). Cᵥ measures the amount of energy required to raise the temperature in a sealed, fixed volume container. In such a container heating also causes the pressure to rise. Cₚ measures the amount of energy required to raise the temperature of a gas that is allowed to expand sufficiently to maintain constant pressure.

These two specific heats are not independent. In fact, the ratio between them is fixed by the number of degrees of freedom of the gas. This gives us the constant that we use for describing the thermodynamic properties of a gas—the thermodynamic exponent. This constant is represented by the lower case Greek letter gamma Γ It is defined by:

Γ=cₚ/cᵥ

Leading to the general law, valid for all perfect gases:

P=(Γ−1)(K.E.)/V

Gamma also goes by the name adiabatic exponent, since matter undergoing adiabatic compression follows the relation:

V^{Γ}=constant/P

Adiabatic compression is compression where the entropy is constant (no heat is added or removed). If flows of heat occur, then the process is non-adiabatic and causes irreversible change.

Gamma is determined by the compressibility of a gas. The larger Γ, the more work is required to reduce the volume through adiabatic compression (and the larger the increase in internal energy). An infinitely compressible gas would have an exponent of 1. The Γ for a gas is related to the number of degrees of freedom (n_{f}) by:

Γ=(2+n_{f})/n_{f}

Some examples are: Perfect Monatomic Gas Γ=5/3, Diatomic Gas (fully excited) Γ=9/7, Photon radiation Γ=4/3, Lithium Γ=2.1.

The equipartition of energy in an equilibrium system also extends to radiant energy present in the system. Photons are emitted and absorbed continually by matter, creating an equilibrium photon gas that permeates it. But, unlike matter, the photon gas is distributed according to the Bose-Einstein statistics.

This fact gives rise to an energy distribution among the particles in a photon gas called the blackbody spectrum which has a temperature dependent peak reminiscent of the Maxwell-Boltzmann distribution. The term “blackbody” refers to the analytical model used to derive the spectrum mathematically which assumes the existence of a perfect photon absorber or (equivalently) a leakless container of energy (called in German a “hohlraum”).

The emissions per unit area (flux) and photon radiation pressure (P_{rad}) can be calculated using the Stefan-Boltzmann constant sigma (σ=5.669×10⁻¹² J/sec-cm²-° K⁴) as follows,

Flux=σT⁴

P_{rad}=(4σ/(3c))T⁴

It is easy to see from the above that the amount of radiant energy present varies dramatically with temperature. At room temperature it is insignificant, but it grows very rapidly. At sufficiently high temperatures, the energy present in the blackbody field exceeds all other forms of energy in a system (which is then said to be “radiation dominated”). The average photon energy is directly proportional to T, which implies the photon density varies as T³. In radiation dominated matter we can expect the number of photons present to be larger than the number of all other particles combined.

Since the pressure of kinetic energy is NkT/V, the total pressure is,

Pₜₒₜₐₗ=NkT/V+(4σ/(3c))T⁴.

The radiation pressure begins to surpass the kinetic pressure when the temperatures climbs beyond 1.3×10⁷° K (1.1 keV), for a sample of hydrogen kept at liquid density.

The energy of a photon of frequency nu (v) is simply

Eₚₕₒₜ=hν, where
ν is in hertz (c/wavelength) and
h is Plank's constant.

As pressures continue to increase above several megabars, the electronic structure of the atom begins to break down. The Coulomb forces become so strong that the outer electrons are displaced from the atomic nuclei. The material begins to resemble individual atomic nuclei swimming in a sea of free electrons, which is called an electron gas. This gas is governed by quantum mechanical laws, and since electrons belong to a class of particles called fermions (which obey Fermi_Dirac statistical laws), it is an example of a Fermi gas.

In contrast to the Bose_Einstein gas of photons, where particles prefer to be in the same energy state, fermions cannot be in the same energy state.

The Fermi pressure is:

P_{Fermi}=2.34×10⁻³³*(electrons/cm³)^{(5/3)} bars.

A useful rule-of-thumb about electron density in various materials can be obtained by observing that most isotopes of most elements have a roughly 1:1 neutron/proton ratio in the nucleus. Since the number of electrons is equal to the number of protons, we can assume that most substances contain a fixed number of electrons per unit mass: 0.5 moles/gram (3.01×10²³ electrons). Two fuels, ⁶Li and D, follow this rule exactly. This assumption allows us to relate mass density to Fermi gas pressure without worrying about chemical or isotopic composition.

As the electron shells of atoms break down, the value of Γ approaches a limiting value of 5/3 with respect to the total internal energy, regardless of whether it is thermal or quantum mechanical in nature.

The total pressure present is the sum of the Fermi pressure, the kinetic pressure of the Boltzmann gas consisting of the nuclei and non-degenerate electrons, and the pressure of the photon Bose gas. Similarly, the energy density is the sum of the contributions from the Fermi, Boltzmann, and Bose gases that are present.

### Target Design

The immediate goal of target design is to achieve the optimal conditions for achieving ignition and propagation of burn with a minimal amount of incident laser energy. In ICF this is achieved by layering the target, from inside to outside, with D-T gas, D-T ice, and a high-Z tamper. BSF can use similar ideas in its target designs, by mixing liquid and gaseous fuels, and choosing a liquid tamper that adheres to the inside surface of the bubble.

A disadvantage of using all-DT gas targets is that the laser absorption rate is only 60%. Although this is important for ICF, the laser absorption rate has little meaning in BSF, because whatever incident light is not absorbed immediately will have another chance after it reflects from the spheres innards. ICF increases the laser absorption rate by using DT-wetted foam or gaseous paraffin targets that can absorb up to 90% of the laser light. The reason for the increased energy coupling in those types of targets is that the carbon, higher Z material, makes the plasma more collisional (a condition that is conducive to Inverse Bremsstrahlung Absorption). These factors could influence the gain significantly, because, with higher absorption, the same incident laser energy could drive more massive targets.

### Rayleigh-Taylor Instability

For ICF, both ion temperature and fusion yields are strongly dependent on the uniformity of the implosion. RTI is what causes the mixing which occurs between two fluids of different densities when a light fluid pushes a heavier fluid. Since the beginning of ICF research, control of implosion instabilities was recognized as a key issue, and RTIs were addressed both analytically and numerically. RTIs quench the fuel, causing major problems for ICF, and a large portion of ICF research computer time is focused on modeling and preventing them.

Instabilities destroy the integrity of the capsule interface and mix the fuel with “high-Z” (C, Si, O, . . . ) material from the shell. When the high-Z atoms mix with the fuel heated by compression, thermal energy of the fuel ionizes these contaminating atoms, which in turn lowers the temperature of the fuel, which lowers the fusion rate.

In 2009, W. J. Nellis of Harvard University wrote a critique of the National Ignition Fusion program. The article was titled “Will NIF work?” It contained the following quotes, “Despite the financial and human resources and time spent on NIF, the key condensed matter and materials physics issues of the fuel capsule remain unsolved and the R-T instability continues to be the limiting feature of NIF performance.” “While both the physics of R-T growth and the equations of state of DT (hydrogen) and shell material must be known, the R-T instability is by far the major issue . . . .” “It is R-T spikes that grow from such R-M instabilities under high accelerations at later times that are the show-stopper of ICF.” “Computational simulations for more than 35 years have provided no insight into eliminating the R-T instability.”

In fact, computer simulations have always overestimated the performance of both direct and indirect drive ICF implosion experiments. These simulations also routinely underestimate the energy needed for ignition; according to the Halite-Centurian tests in Nevada, 20 MJ might be required, but, to this day, none of the simulations predict this much energy would be required. Experiments in the real world have shown a substantially degraded thermonuclear performance, compared with these one-dimensional numerical simulations. The deviation increases with the implosions convergence ratio, in agreement with the present interpretation of fuel-to-tamper turbulent mixing, consequence of the hydrodynamic instabilities previously described. It should also be noted that attempting to obtain ICF ignition at an energy much less than the NIF uses would require laser beam intensities well above the threshold for the deleterious effects of laser-plasma interaction, even with ultraviolet lasers.

BSF, unlike ICF, is virtually immune to RTIs. There are two situations where RTIs can occur during an ICF implosion, first, when laser ablation causes low-density vaporized material to push into the high-density shell, and later, when the implosion stagnates and the low-density D-T fuel starts pushing back. These pressure/density directions are reversed during BSF's acoustic pre-compression, with high-density coolant pushing low-density fuel, so, as a consequence, RTIs are ruled-out. Also, the stagnation, which is expected at the end of pre-compression, never occurs in BSF. The reason for this, lack of stagnation, is that rising fuel temperatures trigger an outgoing laser cascade, which returns to ionize everything in, and around, the focal spot. This marks the end of acoustical pre-compression and the beginning of differential ionization compression, which is again RTI-free, being characterized by the same high-pressure high-density coolant (in a highly ionized state of plasma) pushing into lower-pressure lower-density fuel.

The major challenge in realizing sufficient gain from a direct-drive target is suppression of hydrodynamic (Rayleigh-Taylor) instabilities, which can be seeded by the non-uniformities of either the capsule surface or the driver-beam illumination. Experiments have shown that adding a thin high-Z layer (such as Pd) on the surface of the target substantially reduces the imprint of laser-non-uniformities, and hence mitigates the seeding of hydrodynamic instabilities. X-rays from this high-Z layer enhance energy transport into the target, and produce a large plasma that can buffer and reduce the small scale laser nonuniformity.

In 2004, Linford comes to the same conclusion, “Turning to targets, the most important near term issue is Rayleigh-Taylor instabilities seeded by non-uniformities in the laser deposition profile or in the target . . . . Recent innovations include using high-Z target coatings to reduce beam imprint.” Doped ablators (Si & Ge) can minimize energetic electron preheat and R-T growth rate. Initial experiments with high-Z doped plastic shells show reduced hard x-ray production.

Not all recent findings are negative. The RTI that occurs during deceleration and stagnation of an ICF target differs from classical RTI in that the heat flow and the flow of α-particles from the central hot spot causes ablation of the inner surface of the decelerating dense shell. This ablation on the inside tamper wall reduces the growth of RTIs inside the shell, just like the ablation of the outer laser/radiation-driven front reduces the RTIs outside the shell. Although this effect has been known for a long time, only recently Lobatchev and Betti (2000) have pointed out that such an ablative flow should stabilize the deceleration-phase RTI just as laser- or x-ray driven ablative flow stabilizes RTI at the outer surface of an ICF shell.

RTIs are not the only instability, but, they are by-far the most dangerous, as far as ICF is concerned. Richtmyer-Meshkov instabilities (RMI) occur when an interface between fluids of differing density is impulsively accelerated. e.g. by the passage of a shock wave. Bubbles appear in the case where the light fluid penetrates the heavy fluid, and spikes appear when the heavy penetrates into the light.

RMIs are certainly less dangerous than RTIs. They grow linearly in time, while RTIs grow exponentially in time.

It has been assumed that the R-M and R-T instabilities could be eliminated simply by fabricating the inner spherical surface of the capsule to be spherically smooth to a few nm. Since the inception of the ICF program in the early 1970s the fuel capsule was made from compressible plastics. Such_plastics lack the strength needed to impede instability growth. About the time it was shown that the R-T computational program had not been useful for this problem, the ICF Program began considering the strongest material known, diamond. Unfortunately for NIF, it appears that it does not matter how smooth capsule surfaces are fabricated because when the capsule is shocked by the laser pulse, rapid deformation induces defects in the shell, which show up as small interfacial imperfections on the interface when the shock breaks out of the shell. These shock-induced imperfections nucleate sites for the growth of R-T instabilities under subsequent fast spherical convergence.

Using sapphire and diamond, Celliers et al have demonstrated that R-T growth rates can be large no matter how smooth the capsule is fabricated. They have also demonstrated that diamond is probably not a material that should be used in a fuel capsule. This means that the optimal material must be found from which to fabricate ICF shells. Something that is yet to be done. Experiments have shown that surface roughness could be reduced by going to shock stresses near melting or in the melt region of diamond. Those results indicate that reducing strength produces smoother surfaces. For a sufficiently strong shock on breakout, the impulse will simply spray bits of the shell into the DT, which will poison fusion for the same reason the R-T instability does; thermal energy will be absorbed by ionizing shell bits. A multi-Mbar shock is likely to do this.

Non-uniformities in excess of 1% in compression result in the formation of ‘jets’ of energy that surge outward and locally cool the fuel. The current generation of ICF systems use multiple beams (as many as 192 in one system) to attempt to provide a sufficiently uniform compression of the fuel. Instead of combining individual beams, BSF uses a spherical laser that can completely and uniformly illuminate the entire target from all angles. In addition, a BSF bubble cannot squirt its contents out, because it is immersed within a body of coolant that is of much higher density and higher pressure, squeezing it uniformly inward, unlike the situation in ICF, where the vacuum chamber ‘sucks’ everything outward. For those reasons, BSF might even succeed with highly irregular non-spherical implosions.

### Yields (Using D-T Gas)

In BSF, an upper bound on target energy yield can be calculated using the fuel's volume, pressure, and nuclear properties. If the top of the sphere is kept at ambient atmospheric pressure, then the place where the bubble of fuel gets injected will be 30 meters below and subjected to an additional 11.2 atmospheres of pressure due to the weight of coolant above it. The number of moles in one cubic centimeter of hydrogen gas under 12.2 atmospheres of pressure and heated to 700° C. can then be calculated using the Ideal Gas Law, PV=nRT, and the Universal Gas Constant, 0.0821 (atm 1)/(mol K), to be: (12.2 atm)(0.001 l)/(0.0821(273+700))=1.53E−4 moles. Using this value, the yield is (1.53E−4 mol/target)(6.023E23 molecules/mol)(22.37E6 eV/DT molecule)(joules/6.24E18 eV)=330 MJ. If it takes 15 seconds between firings, then 1320 MJ is produced each minute. Since one watt is one joule per second, 1320 MJ/min is 22 MW.

That yield assumed 100% burn-up and was quite small, but higher yields can be obtained using bigger targets, faster firing rates, and most dramatically by adding liquid lithium hydride (with a D-T fuel density 480 times greater than gaseous D-T) to the fuel. The yield can also be increased by using a gaseous fuel with more D & T atoms per molecule. This is in accordance with Avogadro's Principle, which states that the volume of a gas is directly proportional to the number of molecules of the gas, not influenced by the sizes or weights of the gas molecules. Therefore, equal volumes of gases with the same pressure and temperature contain the same number of molecules. Good candidates, for achieving high D-T densities, are the alkanes.

Alkanes can have lots of hydrogen atoms per molecule, and they are relatively inert because their C bonds are relatively stable and cannot be easily broken. Unlike most other organic compounds, they possess no functional groups. They react only very poorly with ionic or polar substances. Due to very strong C—H bonds in a methane molecule (440 kJ/mole) its thermal (non-catalytic) decomposition occurs at very high temperatures (>1200° C.). In crude oil the alkane molecules have remained chemically unchanged for millions of years. Good examples are paraffin wax (C₂₅H₅₂) and Pentacontane (C₅₀H₁₀₂), with hydrogen densities of 26 and 51 times that of D-T gas and with boiling points of 300° C. and 575° C. respectively.

Even without using high density gas & liquid fuels, the yield can still be significantly increased. For example, firing on 3 cm diameter bubbles every 3 seconds should produce 1.5 GW. If this same sized bubble was composed of gaseous paraffin wax, and effectively burnt at the same rate, then over 40 GW of power could be extracted. This huge capacity, coming from a single moderate sized BSF plant, cannot be matched by any other power plant currently in operation, including the worlds largest hydroelectric dams.

For reference, a GJ corresponds to the energy released by 250 kg of high explosive, a yield of 30 GJ would almost completely vaporize liquid FLiBe for a radius of one meter, and 150 MJ is the energy released by the combustion of one gallon of gasoline.

When assessing the blast of such explosions, however, one should keep in mind that the fusion energy released is in the form of high velocity particles (neutrons, ions) and photons, carrying relatively low momentum per unit of energy. The blast therefore is considerably weaker than for chemical explosions that release this same amount of energy in the form of gases with much lower velocities.

Pulses of energy deposited in the reactor walls will be characterized by shallow penetration (a few micrometers) and short duration (from a nanosecond to a few microseconds). The surface temperature increase is dominated by the heat conductivity & capacity of the wall material, and the resulting temperature could be derived naively by equating the heat stored in a spherical shell of thickness δ (cm) to the pulse energy. It is reassuring to know that this naïve result is also the limiting value of a rigorous general solution of the heat transfer equation. The foregoing analysis to calculate inner wall surface temperature ignores pulse duration (τ) and exchanges the singular behavior with respect to pulse length for the singular behavior with respect to the depth of energy deposition.

The dynamic response of chambers following target explosions is a critical scientific-issue in determining the repetition rate and durability and hence the ultimate attractiveness of all IFE concepts, not just BSF. Important chamber issues requiring further work for ICF resolution include thick liquid chamber dynamics and shock mitigation, aerosol generation and transport, armor survival, and chamber clearing.

The next few paragraphs perform a back-of-the-envelope calculation to determine the maximum survivable yield, based on the amount of pressure a reactor can withstand before bursting.

Theoretically, a sphere is the optimal shape for a pressure vessel. For thin-walled (r>10*t) spherical pressure vessels, the stress in the circumferential direction is P*r/2t, where P is the gauge pressure, r is the inner radius, and t is the thickness. Steel has an ultimate tensile strength of between 400-2500 MPa. If a 5 m radius sphere is constructed from steel 0.25 meter thick then it should be capable of withstanding between 40-250 MPa of internal pressure before bursting. Note, for comparison, the pressure inside a typical hunting riffle's firing chamber is over 400 MPa, and the steel plating on battleships is usually over a foot (0.3 meters) thick. So, if the maximum internal pressure can be kept below 40 MPa it should be possible to build a durable reactor from a 5 m radius sphere with 0.25 m thick walls at a reasonable cost.

For some metals, such as many steels, there seems to be a stress level, below which the component will never fail due to fatigue. For other metals, such as aluminum alloys there is no fatigue limit and so the component will eventually fail due to fatigue. Carbon steel shows a fatigue limit of 300 MPa. Some super-alloys, like Ni₃Al actually have yield strengths that increase with temperature up to about 1000° C., giving super alloys there unrivaled high-temperature strength.

The major source of internal pressure is the vaporization of coolant after detonation—most glasses have very low (or negative) thermal expansion. So, how much coolant needs to be vaporized in order to impose 40 MPa of pressure throughout the remaining unvaporized coolant? For simplicity, assume the coolant is pure SiO₂ and that the pressure gets equally distributed throughout the entire sphere. Ignoring the amount of coolant that is vaporized, the amount of liquid coolant inside the sphere is 4/3π5³, and, since 40 MPa will reduce that volume by 40M/37 G (the bulk modulus of glass is 37 GPa), it follows that the vapor pocket creating this pressure must be 0.57 m³.

Vaporizing more coolant than what would fill a 0.57 m³ pocket with SiO₂ gas at 40 MPa could potentially destroy the reactor. So the next question is, how much energy does this correspond to? On the safe side (overestimating the proportion of energy that gets attributed toward increasing the internal pressure), we can assume that all of the energy of a detonation goes into heating a local pocket of coolant around the blast zone from 973 K up to its boiling point at 2503 K (specific heat=840 J/kg-K) and then through a phase change (heat of vaporization=12700 kJ/kg). Again, erring on the side of caution, assume that energy is neither radiated away electromagnetically nor acoustically. Using the ideal gas Law, PV=nRT, with P=40 MPa, V=0.57 m³, R=8.314, and T=2503 K, there would be 1096 moles of SiO₂ in the vapor pocket. SiO₂ weighs 60 g/mol, so that is about 66 kg. Heating 66 kg of SiO₂ from 973 K to 2503 K uses 85 MJ, and vaporizing it requires an additional 840 MJ. The PdV work of expansion is approximately (40M)(0.57)˜23MJ, and the total energy bill, ignoring radiant energy losses, is 85+840+23=948 MJ. So, according to this calculation, to avoid bursting the sphere the maximum yield should be kept below 948 MJ. But, if we assume that 80% of the fusion energy is carried away by high speed neutrons that thermalize several meters outside the blast zone, the yield could safely be increased to 4.7 GJ, five times larger.

This number seems reasonable when compared to the 20 GJ/shot that Sandia National Laboratories proposed, in Annual Report of 2005, for a cylindrical Z-IFE chamber 6 m radius and 8 m high, designed to operate at 0.1 Hz, for a fusion power of 2000 MW, because “the economics of scale will favor having a single chamber with the largest acceptable yield.”

The 4.7 GJ maximum yield value we calculated above is only a rough (But, safe!) approximation, it failed to account for several things, like electromagnetic radiation exiting the blast zone without returning, thermal conduction, and turbulent mixing of hot and cold fluids. The sphere's internal mirror only reflects 95-98% of incident light (per reflection), depending on the surface coating. Note—light can travel back and forth between the blast zone and mirror several thousand times before the wave of pressure from the explosion reaches the mirror, so a significant amount of absorption will take place at the mirror's surface before the central fireball can fully expand. This robs the blast zone of energy that would otherwise go into increasing internal pressure. Because the vapor is at a lower density and higher pressure than the coolant, Rayleigh-Taylor instabilities would be very pronounced. Taking all this into account, it would not be surprising if yields ten times greater than the 4.7 GJ safety limit that was originally calculated could be handled. The power production capacity for a plant, based on this example, would be far greater than the output of an average fission plant (˜1 GW), but, if capacities larger than this are desired the reactor could be made larger and/or the walls made thicker—it scales upward nicely.

### Coolant (Circulation Speed)

In BSF, it is important to maintain the correct circulation volume flow rate (l/s) inside the sphere. If the coolant circulates too slow the sphere will overheat and fail structurally. If the coolant circulates too fast, the coolant temperature will drop below the range needed by the degasser, and tritium bubbles will remain trapped. The coolant circulation speed (m/s) is unimportant, but controllable, by varying the diameter of the flow pipes.

There are strong incentives to develop high-temperature nuclear energy systems with coolant temperatures between 700° and 1000° C. Power plant efficiency increases with temperature, and there is a growing interest in hydrogen production using thermochemical hydrogen cycles that require high-temperature heat to convert water to hydrogen and oxygen. Preliminary cost estimates indicate that hydrogen production costs using these cycles to be ˜60% of the cost of hydrogen from electrolysis. Depending upon the system, heat must be delivered between 700° and 850° C.

Rankine steam cycles have served the utility industry well; however, the upper limit of practical steam cycles is between 500° and 600° C., making efficient utilization of the high-temperature heat at a reactor's core unavailable. In the last decade efficient Brayton power cycles, derived from aircraft engines, have been developed for utility applications. Now, using nitrogen or helium, high-temperature heat can efficiently be converted to electricity, and the potential for freezing in the heat exchangers is reduced.

High-temperature reactors with high efficiency and Brayton cycles dramatically lower the cost of dry (air) cooling and increase the number of options for nuclear-plant siting. In the United States, cooling water for steam plants is the largest single use of water.

The beauty of using high temperature primary coolants, and the reason they functions so well at such high temperatures (850° C. compared with 320° C. of conventional nuclear plants) is that helium can be used to cool them. Helium has three key advantages; (1) Helium remains as a gas, and thus the hot helium can directly turn a gas turbine, enabling conversion to electricity without a steam cycle, (2) Helium can be heated to a higher temperature than water, so that the outlet temperature can be higher than in water-cooled systems, and (3) Helium is inert and does not react chemically or corrode. This simplifies the design and increases the efficiency by over 50 percent compared to conventional water-cooled systems, thus reducing the cost of power production.

A significant experience base exists for only three candidate high-temperature liquid coolants: molten iron, molten glass, and molten fluoride salts. In BSF the coolant must function as a laser and tritium breeding blanket, so molten iron can be eliminated.

Many molten fluoride salts have excellent heat transfer properties, are optically transparent, have very low vapor pressures with boiling points in excess of 1400° C., are highly stable in radiation fields, and have relatively low viscosities. One often mentioned reactor coolant is Li₂BeF₄ (Flibe), with these properties:

| | |
|---|---|
| Melting point: | 459° C. |
| Boiling point | 1430° C. |
| Density | 1940 kg/m³ |
| Specific heat | 2.34 kJ/kg C |
| Thermal conductivity | 1.0 W/m C |
| Viscosity | @ 600° C.~olive oil |

Other molten salts include LiF, NaF, KF, BeF₂, and ZrF₄. These are all chemically stable with properties similar to water, but boiling at temperatures around 1400° C., and they can be combined in various mixtures. The Advanced High Temperature Reactor (AHTR) can achieve a thermodynamic efficiency of over 50% using molten salts and multiple-reheat helium Brayton cycles.

Even the uranium salt UF₄ is worth considering, but then you'd have a dirty blanket full of radioactive coolant. Lawrence Livermore National Laboratory is currently developing a hybrid fusion-fission nuclear energy system, called LIFE, to generate power and burn nuclear waste. It utilizes inertial confinement fusion to drive a sub critical fission blanket surrounding the fusion chamber. The sub critical blanket provides an additional gain of 4-8, depending on the fuel, currently a eutectic mixture of 73 mol % LiF and 27 mol % UF₄, with a melting point of 490° C. LIFE has the potential of fulfilling an important waste incineration mission, but proliferation is an issue, and it does not appear capable of operating under tritium self-sufficiency. LIFE's fusion neutrons can either be used for fission or to breed tritium, one or the other, not both.

If a molten fluoride salt could be found that was (1) laser active, (2) a breeder of tritium, (3) safe from accumulating harmful radioactive transmutations under neutron bombardment, (4) easy to process for tritium recovery, (5) non-corrosive, and (6) did not chemically react with the fuel, then it would be much preferred over molten glass, since molten glass has a viscosity similar to molasses and incurs significant frictional losses.

Going back to the previous example, how much heat will each 330 MJ explosion produce? About half the energy leaves the sphere and gets harvested by the piezoelectric transducers, so only 165 MJ of heat needs to be pumped out of the sphere before the next firing. If we assume that the temperature of the hot glass is 300° K above the cold glass, then the volume of glass that must be circulated between firings is: (1.65E8 J/firing)(1 kg K/506 J)(1000 g/kg)(cm³/3.86 g)(m³/1E6 cm³)(temp_change/300° K)(1000 liters/m³)(4 shots/min.)(1 min./60 sec.)=18.8 liters/sec. For the 1.5 GW scenario, about 1.3 cubic meters of hot glass must be removed from the blast zone every second.

### Other Coolant Materials

In the early stages of fusion work, FLiBe was suggested as a breeding blanket material in a helium cooled blanket. The deficiency of the breeding potential, primarily due to the low lithium concentration and attenuation of neutrons by the first wall, required additional neutron multiplier which complicated the blanket design. Early investigators found that changing the Be content of the coolant had surprisingly little effect, reducing the Be fraction from 90 to 45 vol % reduced the potential TBR from 2.37 to 2.21. More recently, mixtures of Pb and Li have been considered that are capable of increasing the tritium breeding ratio. In all of these cases, tritium's very low solubility makes separation and recovery fairly easy.

As a rule, the coolant cannot be allowed to freeze in the blanket and piping system. The blanket and the piping are all well insulated from the environment, so the small but finite amount of after-heat will keep the blanket temperature above the melting temperature of the coolant for several days. The blanket should be designed such that the coolant can be dumped readily to a dump tank when it is required. A dump system such as this is a standard requirement for any liquid system and does not represent extra cost. The coolant can be allowed to freeze in the dump tank on which a preheating system is built for melting it.

FliBe can be corrosive in the as received form. This is primarily due to the presence of free fluorine; this problem becomes more critical when tritium is bred, because the disappearance of either Li¹⁺ or Be²⁺, by transmutation, leaves a hole of increased F⁻ ion activity. Free fluorine atoms can then combine with available tritium to form TF, which poses a significant corrosion threat. Since the free energy of formation of TF is similar to that of VF₄, VF₅, and FeF₂ on a per g atom of F basis, it is expected that vanadium or iron will react and dissolve in the salt. Mo, W, Ni are more stable; this is the reason that the Molten Salt (fission) Reactor used high nickel alloys in its structural material. Unfortunately, high nickel alloys have not been considered for fusion environments due to both radiation enhanced induced embitterment and unfavorable neutronics characteristics, but, since these problems only occur when the nickel alloys are directly exposed to the blast, systems using compact blankets are immune.

It is undesirable for the coolant to dissolve the material it flows through. Here are some Free Energies of Formation, with ΔG^{F} 1000° K (kcal/g−atom of F), that are important to know when choosing structural metals designed to operate in a hot FLiBe environment:

| | | | | | | | | | |
|---|---|---|---|---|---|---|---|---|---|
| MoF₆(g) | −50.2 | WF₆(g) | −56.8 | NiF₂(d) | −55.3 | VF₅(g) | −58.0 | VF₄(cr) | −66.0 |
| HF(g) | −66.2 | FeF₂(d) | −66.5 | NbF₅(g) | −72.5 | CrF₂(d) | −75.2 | TaF₅(g) | −82.2 |
| TiF₄(g) | −85.4 | BeF₂(l) | −106.9 | LiF(l) | −125.2 | | | | |

Corrosion can be controlled by an electrochemical cell fabricated from a consumable anode of Be and a Ni cathode onto which metal plates-out. After addition of sacrificial Be to FLiBe, the corrosion of 316SS (stainless steel) is reduced by almost a factor of 50, by allowing the HF or free fluoride ions to react back to BeF₂. This idea has been carried further, the high nickel alloys used in the structure of a Molten Salt Reactor have been electrically charged with an externally generated potential causing active electroplating of selected metals:

nBe(s)+2MFₙ(salt)⇄nBeF₂(salt)+2M(s)

MFₙ(salt)+nLi(Bi)⇄M(Bi)+nLiF(salt)

One of the most difficult problems associated with using FLiBe is tritium management. The hydrogen isotopes dissolve in FLiBe in molecular form and, therefore, obey Henry's law: X=k_{H}P, in which k_{H} is Henry's law constant=0.23 wppm/atm, X is concentration, and P is pressure.

Due to the linear dependency, the solubility of tritium in FLiBe is very low at low T₂ pressure. If tritium cannot be tied up by lithium, the tritium will exist in T₂ form. Tritium can also exist as TF which has the potential to cause material compatibility problems.

Unfortunately (when considering the use of lithium hydrides as fuel additives), LiT is relatively stable and will dissolve in FLiBe, but its solubility and the fluorine activity can be controlled by dissolving a small amount of Be in the salt, which causes a small but significant amount of lithium to be released:

Li₂BeF₄+Be⇄2BeF₂+2Li

ΔG=(−460.02 kcal) (−427.6 kcal)

Although the forward reaction (→) is not favored by thermodynamic considerations, as indicated by ΔG values, the reaction still proceeds forward because

$$Δ G = - RT ln \frac{{{[ {BeF}_{2} ]}^{2} [ Li ]}^{2}}{[ Be ]} .$$

Adding 0.01 of beryllium will cause the beryllium concentration [Be] to reach a statistical equilibrium of 7.5×10⁻³, [Li] equilibrates at 5×10⁻³, and [BeF₂] and [Li] at 2×(0.01−[Be]).

The LiT dissolved in the salt can be recovered easily by an electrolysis process. The dissociation potential of LiT is around 1 volt while the dissociation potential of FLiBe is 4.7 volts. This difference in dissociation potential can be used to dissociate LiT, while the FLiBe remains stable.

The heat transfer characteristics of FLiBe are fairly similar to those of water. The key difference is the viscosity which is 70 times higher. Fortunately, neither heat transfer nor pressure drop depends strongly on viscosity. A typical heat transfer coefficient for FLiBe is 1.5 W/cm²-C°, while not as good as that of water, is much better than that of helium. Since the pressure drop is reasonable and the volumetric heat capacity is large, the power required to circulate the coolant is small. The melting temperature depends on the molar ratios of LiF to BeF₂, a 1:1 mixture melts at 363 C°, 2:1 at 460 C°, and 1:3 at 515 C°.

| | Li₂BeF₄ (600 C.°) | H₂O (260 C.°) | |
|---|---|---|---|
| Cₚ | 2.8 | 5.0 | J/g-C.° |
| ρ | 1.92 | 0.79 | g/cm³ |
| μ | 7.5 | 0.11 | cp |
| κ | 0.011 | 0.006 | W/cm-C.° |
| ρCₚ | 5.4 | 4.0 | J/cm³-C.° |

Safety issues identified include chemical toxicity, radiological issues resulting from neutron activation, and the operational concerns of handling a high temperature coolant. Beryllium compounds and fluorine pose toxicological concerns. Since FLiBe has been handled safely in other applications, its hazards appear to be manageable.

Some safety issues that require further study are:

1) at high temperatures, will fluorine release as a gas or remain in the molten salt?

2) will tritium migrate from the FLiBe into the cooling system?

Fortunately, the FLiBe itself is not a combustible material. FLiBe recombines reasonably fast from radiolytic decomposition, and it is also expected to quickly recombine from the Hall Effect as well because of the chemically reactive nature of fluorine.

Individually, the chemical constituents of FLiBe, fluorine, lithium, and beryllium, are highly reactive and therefore hazardous materials. When reacted together to form LiF and BeF₂, however, they become rather passive and do not show substantial chemical reactivity.

### Blanket Neutronics

This section covers two different coolant mixtures, based on either FLiBe or glass. For both mixtures, the primary source of tritium comes from transmuted lithium. Neutron multiplication is achieved using either beryllium (in FLiBe) or lead (in glass). A rare-earth laser-active element, like neodymium, can be dissolved into the mixtures, Nd₂O₃ (in glass) or NdF₃ (in FLiBe).

FLiBe is typically considered a low- to medium-activation material. The radioisotopes created from neutron activation of pure FLiBe are ¹⁰Be, ¹⁴C, and ¹⁸F. The dominant activation product was ¹⁸F, which has a half-life of 1.8 hours and decays by positron emission into ¹⁸O. ¹⁰Be has a half-life of 1.6 million years, no energetic decay radiation, and a low production cross section, so it does not present a significant radiological hazard. There will also be a significant amount of tritium (T_{1/2}=12.3 years) bred. In the event of a spill, gaseous tritium, in several forms, could be released from the FLiBe. Even if there is no spill, an important concern regarding tritium produced in FLiBe is its propagation to other parts of the fusion system. Solubility of hydrogen isotopes in FLiBe is very low. That means that even a small concentration of tritium produced in the FLiBe by neutron transmutation will have a very high chemical potential and will readily exit the FLiBe by whatever means are available. A particular concern in this regard is its ability to pass through the walls of heat exchanger tubes.

Another worrisome reaction can take place between fluorine and energetic (2.36 MeV) alpha-particles. The reaction, ¹⁹F+α→²²Na+n, creates ²²Na, which has a half-life of 2.6 years and emits hazardous 1.3 MeV γ-rays.

The neutron activation chain in FLiBe will lead to a build-up of deuterium, tritium, helium, boron, nitrogen, oxygen, and neon contaminants.

If glass (SiO2) is used in the blanket, then the following discussion of oxygen neutronics is relevant. Radioisotope ¹⁶N is the dominant radionuclide in the coolant of pressurized water reactors or boiling water reactors during normal operation. It is produced from ¹⁶O (in water) via (n,p) reaction. It has a short half-life of about 7.1 s, but during decay back to ¹⁶O produces high-energy gamma radiation (5 to 7 MeV). Because of this, the access to the primary coolant piping in a pressurized water reactor must be restricted during reactor power operation and for at least 10 minutes after a shutdown. ¹⁶N is one of the main means used to immediately detect even small leaks from the primary coolant to the secondary steam cycle.

Silicon has no known metastable isotopes, making it, along with phosphorus and magnesium, the only elements in the 3^{rd} group with this property.

In “Fundamentals for the development of a low-activation lead coolant with isotopic enrichment for advanced nuclear power facilities,” translated from Russian, scientists reported running calculations using FASPACT-3 code to simulate what would happen if natural Pb was irradiated for 30 years, to determine the long-lived toxic radionuclide accumulation levels that would be expected at a nuclear facility operated for that period of time. They discovered that, because of a build-up of ²⁰⁷Bi, ²⁰⁸Bi, and ²¹⁰Pb, the cooling down period would need to be extended in order to reach a safe clearance level. They concluded, this time could be shortened by using the lead isotope ²⁰⁶Pb instead of natural Pb, which is a mixture of four stable isotopes extracted from galena ores, ^{208, 207, 206, and 204}Pb, worth ˜$1/kg on the world market. Using ²⁰⁶Pb would substantially decrease the concentration of the most toxic polonium isotope, ²¹⁰Po, and the activity of ²⁰⁷Bi is reduced four orders of magnitude when ²⁰⁶Pb is used instead of natural lead.

The doubly magic (on account of its number of protons, Z=82, and neutrons, N=126) ²⁰⁸Pb accounts for more than half of the natural lead mixture.

The main source of ²⁰⁹Bi is the ²⁰⁹Pb nuclide, formed by radioactive capture of a neutron by the nucleus of ²⁰⁸Pb, which makes up more than 52% of the natural lead mixture. Capture of another neutron can transform ²⁰⁹Pb into the ²¹⁰Pb radioisotope but this process is less likely to occur than beta decay of ²⁰⁹Pb+β⁻→²⁰⁹Bi.

The alpha-active ²¹⁰Po isotope is another dangerous radionuclide. Its production is linked to the accumulation of bismuth in lead. So much ²¹⁰Po is produced in natural lead that, despite its relatively short half-life of T_{1/2}=138 days, spent lead achieves clearance from radiation monitoring of the ²¹⁰Po radionuclide only after 100 years. On the other hand, if the ²⁰⁶Pb isotope is used instead of natural lead, ²¹⁰Po activity decreases by four orders of magnitude and this type of coolant achieves clearance from ²¹⁰Po monitoring within 2 to 3 years of decommissioning.

Unfortunately, ²⁰⁶Pb enrichment costs about $10,000/kg.

### Tamper

A tamper is a jacket that surrounds the fusion fuel. It can provide reaction mass as an ablator to drive the radiation implosion, act as an inertial mass to confine the fusion fuel during the burn, act as a radiation container to prevent loss of heat during the burn, and act as an energy producing fuel by reacting with the neutrons produced by the fusion reactions.

In ICF, burn time is a function of ρR, the areal density. The fraction of fuel burnt is approximately 1/(1+7ρR). The fraction of fuel burnt in BSF could be much higher, because the containment (burn time) is expected to be much longer. Even prior to ignition, the improved containment of BSF allows larger and denser optically thick DT targets to be held for longer pre-ignition times, making low temperature volume ignition (as low as 1 keV, well below the ideal ignition temperature 4.3 keV) practical.

In BSF, the expansion of the reacting material is delayed by more than just the inertia of the implosion, the incompressibility of the coolant also helps to create a longer lasting, more energetic, and more efficient explosion. The most effective tamper is the one having the highest density; high tensile strength is unimportant because no material remains intact under these extreme pressures. Coincidently, high density materials are doubly suitable, since they also make excellent neutron reflectors.

The tamper material of choice, for “clean” (non-fissile or minimum residual radiation), seems to be lead or lead-bismuth alloy. Lead is a readily available, inexpensive material, and it has the second highest atomic number of any non-fissionable element available in significant quantity (Z=82). When irradiated with neutrons, neither lead nor bismuth produce isotopes that constitute substantial radiological hazards. Another relatively safe material is glass (SiO2), since it takes at least 3 neutron captures before the dominant isotopes, ¹⁶O=99.8% and ²⁸Si=92%, turn radioactive.

Lead has an interesting nuclear property, with 82 protons and 126 neutrons, it is very stable. Only a few elements besides oxygen have this type of “magic” nuclei, making them relatively immune to neutron bombardment.

### Ionization

At sufficiently high temperatures or pressures, the outer electrons of an atom can become excited to higher energy levels, or completely removed. Atoms with missing electrons are ions, and the process of electron removal is called ionization. The energy required to remove an unexcited electron is called the ionization energy.

The following table lists electron volt energies for multiple electron ionizations, and it implies that differential ionization compression should occur before ignition (1.6 keV):

| | 1^{st} | 2^{nd} | 3^{rd} | 4^{th} | 5^{th} | 6^{th} | 7^{th} | 8^{th} | 9^{th} | 10^{th} | 11^{th} | 12^{th} |
|---|---|---|---|---|---|---|---|---|---|---|---|---|
| H | 13.6 | | | | | | | | | | | |
| Li | 5.4 | 75.6 | 122.5 | | | | | | | | | |
| Be | 9.3 | 18.2 | 153.9 | 217.7 | | | | | | | | |
| O | 13.6 | 35.1 | 54.9 | 77.4 | 113.9 | 138.1 | 739.3 | 871.4 | | | | |
| F | 17.4 | 35.0 | 62.7 | 87.1 | 114.2 | 157.2 | 185.2 | 953.9 | | | | |
| Si | 8.1 | 16.4 | 33.5 | 45.1 | 166.8 | 205.3 | 246.5 | 303.5 | 351.1 | 401.4 | 476.4 | 523.4 |
| Pb | 7.4 | 15.0 | 31.9 | 42.3 | 68.8 | | | | | | | |

To convert the values in this table from electron-volt per particle to the “molar ionization” units of kilo-Joule per mole, multiply by 96.45.

Every electron dislodged from an atom becomes an independent particle and acquires its own thermal energy. Since the law E=NkT does not distinguish types of particles, at least half of the thermal energy of a fully ionized gas resides in this electron gas. At degrees of ionization much greater than 1, the thermal energy of the atoms (ions) becomes unimportant.

Although an electron gas is perfect (Γ=5/3), ionization tends to drive the effective value of Γ down in two ways. First, by absorbing energy, but more importantly by increasing N. The larger the number of free electrons, each sharing kT internal energy, the larger the sink is for thermal energy. Ionization has very important effects on shock waves. These effects are especially pronounced in regimes where abrupt increases in ionization energy are encountered (e.g. the transition from an un-ionized gas to a fully ionized gas; and the point after the complete removal of an electron shell, where the first electron of a new shell is being removed).

### Differential Ionization Assisted Fuel Compression

When two adjoining regions of “condensed matter” (solid or liquid) of different electron density are suddenly heated to the same extremely high temperature (high enough to fully ionize them) what will happen?

Since the temperature is the same, the radiation pressure in both regions will be the same also. The contribution of the particle pressure to the total pressure will be proportional to the particle density however. Initially, in the un-ionized state, the particle densities were about the same. Once the atoms become ionized, the particle densities can change dramatically with far more electrons becoming available from dense high-Z materials, compared to low density, low-Z materials. Even if the system is radiation dominated, with the radiation pressure far exceeding the particle pressures, the total pressures in the regions will not balance. The pressure differential will cause the high-Z material to expand, compressing the low-Z material. This type of compression is even more pronounced when low-Z gas is surrounded by high-Z condensed matter.

The process of ionization compression can be very important in a system, like BSF, where a high-Z material (like lead) directly contacts low-Z materials (like lithium hydrides). In fact, it is interesting and relevant to note that the main effort Soviet scientists made towards an H-bomb was the “Layer Cake” or Sloika design. It employed Vitali Ginzburn's idea of using solid lithium-deuteride fuel and Andrei Sakharov's notion of ionization compression of the fuel.

Another benefit, related to this topic, is that thermal conduction is inhibited at any interface between two plasmas with different temperatures and/or densities. Under these conditions an internal transport barrier exists, where electrons leave the Debye layer (λ_{D}={kT/[4πnₑe²]}^{1/2}) of the hot plasma toward the cold plasma while the ions stay behind in the Debye layer. Any electric conduction is then determined by the ions such that the thermal conductivity of the plasma is given by that of the ions, Kᵢ=K_{c}(m_{c}/mᵢ)^{1/2}. This discovery, that the charged energetic particles interact collectively with the whole electron cloud (not binary electron collisions), is in contrast to Beth-Block theory. Using this, the stopping length R of alphas from DT fusion can be approximated by R=(0.01-1.7)×10⁻⁴ T cm, in contrast to the, otherwise, T^{3/2} dependence of stopping by binary collisions.

Collisions between high-speed electrons and ions in the fusion plasma will produce (Bremsstrahlung) x-ray radiation of 10-30 keV. In heavy elements, electron energy levels can span a range of several keV; it takes 88,000 eV to remove the inner-most electron from Pb, but only 13.6 eV to remove hydrogen's lone electron. When an electron has been removed from an inner shell (e.g., as a result of collision with high-energy electrons that bombard the atom), another electron from outer shells can fill this vacancy by radiating an X-ray photon. These events can also proceed backwards, in the process of photo-ionization, the absorption of x-ray photons cause electrons to be ejected from the inner shells of heavy elements. To a large extent, the DT fuel will be transparent to the x-rays produced in hot plasma, but, because the coolant contains heavier elements, most of these x-rays will be absorbed (and converted into heat) after passing through less than a mm thicknesses of coolant. This process cools the fuel's core, and, at the same time, it heats the fuel's perimeter, causing coolant at the perimeter to expand and squeeze the fuel more tightly. This transfer of energy, from the inside to the outside, should lead to improvements in both fuel compression and fuel containment.

Heat loss by x-ray radiation, being a consequence of collisions of electrons and ions, is unavoidable, but, as pointed out in the previous paragraph, it can be curtailed, blocked by the presence of high-z elements inside of a BSF blanket. Furthermore, given that the amount of x-ray radiation coming from a DT plasma is expected to exceed the internal fusion power for temperatures less than about 40 million degrees Celsius (a point stressed by Lawson in his original paper), ICF/MCF community members must be disheartened by how helpless they are to control this type of loss.

Laser energy should pass through the transparent coolant unhindered until it encounters the fuel, where it will be strongly absorbed. The reason for strong absorption at the fuel's surface is that incident light cannot penetrate beyond a layer known as the critical surface, which for hot dense DT gas is only a fraction of a mm. The laser energy is absorbed close to the critical surface and carried by heat conduction. After the material near the current absorption sight becomes ionized, the absorption sight shifts, tracking the new location of critical electron density. In this way, a shock wave will propagate back through the coolant, away from the bubble, leaving everything in its wake strongly heated and ionized. Since the expansion of ionized coolant is what drives compression, an important question to ask is, how much coolant (volume) will be ionized?

This will be a rough estimate of the amount of coolant ionized when a 1.5 MJ laser is incident on a 0.50 cm radius bubble. The laser intensity would be 8.69×10¹² W, which corresponds to a temperature of 96 eV. For simplicity, lets assume the coolant is pure SiO₂, and lets also ignore some of the less significant details, like the energy needed to vaporize and atomize the coolant. At this temperature (1.1 million Kelvin) both Si and O will be ionized, with four electrons removed. Reaching this level of ionization for one Si and two O atoms requires (8.1+16.4+33.5+45.1)+2*(13.6+35.1+54.9+77.4)=465.1 eV per SiO₂ molecule. The number of particles that need to be heated to 96 eV is now 15, not the original 3, since there are also 12 electrons. Heating 15 particles to 96 eV requires 2160 eV (15*(3/2)*96), so the total energy bill is 2160+465.1=2625.1 eV per SiO₂ molecule, which is (2625.1 eV/SiO₂ molecule)*(1 Joule/6.24×10¹⁸ eV)(6.02×10²³ molecules/mole)=256 MJ per mole of SiO₂. Since SiO₂ has a density of 2.648 g/cm³ and one mole weighs 60 g, we can calculate the volume, (1 cm³/2.648 g)(60 g/mole)(mole/256 MJ)(1.5 MJ/total laser energy)=0.13 cm³, which, for a bubble of radius 0.5 cm, would correspond to a surrounding layer of coolant 0.4 mm thick. This might not seem like enough coolant to compress such a large bubble of gas, but, the atomic density of liquid coolant starts out several hundred times greater than that of gaseous DT fuel, and after ionization the particle density increases another 5 fold, so there should be plenty of coolant particles to fill whatever amount of DT gas is displaced when the bubble's radius shrinks, and, given that the temperature (and pressure per particle) of laser heated coolant is about a thousand times greater than inside the fuel, the expanding coolant should easily push the DT inward.

### Acoustic Waves

Acoustic waves are small-amplitude disturbances that propagate in a compressible medium through the interplay between fluid inertia and the restoring force of pressure. Any local pressure disturbance in a gas that is not too strong will be transmitted outward at the speed of sound. Such a spreading disturbance is called an acoustic wave. This speed, designated cₛ, is a function of gas pressure P, density ρ and gamma Γ; or equivalently by the temperature and R (the universal gas constant per unit mass), and is given by:

cₛ=(ΓP/ρ)^{0.5}=(ΓRT)^{0.5}, where R=kn/ρ=0.0821 (atmospheres*liters)/(moles*Kelvin).

A disturbance that decreases gas pressure is called a rarefaction wave, a disturbance that increases pressure is a compression wave. With either type of acoustic wave the change in state of the gas is essentially adiabatic.

When a gas is adiabatically expanded the speed of sound decreases, when it is adiabatically compressed cₛ increases. Lagging portions of compression waves tend to catch up with the leading edge since they propagate at higher speeds through the disturbed (compressed) gas. The pressure profile of the compression wave thus becomes steeper and steeper. When a portion of the wave catches up with the leading edge, the slope at that point becomes infinitely steep, i.e. a sudden pressure jump occurs. A wave that causes an instantaneous pressure increase is called a shock wave.

Compression waves are fundamentally unstable. They naturally tend to steepen in time and eventually (if they propagate long enough) will become infinitely steep: a shock wave. On the other hand, rarefaction waves are stable and a rarefaction shock (a sudden pressure drop) is impossible.

When a particle of matter passes through an ideal shock front it undergoes an instantaneous change in state. The pressure it is subjected to increases, it is compressed to higher density, its temperature increases, and it acquires velocity in the direction of shock wave travel.

It turns out that the shock transition occurs over a distance which is on the order of the molecular collision mean free path in the substance propagating the shock wave. That is to say, only one or two collisions are sufficient to impart the new shocked state to matter passing through the shock front. In condensed matter, this path length is on the order of an atomic diameter. The shock front is thus on the order of 1 nanometer thick! Since shock waves propagate at a velocity of thousands of meters per second, the transition takes on the order of 1E-13 seconds (0.1 picoseconds)!

The shock velocity is always supersonic with respect to the unshocked matter. That is, it is always higher than the speed of sound cₛ for the material through which the shock is propagating.

The shock velocity is always subsonic with respect to the compressed material behind the front. This means that disturbances behind the shock front can catch up to the shock wave and alter its behavior.

Obviously a shock wave does work (expends energy) as it travels since it compresses, heats, and accelerates the material it passes through. The fact that events behind the shock front can catch up to it allows energy from some source or reservoir behind the shock wave (if any) to replenish the energy expended (a fact of great significance in detonating high explosives).

A very weak shock wave travels only very slightly faster than sound, it creates a small pressure increase behind the front, imparts a small velocity to the material it passes through, and causes a extremely small entropy increase. The velocity of sound behind a weak shock is about the same as it is in front. The behavior of a weak shock wave is thus not much different from an acoustic wave (in fact an acoustic wave can be considered to be the limiting case of a weak shock).

As shock strength increases, the proportions by which the energy expended by the wave is divided between compressive work, entropic heating, and imparting motion also changes. The density of matter crossing the shock front cannot increase indefinitely, no matter how strong the shock. It is limited by the value of Γ for the material. The limiting density increase is:

density_ratio=(Γ+1)/(Γ−1)

Consequently, for a perfect monatomic gas the limit for shock compression is 4. Material with higher Γs (e.g. essentially all condensed matter) has a lower compressive limit. In regimes where abrupt increases in ionization energy absorption occur (initial ionization, initial electron removal from a new shell), the effective Γ can be driven down to the range of 1.20 to 1.25, leading to density increases as high as 11 or 12. As shocks continue to increase in strength above such a regime the kinetic excitation again dominates, and the value of Γ rises back to 5/3 (until the next such regime is encountered).

Since the degree of compression has a fixed limit, entropy must increase without limit.

In an extremely strong shock, almost all of the energy expended goes into kinetic energy and entropic heating. Subcritical radiative shocks are strong enough to achieve compressions close to the limiting value of (Γ+1)/(Γ−1); a factor of 4 for perfect gases. In strong subcritical shocks in low-Z gases (e.g. air) an effective Γ value of 1.25 is typical due to energy absorption in ionization, resulting in a density increase of 9.

### Shock Boundary Crossing & Reflections

If the material is not a gas but a solid (and the shock has not vaporized it), the situation is a bit different. The solid cannot expand indefinitely, so expansion halts when it reaches the normal zero pressure density. The release propagates backward at cₛ as before. In metals at moderate shock strengths (1 megabar and below), this expansion causes a phenomena called “velocity doubling”, since the release wave doubles the velocity imparted by the shock. This doubling law begins to break down when shock strengths are high enough to cause substantial entropy increases.

Another important difference in solids is the existence of tensile strength. We have seen that in detonation waves that the pressure drops rapidly a short distance behind the shock front. When high explosives are used to generate shocks in metal plates a phenomenon called “spalling” can occur due to the interaction between the tensile properties of the metal, the release wave, and this shock pressure drop.

As the rarefaction wave moves back into the plate, it causes the pressure to drop from the shock peak pressure to zero. As it moves farther back into the plate it continues to cause pressure drops of the same absolute magnitude. When it encounters pressures below the shock peak this means that the pressure in the plate goes negative, that is, tensile stress is produced (you can think of this as the faster moving part of the plate pulling the slower moving part of the plate along). If the negative pressure exceeds the tensile strength of the metal, the plate will fracture. The fracture may simply open a void in the plate, but often the velocity doubled layer will peel off entirely and fly off the front of the plate.

In BSF, when the shockwave reaches the outside of the metal sphere, some of the wave energy is reflected and negative pressures arise in the body, i.e. the outer surface experiences a tensile stress. If the tensile stress exceeds the ultimate tensile strength of the material, then a fracture or “scabbing” occurs at this point, and a layer of material (the scab) is split away from the surface and separates from the remaining material, moving away from the surface with a definite speed. The maximum tensile stress, above which steel breaks down under impulsive loadings, is of the order of 30,000 kg/cm².

If a shock wave crosses from a high density region into one that is much lower than the first, then the situation is essentially the same as the free surface case as far as the first material is concerned. The pressure at the release wave front will be negligible compared to the shock pressure and the escape velocity will be virtually the same. The increased particle velocity at the front of the release wave acts like a piston in the second material, driving a shock wave ahead of itself.

If the density of the second material is not negligible compared to the first, the result is intermediate between the case above and the case of a shock propagating through a material of unchanging density. The pressure at the interface drops, but not as drastically. The velocity of the release wave front is lower, and creates a shock in the second material that is slower, but with a higher pressure. The rear of the release wave travels backwards at the same speed (cₛ), but since the pressure drop at the release front is not as sharp, and it moves forward more slowly, the pressure gradient in the release wave is not as steep.

When shock waves meet a boundary with a higher density material a shock wave is reflected back into the first material, increasing its pressure and entropy, but decreasing its velocity.

If the second material is not enormously denser than the first, a transmitted shock is created in the second material, along with the reflected shock in the first. The shock reflection causes an increase in pressure and decrease in particle velocity in the first material. Continuity in pressure at the interface indicates that the transmitted shock must also be higher in pressure than the original shock, but the particle velocity (and shock velocity) will be lower.

An interesting situation occurs if a low impedance material is trapped between two high impedance bodies during a collision. This situation is similar to what is happening in BSF, where a low density gas bubble is compressed with high density matter. At the moment of collision, a relatively low pressure, high velocity shock is set up in the low impedance material, which is greatly accelerated. The colliding body is decelerated to a much smaller extent. The shock is transmitted through the low impedance layer, and is reflected at the high impedance boundary, bringing the material to a near-halt again. The intensified reflected shock travels back to the first body, and is reflected again. Each reflection increases the pressure of the shock, and the density of the low impedance material, and incrementally transmits momentum from the first high impedance body to the second. After enough reflections have occurred the first will have been decelerated, and the second body accelerated sufficiently to bring them to rest with respect to each other. In the process, the low impedance material will have been highly compressed by repeated reflected shocks.

### Spherical Compression

Spherical compression is the most rapid type of compression, any change in the radius is accompanied by a change in the volume that is proportion to the cube of the change in radius scale.

The most critical factor in characterizing implosion systems, besides geometry, is the pressure-time curve that actually causes the compression.

At one extreme we have gradual homogenous adiabatic compression. In this case the pressure exerted on the implosion system increases continuously, at a slow enough rate that the pressure within the implosion system is uniform everywhere. This type of implosion does not increase entropy and allows arbitrarily high degrees of compression, if sufficient force can be exerted.

The other extreme is shock compression. Here the pressure increase is instantaneous, and entropy is always increased. There is a theoretical limit to the degree of compression achievable in this manner, regardless of the shock pressures available. In shock ignition, the final step of the laser pulse has relatively high intensity, launching a converging shock wave into the compressed target to compress the “hot spot” and supposedly trigger ignition at a lower drive energy.

The most obvious method of achieving implosion is through convergent shock waves, and this was the first implosion system to be developed (during the Manhattan Project).

In a convergent shock wave the flow of matter behind the shock front is also convergent (inward directed). This means that following the shock compression there is an adiabatic compression phase in which the kinetic energy of the shocked material is converted into internal energy, causing the flow to decelerate. The pressure behind the shock front, rather than remaining constant as in a classical shock wave, continues to rise. The temperature is also higher in the wake of the shock; the ratio of those temperatures is proportional to the square of the Mach number. This increasing pressure is transmitted to the shock front, causing it to continuously strengthen and accelerate.

The velocity of a bubble interface can reach speeds on the order of four to five times the velocity of sound in undisturbed gas.

For an imploding air bubble, the Mach number approaches ∞ as the shock front moves closer to the focal point, which means that a tremendous amount of heating takes place. Furthermore, when the shock hits the center and explodes outward, the stuff that was behind the shock is suddenly in front of it again. This hot stuff is hit a second time, and its temperatures goes up by another factor of the square of the Mach number.

Although the increase in shock strength is unbounded in principle, subject only to the granularity of atomic structure, in practice the symmetry of the implosion breaks down long before then, providing a much lower limit to the maximum degree of energy cumulation. In contrast to plane or divergent shocks, which are stable, convergent shocks are unstable and irregularities will grow with time. In addition, liquid, which is normally thought of as being incompressible, becomes very compressible under high (gigabars) pressures. Computer simulations of bubbles under gigabar compressions in liquids, show that almost all the compression energy goes into compressing the liquid (like storing energy in a compressed spring) and only about one millionth goes into compressing the bubble. However, BSF is only expected to need acoustical compressions of a few megabar (enough for pre-compressing the fuel and triggering a sonoluminescent burst) or less, because it is the electromagnetic radiation coming from the laser medium, not the acoustic pressure, that supplies energy for thermonuclear ignition.

When a converging shock reaches the center of the system it should, theoretically, create a reflected shock moving outward driven by the increasing pressure toward the center. This shock is a relatively slow one (compared to the imploding phase). The reflected shock front reverses the inflow of gas. Behind the front the gas is expanding outward, again quite slowly compared to its inward velocity. The density reaches a new maximum at the shock front, but falls rapidly behind it reaching zero at the center. This is a consequence of the increasing entropy toward the center, but is augmented by the fact that pressure drops behind a diverging shock front. The new density maximum is thus a local phenomenon at the shock front. Matter is actually being driven outward from the center and for any volume around the center, the density falls continuously once the reflected shock front has passed. You can think of the implosion as having “bounced” at the center, and is now rebounding outward.

Whether the high densities achieved at the outgoing shock front are “useful” or not depends on the characteristic length scale of the physical processes being enhanced by the compression. In a fission reaction the scale is given by the neutron mean free path, the average distance a neutron travels between interactions, which is typically a few centimeters. If the thickness of the shock compressed layer is less than this, the reaction will be more affected by the average density of the core than by the local density at the front. In a fusion reaction the reaction rate at a given temperature is governed by the local density of the fuel, so the reaction rate will be enhanced by the rebounding shock.

It appears that the peak compression at the reflected shock is less than that predicted by theory and its not hard to guess why. Before this second symmetric shock phase begins the implosion has to pass through a singularity in the center where the shock front decreases to zero size, and increases to infinite strength. Since implosion symmetry breaks down before this point, we actually get a turbulent flow that dissipates some of the inflowing kinetic energy as heat. We thus get an expanding stagnation front with higher entropy increases, and lower compressions than theory would indicate.

If the main imploding mass is surrounded by a higher density imploding shell (which presumably originated the initial convergent shock) then additional compression is achieved when the outgoing shock is reflected at this high density interface. A series of alternating inward and outward reflected shocks will achieve very high densities. In this case it is the kinetic energy of the decelerating high density layer (acting as a pusher/tamper) being brought to rest that is supplying the additional compressive work.

If the pressure increase is divided between a large number of weak shocks, the effect is essentially identical to adiabatic compression. In fact, true adiabatic compression can be considered the limiting case of an infinite number of infinitely weak shocks. Conversely in very rapid adiabatic compression where the pressure gradients are steep, the inherent instability of compression waves tends to cause the pressure gradient to break up into multiple shocks. Thus for practical purposes the multi-shock and adiabatic compression approaches are closely related, and either model can suffice for analyzing and modeling extreme compression.

Two general styles of multi-shock implosion are possible. The first has already been described—a convergent shock system with reflection. In this system, each successive shock is going in the opposite direction as the previous one, and requires shock drivers on each side. An alternative approach is unidirectional shock sequences. In this approach a succession of shocks travel in one direction in “follow-the-leader” style.

In an optimal unidirectional multi-shock implosion system the shocks would be timed so that they all reach the center simultaneously (each successive shock is faster and will tend to overtake the earlier shocks). If they overtake each other earlier, then a single intense shock will form. If they do not merge before reaching the center, then shock wave rebounds will collide with incoming shocks, creating complicated shock reflection effects. Similarly the time pressure curve in adiabatic compression should avoid steepening into a single strong shock, or breaking up into a rebounding shock sequence.

In situations where two fluids are exerting forces on each other it is possible for instabilities to arise at the interface and grow with time, magnifying the original imperfections. If unchecked this could lead to rapid decompression and cooling. In these situations the amplification of irregularities is lower for higher accelerations, since there is less time for growth. In the limiting case of shock acceleration, no growth occurs. It is only when unbalanced forces exist for significant time intervals that the instability becomes a problem.

### Sonoluminescence (Maximizing)

In Journal of Fluid Mechanics 1998 “Analysis of Rayleigh-Plesset dynamics for sonoluminescing bubbles,” it was suggested that the ideal fluid for creating a violently collapsing but surface-stable bubble should have a low surface tension and a high viscosity . . . other suggestions capable of up-scaling the collapse intensity would be to use lower driving frequencies and/or larger ambient pressures at the same P_{driver}/P_{ambient}. BSF already incorporates several of these suggestions into its physical design, and its operational methods can incorporate the rest. In addition, the high ambient temperature inside of a BSF reactor should result in higher post-compression temperatures. Taken altogether, it should be easy to create a luminous burst of sufficient strength to trigger the necessary laser cascade.

Recent experiments conducted by the University of Illinois at Urbana-Champaign indicate temperatures of at least 20,000 K, in an oscillating bubble, but higher temperatures could be achieved, if the bubble was not required to be trapped and oscillating, by one powerful squeeze. In this method of Single Cavitation Bubble Luminescence (SCBL) the number of emitted photons per flash and the pulse duration are both much greater than in Single Bubble Sonoluminescence (SBSL). Another advantage of SCBL over SBSL is that SCBL bubbles can be about a thousand times bigger (radius=˜3 mm) and take a hundred times longer (˜100 μs) to collapse.

Under low driving pressure, the presence of a noble gas in the bubble was found to be crucial for producing stable high-intensity light emissions. Without the noble gas, there was a low temperature ceiling, of about 6000 K, most likely the result of molecular disassociation, H₂+hv→2H, inside the bubble. It takes energy to break bonds, and the noble gases have none.

Under driving pressures from 1.9 to 3.1 bar, the observed emission temperature ranges from 6200 K to 9500 K. The temperature also increases if monatomic gasses are dissolved inside the bubble, such that higher temperatures are achieved by heavier Nobel gasses.

The initial stage of bubble collapse is slow and isothermal, during which the energy deposited in the bubble interior is readily transferred to the surrounding liquid via thermal conduction. As the speed of collapse increases the interior of the bubble undergoes compressional heating and becomes increasingly adiabatic due to the rapidity of the bubble collapse.

In the fluid surrounding the bubble, viscosity must be small for sound to be a wave process, both the threshold stress and temporal variations must be small for the waveform speed not to distort considerably from a constant, during propagation of a sound pulse in a medium. Shock waves in liquids are known to cause spherical gas bubbles to rapidly collapse and form strong re-entrant jets in the direction of the propagating shock. Viscosity has a strong influence on the dynamics of surface oscillation, instabilities become weaker at higher viscosities. High viscosity might play a significant role in suppressing the jetting; recent experiments involving laser-induced bubble growth and collapse in viscous fluids suggest that higher viscosity fluids both suppress the strength of the jetting and slow the time scale of the collapse.

### Opacity

To characterize the optical properties of the medium (also called the “opacity”) with a single number we can use the “total absorption coefficient” (also called the attenuation or extinction coefficient), which is the sum of the absorption and the scattering coefficients.

Many substances (e.g. color/absorption centers) are selective in their absorption. They absorb certain portions of the visible spectrum, while reflecting others. The frequencies that are not absorbed are either reflected back or transmitted for our physical observation.

Since, with few exceptions, the cross section of each mechanism of interaction varies with photon energy, the optical coefficients vary with photon energy as well. If we are dealing with a mono-energetic flux of photons (like laser beams) then we need to have absorption and scattering coefficients for that particular photon frequency. If the flux contains photons of different energies then we must compute overall coefficients by averaging over the spectral distribution, a process that is straightforward only for optically thin mediums, where photon emissions are spontaneous and independent of other photons.

The mechanisms of absorption and emission can produce local features in the blackbody spectrum. For example, a strong absorption line can create a narrow gap at a particular frequency. The energy missing in this gap will be exactly balanced by the increased intensity in the remainder of the spectrum, which will retain the same relative frequency-dependent intensities of the ideal black body spectrum.

A second caveat is that the blackbody spectrum only applies to systems in thermal equilibrium. Specific mechanisms can dominate non-equilibrium situations, and can occur without significant counterbalance by the reverse process. Laser emission and fluorescent emission are common examples of non-equilibrium processes.

The physics of these mechanisms is often extremely complex (especially the bound-bound and bound-free processes), even the process of developing simplifying approximations is hard. It is thus often very difficult to determine what the values of the optical coefficients should be.

In hot dense gases that are not completely ionized (stripped of electrons) line absorption contributes significantly to the opacity of the gas, and may even dominate it.

When matter is being heated by a thermal photon flux (that is, the matter is not in thermal equilibrium with the flux), photoelectric absorption (a bound electron absorbs a photon with energy at least equal to its binding energy, and thereby is dislodged from the atom) tends to dominate the opacity.

The reverse process by which atoms capture electrons and emit photons is called radiative electron capture.

Photons can interact with matter in two ways, by bremsstrahlung absorption/emission and by photon scattering.

The term “bremsstrahlung” is German and means “slowing down radiation.” It occurs when an electron is slowed down through interaction with an ion or atom. The momentum, and a small part of the energy, is transferred to the atom; the remaining energy is emitted as a photon. Inverse bremsstrahlung (IB) occurs when a photon encounters an electron within the electric field of an atom or ion. Under this condition it is possible for the electron to absorb the photon, with the atom providing the reaction mass to accommodate the necessary momentum change. In principal bremsstrahlung can occur with both ions and neutral atoms, but since the range of the electric field of an ion is much greater than that of a neutral atom, bremsstrahlung is a correspondingly stronger phenomenon in an ionized gas.

Since mᵢ/mₑ (the mass ratio between the ion and electron) is 1836 A (where A is the atomic mass of the ion), the velocity change ratio is 1/1836 A. Kinetic energy is proportional to mv², so the kinetic energy change for the ion is only about 1/1836 A of the energy gained or lost by the electron. Bremsstrahlung/IB is thus basically a mechanism that exchanges energy between photons and electrons. Coupling between photons and ions must be mediated by ion-electron collisions, which requires on the order of 1836 A collisions.

Unlike the bound-bound and bound-free processes, whose macroscopic cross section is proportional to the density of matter, the bremsstrahlung/IB cross sections increase much faster with increasing density. It thus tends to dominate highly ionized, high density matter.

The absorption coefficient kᵥ from bremsstrahlung (assuming a Maxwellian electron velocity distribution at temperature T) in cm⁻¹ in the CGS (centimeter, gram, second) system is:

kᵥ=3.69E8(1−Exp(−hv/kT)(Z³nᵢ²)/(T^{0.5}v³)

where

Z=ionic charge

nᵢ=ion density

All of the processes described so far are absorption and emission processes which involve photon destruction and creation, and necessarily exchange substantial amounts of energy between matter and the radiation field. Photon scattering does not, in general, involve significant exchanges in energy between particles and photons. Photon direction and thus momentum is changed, which implies a momentum and energy change with the scattering particle. But photon momentum is usually so small that the energy exchange is extremely small as well.

At a sufficiently high temperature, the bremsstrahlung absorption coefficient may become smaller than the scattering (Thomson) coefficient, which will then tend to control radiation transport. When the photon energy becomes comparable to the electron rest-mass (511 keV), the photon momentum is no longer negligible and an effect called Compton scattering occurs. This results in a larger energy-dependent scattering cross section. Compton scattering transfers part of the energy of the photon to the electron, the amount transferred depends on the photon energy and the scattering angle. At high thermonuclear temperatures (35 keV) a significant proportion of photons in the upper end of the Planck spectrum will undergo this process.

An ion strongly interacts with the X-ray spectrum (is opaque to it) when it possesses several electrons, because it then has many possible excitation states, and can absorb and emit photon of many different frequencies. A material where the atomic nuclei are completely stripped of electrons must interact with X-ray photons primarily through the much weaker processes of bremsstrahlung or Thomson scattering. High atomic number atoms hold on to their last few electrons very strongly (the ionization energy of the last electron is proportional to Z²), resisting both thermal ionization and high pressure dissociation, which is the primary reason they are opaque.

Even when comparing two different fully ionized materials, the higher Z material will more readily absorb photons since bremsstrahlung absorption is proportional to Z² (equal particle density) or Z³ (equal ion density).

An important caveat to the above is that at the very high pressures needed for fusion, essentially any element will become opaque. The density of Fermi degenerate matter under some specific pressure is determined by the density of free electrons. Under the enormous compressive forces generated during implosion the electron density becomes so high that even the “weak” Thomson scattering effect becomes strong enough to render matter opaque. This is important for the energy confinement needed during the thermonuclear burn.

The very high Z fissile material radiates thermal energy at an extraordinary rate (over seven hundred thousand times faster than hydrogen), and would quench the fusion reaction if the energy could escape.

Due to the complexity of the interacting processes that determine the opacity of incompletely ionized material at local thermal equilibrium, theoretical prediction of these properties is extremely difficult. In fact, it is impossible to make accurate predictions based on first principles, experimental study is required. It is interesting to note that opacity data for elements with Z>71 remain classified in the US, and even the well-known fact that lead (Z=82) is used for radiation case linings has only recently been declassified.

The optimal material for radiation confinement should have maximum optical thickness per unit mass. Opacity increases with atomic number, but for a given radiation temperature the increase with Z probably declines at some point. Since atomic mass also increases with Z, there is probably an optimal element for any given radiation temperature that has a maximum opacity per unit mass.

### Lasing

The basic reason why lasers are such powerful light sources is that the laser medium absorbs and accumulates the energy that is pumped in over a relatively long period of time (for Nd:glass laser ˜1 ms) whereas the timescale for output is relatively short (˜1 ns) giving a 1E6 increase in power. These extremely high peak power densities can heat small amounts of matter to the temperatures required for fusion, but in order to attain such temperatures the mass of the fuel must be kept quite low. As a result, fuel capsules are quite small. Typical dimensions are less than 1 mm. Fuel capsules in reactors could be larger (over 1 cm) because of the increased driver energies available.

Atoms (or ions, or molecules) have quantum-mechanical energy levels. When pumped or excited into higher energy levels by various methods these atoms can make downward transitions to lower levels, emitting radiation matching the characteristic transition frequency in the process. These transitions can be either spontaneous or, in the case of lasers, stimulated by proximity with photons having wavelengths close to the desired transition frequency.

For laser action to occur, the pumping process must produce not merely excited atoms, but a condition of “population inversion”, in which more atoms are excited into some higher quantum energy level than are in some lower energy level in the laser medium.

Once population inversion is obtained, electromagnetic radiation within a certain narrow band of frequencies can be coherently amplified if it passes through the laser medium. This amplification bandwidth will extend over the range of frequencies within about one atomic line width or so on either side of the quantum transition frequency from the more heavily populated upper energy level to the less heavily populated lower energy level.

The energy levels of rare-earth ions such as Tb³⁺ or Nd³⁺ are associated with the electrons in the partially filled 4f inner shell of the rare-earth atom. In nearly all solid materials, these inner electrons are well shielded, by surrounding outer filled electron shells. These ions are also well protected from most chemical and thermal disturbances as well as from the crystalline Stark effects caused by the bonds to surrounding atoms in the crystal or glass material. Hence the quantum energy levels of such rare-earth ions are almost unchanged in many different crystalline or glass host materials.

The transparency of glass in the visible spectrum means that the Si⁴⁺ and O²⁻ atoms, when they are bound into the glass network crystal lattice, have no absorption lines from their ground energy levels to levels anywhere in the visible regions.

All of the resonant absorption processes involved in an optically transparent material can be explained by the same common principle. At particular frequencies, the incident radiation is allowed to propagate through the lattice producing the observed transparency. Other frequencies however, are forbidden when the incident radiation is at resonance with any of the properties of the lattice material (ie. Molecular vibrational frequencies), and as such are transferred as thermal energy, exciting the atoms or electrons.

Almost any material containing small amounts of Tb³⁺, for example, will fluoresce with the same brilliant green color around 540 nm, and materials containing Nd³⁺ all fluoresce strongly around 1060 nm in the near infrared. There are also several other such rare-earth ions, including Dy²⁺, Tm²⁺, Ho³⁺, Eu³⁺, and Er³⁺, that make good to excellent laser materials. Oxide powders of these rare-earth elements will become transparent if finely ground and placed in wet colloidal suspension. Moreover, when the size of the scattering center (or grain boundary) is reduced well below the size of the wavelength of the light being scattered, the light scattering no longer occurs to any significant extent.

The amplification (gain) in ruby and other solid-state lasers is often much higher than in gas lasers.

Rare-earth-doped laser crystals often exhibit sharply defined laser and pump transitions, which typically have a bandwidth of a few nanometers or less. In contrast, glasses typically have much broader transitions with bandwidths of the order of tens of nanometers. This difference arises from the fact that in many laser crystals the laser-active ions occupy only a specific site of the crystal lattice, so that all laser-active ions see the same surroundings, whereas glasses offer many different environments to these ions, so that there is strong inhomogeneous broadening. Rare-earth ions in a glass can absorb radiation (“absorb photons”) from light sources at any of these particular frequencies, and as a result be lifted up to various of the upper levels. This excitation is enhanced by the fact that in solids the higher energy levels are often rather broad bands. The absorption lines in gases are typically sharper or narrower than those in solids or liquids, since the energy levels in gases are not subject to some of the perturbing influences that tend to broaden or smear out the energy levels in liquids or solids. The absorption line widths of rare-earth glass lasers are thus relatively broad, permitting reasonably efficient absorption of continuum radiation sources.

There are actually two quite separate kinds of downward relaxations that occur in these solid-state materials, as well as in most other atomic systems. One mechanism is radiative relaxation, which is to say the spontaneous emission of electromagnetic or fluorescent radiation.

Nonradiative relaxation occurs when excited ions get rid of the transition energy not by radiating electromagnetic radiation somewhere in the infrared, but by setting up mechanical vibrations of the surrounding crystal lattice. To put this in another way, the excess energy is emitted as lattice phonons, or as heating of the surrounding crystal lattice, rather than as electromagnetic radiation or photons—hence the term nonradiative relaxation.

Transitions between vibrational quantum states typically occur in the infrared and transitions between rotational quantum states are typically in the microwave region of the electromagnetic spectrum.

Nonradiative relaxation can be a particularly rapid process for relaxation across some of the smaller energy gaps for rare-earth ions and other absorbing ions in solids. For example, in terbium as in many other rare-earth ions, there may be many rather closely spaced levels or bands at higher energies; but then the energy gap down from the lowest of these upper levels (the 5D4 level in terbium) to the next lower group of levels may be larger than the frequency of the highest phonon mode that the crystal lattice can support.

As a result, the terbium ion cannot relax across this gap very readily by nonradiative processes, i.e., by emitting lattice phonons, since the lattice cannot accept or propagate phonons of this frequency. Instead the atoms relax across this gap almost entirely by radiative emission, i.e., by spontaneous emission of visible fluorescence. Across other, smaller gaps, however, the nonradiative relaxation rate is so fast that any radiative decay on these transitions is completely overshadowed by the nonradiative rate.

This behavior is typical for many other rare-earth ions in crystals and glasses. Following optical excitation to high-lying levels, the atoms relax by rapid nonradiative relaxation into some lower metastable level, from which further nonradiative relaxation is blocked by the size of the gap to the next lower level. The nonradiative decay time of the atoms via phonon emission across the smaller energy gaps may be in the subnanosecond to picosecond range—too fast to be easily measured—and the average lifetime of the same rare-earth ions in their metastable levels, before they radiate away their energy and drop down, is typically between a few hundred microseconds and a few milliseconds.

In general, any nonequilibrium situation that involves intense enough energy deposition is reasonably likely to produce laser action, given the right conditions. Schawlow's Law asserts that anything will lase if you hit it hard enough, and he illustrated this by building, and then consuming, the first edible laser—a fluorescein dye in Knox gelatin.

Preliminary laser fusion experiments use a small mode-locked neodymium-YAG laser oscillator to generate a 10 mJ input pulse at 1060 nm, followed by a chain of successively larger Nd:glass amplifiers to amplify the pulse to the required final energy. The amplifier material consists of a special glass doped with ˜5% by weight of Nd₃O₅ to give ˜4.6E20 Nd³⁺ ions/cm³. For an Nd:FliBe laser, preliminary studies indicate that keeping the concentration of Nd³⁺F₃⁻ (a blue powder that melts at 1374° C. and boils at 2300° C.) below ˜2 mol % @ 600° C. is needed to prevent precipitation of the rare-earth element solid-solution phase. The laser transition is between two excited energy levels of the Nd ions. As a reasonable estimate, perhaps 10% of the available Nd ions can be pumped into the upper laser energy level, and then 1% of those excited ions can be stimulated to make downward transitions by the ultra short laser pulse as it passes down the amplifier chain. In the Mercury laser, this inefficiency is reduced by having the pulse pass through the first and second amplifiers and reflect back through both, and then sending it back for a third and fourth pass through the amplifiers to provide optimum energy extraction.

These ultra short pulses are required for the “fast ignition” versions of ICF. Fast ignition is expected to increase energy gains by about an order of magnitude when compared with central hot-spot ignition. But fast ignition has problems too, and, in 2005, Sandia National Laboratories concluded in their Annual Report, “We determined that fast ignition is not the most promising ignition concept, and it will be dropped from our research to maximize progress on the remaining options.”

BSF uses the slower, more robust approach of “volume ignition,” where the entire mass of fuel is evenly heated, instead of just a tiny speck in the center. Volume ignition does not depend on the extremely precise spatial and temporal focusing techniques that fast-ignition requires. BSF has an advantage over ICF in that the fuel is held together by more than just inertia, it is surrounded by a large quantity of pressurized, high-density, coolant material that is moving inward at high velocity. This prevents the fuel from expanding outward, and allows extra time for additional laser passes to take place, resulting in the maximum extraction of energy from the laser medium. In addition, the reflective surfaces inside of a BSF reactor causes most of the radiant energy to be returned to the fuel. This makes it easier for the fuel to self-heat, and it lowers the ignition temperature. With this in mind, fast-ignited ICF targets are not expected to have higher gains than what is expected from BSF using the simple, robust technique of low-temperature volume-ignition.

IN THE FIVE YEARS after the invention of the laser in 1960, tabletop lasers advanced in a series of technological leaps to reach a power of one gigawatt (10⁹ W). For the next 20 years, progress was stymied and the maximum power of tabletop laser systems did not grow. The sole way to increase power was to build ever larger lasers. Trying to operate beyond the limiting intensity would create unwanted nonlinear effects in components of the laser, impairing the beam quality and even damaging the components. Only in 1985 was this optical damage problem circumvented, with the introduction of a technique known as chirped pulse amplification (CPA) by the research group led by one of us (Mourou). Tabletop laser powers then leaped ahead by factors of 10³ to 10⁵.

At higher energies the peak intensity of an ultra-short pulse can damage conventional laser optics, changing the properties of the medium and even breaking it down. (In fact, a proposed application of high-power ultra-short pulses is to discharge thunderclouds by ionizing a conducting path in the air.) For a long time, these problems limited focused laser intensities to about 10¹⁵ watts per square centimeter. In 1985 Gérard A. Mourou and Donna Strickland, then at the University of Rochester, developed a technique, known as chirped-pulse amplification, that overcomes these difficulties. The pulses are stretched out by a process known as chirping, which lowers their intensity and lets them be amplified by a conventional gain medium. The amplified stretched pulses are then recompressed using sturdy diffraction gratings in a vacuum. Early designs required many stages of amplification and were confined to large laboratory installations. Today we have benchtop terawatt (10¹² watts) lasers with output beams that can be focused to extremely high intensities (10¹⁸ watts per square centimeter). Glass lasers, which use glass rather than gas for a lasing medium, generate tremendous temperatures and are susceptible to fracturing. Indeed, the lens of an NIF prototype laser—or “beamlet”—shattered in a test firing at Livermore in September.

There are several advantages to using a fluid, instead of a solid, laser medium. Liquid lasers have high optical damage thresholds, and do not permanently damage if the threshold is exceeded. Bulk damage to the laser media, such as accidental self-focusing in the gain media, in the solid-state case requires a major tear down of the system and the replacement of the expensive highly optically worked gain media. The equivalent event in the liquid case would be just bubble tracks in the liquid, which would clear. One other advantage is that the cost of fluid media will, in general, be much less than an order of magnitude less than the cost of solid media.

In BSF, if the laser is to penetrate through the liquid and illuminate the fusion core, then the intensity must be kept below the damage threshold, which, for conventional glass-based media, has an approximate upper limit of roughly 10¹⁵ W/cm².

A common problem facing the design and application of high average power lasers is the need to reject a sizable amount of waste heat from the laser medium. The amount of waste heat deposited in the active medium during the lasing process is one of the key limitations in power performance levels in solid-state lasers. Removing this waste heat creates thermo-mechanical stresses which could lead to fracture of the lasing medium. Stress fracture limitations make conventional solid-state lasers unsuited for high average power tasks. For continuous operation of solid-medium lasers there is no option but to have a cooling system rated at the full heat generation, but a smaller cooling system can be used for limited runtimes. In a “heat capacity laser” the medium is allowed to heat up during operation, then, after shutdown, the heat is rejected at a slower rate in preparation for the next run period.

In the state of the art solid-state heat capacity system, the heat is stored in the lasing media itself, which is also thermally isolated. The amount of energy the laser can put out during operation is proportional to its mass, the heat capacity of the active medium material, and the temperature difference over which it is being operated. A liquid heat capacity laser can be pumped much harder than conventional solid-state media since there are no internal stresses (driven by temperature gradients). The on time would be dictated by the elevated temperature laser dynamics.

Good activator choices for liquid lasers are the rare earth ions for the same reasons that they are the favorite of solid-state lasers. Neodymium based lasers have the advantage of a long fluorescent lifetime, so they require lower peak pump powers. Activated liquids would generally show the same effects as solid-state systems, where temperature limits would be set by level population redistribution effects. This would set an upper temperature of about 1200° C. for a liquid Nd system. Another possible limiter would be the liquid decomposition temperature. For a standard atmosphere circulation system, the boiling point could also fix the upper temperature. The size of ΔT is set on the low side by the freezing point temperature of the liquid. The idea of dissolving Nd³⁺ in a liquid host actually dates back to the 1960s, but it was abandoned at that time, because the only excitation sources were flash lamps, and optical distortions were large and varied from pulse to pulse with complex temporal and spatial dependencies.

### Laser Diode Pumping

High-power laser diode arrays are currently capable of supplying thousands of watts of light, and this technology is still young and developing rapidly. NIF currently plans on using hundreds of 1.45 kW diode arrays to generate the 1.8 MJ (500 TW for 3 ns) it needs. Unfortunately, for NIF, the initial safe operating point of the laser system (I.e. the optics) has been reduced by 60%, thereby reducing the beam energy that can be delivered routinely to the target chamber to 0.6 MJ, one-third of the projects original 1.8 MJ specification, and one-half of the minimum energy that NIF project scientists calculate is needed to drive a lower temperature ICF target to ignition. Laser diodes are 20 to 40 times more efficient than flash tubes (which, because of their broad spectrum, are only 1-2% efficient) for pumping solid state lasers.

The beams from multiple diode arrays can be combined by coupling each diode into an optical fiber, which is placed precisely over the diode (but behind the micro-lens). At the end of the fiber bundle, the fibers are fused together to form a uniform, gap-less, round profile.

In BSF, these bundles are fed through apertures, shafts that are drilled into the sphere's shell. This allows the pump's light to enter and be dispersed. The glass in these bundles should be high quality (i.e. fused quartz), to prevent optical losses and/or melting. Fused quartz also has a very low expansion and high thermal shock resistance.

For example, based on BSF volume-ignition @1.6 keV with gain=550, igniting a D-T target capable of producing a 1 GJ yield would require pumping the laser diodes with 1.8 MJ of energy. If we assume this amount of energy needs to be deposited in <300 μs, the laser diodes must be capable of supplying about 6 GW of power. If there are 16 VLSAs with 32 elements each, then there would be 1024 (16*2*32) fiber optic cables available for pumping, and if this power gets equally distributed, each cable would need to carry a brief 6 MW (6 GW/1024) burst. Achieving these pump conditions does not appear problematic, current off-the-shelf non-solarizing fiber bundles with flexural strengths>50,000 PSI designed for use in applications with temperatures as high as 1500 C are available, and scaling up for larger yielding targets is a simple matter of adding more power and more, or bigger, cables.

To insure that the cables do not fuse from overloading, which might happen if they are damaged or exposed to shock while carrying extended-time loads of more than 2 MW/cm², the cable radii should be >0.97 cm (3 cm² cross section). In addition, laser glass can be permanently damaged by short-pulse optical power densities exceeding 10¹⁰ W/cm².

### Gain Material (Selection of)

The selection of gain material for a complex laser is driven by multiple, sometimes conflicting, issues. Here, we'll concentrate on the three issues that most directly impact efficiency, cost, and durability. These issues are: quantum defect, upper-lasing-level lifetime, and emission cross section. Essentially, these can be translated to the amount of energy (heat) left in the laser gain medium after efficient lasing, the number of diode pump lasers required to effectively provide the gain, and the amount of laser light (fluence) needed to circulate through the laser gain medium to efficiently extract the stored energy.

In ICF, the issue of quantum defect is important because it determines the amount of waste heat that must be removed from the gain medium. The Mercury laser uses a gain medium of crystalline strontium fluoro-apatite doped with ytterbium (Yb:S-FAP). The ytterbium dopant absorbs diode light near 900 nm and emits near 1047 nm, indicating a quantum defect of 15%. In other words, an absolute minimum of 15% of the pump energy must be removed as waste heat. This issue of waste heat removal is not a problem in the context of BSF, because BSF's laser medium also functions as a hot liquid coolant, allowing heat (quantum defect) to usefully be extracted using high-efficiency Brayton cycles, instead of needing to be removed as low-level waste heat.

The upper-state lifetime is important because it directly affects the number of diode-laser pumps required to achieve a given energy output from the laser. The longer the upper-state lifetime, the longer the diodes have to pump the necessary energy into the population inversion. To achieve a 100 J output with its 15% quantum efficiency, Mercury must pump at least 115 J into its amplifiers' population inversions. Yb:S_FAP has an upper-state lifetime of 1.1 ms, which means it must be pumped with more than 100 kW of diode light. By comparison, if NIF's Nd:phosphate glass were Mercury's gain material, its 360 μs lifetime would require three times as many diodes. But, in general, a glass host will exhibit a longer fluorescence decay time than a crystal host, making glass preferable for use in BSF. Other advantages of glass include, it can be more heavily and more homogeneously doped than crystal, and it is optically isotropic.

The emission cross section is important because it determines the gain medium's saturation fluence—the energy fluence needed to extract 63% of the stored energy in a single pulse. Gain materials with a low saturation fluence, like Nd:YAG, whose saturation fluence is 0.62 J/cm², are not well suited for large-aperture, high-energy laser systems. In a large-aperture Nd:YAG system, small amounts of spontaneously emitted energy moving sideways across the aperture can build quickly, depleting the gain available for the main pulse. Nd:phosphate glass has a saturation fluence of 4 J/cm², so large-aperture systems experience manageable losses from amplified spontaneous emission.

The saturation fluence is one example of how lasing efficiency drives an aspect of the laser design. A high saturation fluence (well above that of Nd:glass) can store tremendous amounts of energy, but requires a high laser fluence (possibly high enough to cause optical damage) to extract the energy. This “problem,” which can melt and fracture ICF optics, is actually beneficial to BSF's ignition.

### Potential Problems with Large, Hot, Spherical Laser Cavities

Here we look at two peculiarities associated with BSF's spherical laser idea that need special attention: thermal line-broadening due to very hot molten glass, and spherical shape and size implications on the laser cavity.

First, thermal line-broadening is a smearing of the spectral lines due to the Doppler effect. The effect arises from the overall distribution of particle velocities. The change in wavelength can be calculated from Δλ_{D}=2[2k_{B}T ln 2/Mc²]^{1/2}λ₀, where M is in kg/molecule, c is speed of light in m/s, T is temperature in Kelvin, and λ₀ is the wavelength in nm that the shift is being applied to. The broadening varies directly with both the frequency of the spectral line and the square root of the temperature, and it also varies inversely with the square root of the mass of the emitting particle, so that increasing the temperature from 300 K (room temp) to 1100 K (molten glass) approximately doubles the line widths. It is important to realize that this is not expected to be a significant source of smearing, especially when you consider that the intrinsic differences in host mediums (for example, switching from a crystal to a glass) would result in line-widths that are five times thicker than the smear caused by this amount of thermal line-broadening.

There were other heat related issues considered. In Nd:glass lasers, because of the large separation of the terminal laser level from the ground state, even at elevated temperatures, there is no significant terminal-state population and, therefore, no degradation of laser performance. In addition, the fluorescent lifetime of the neodymium ion in glass is quite insensitive to temperature variation; only a 10% reduction is observed in going from room temperature to liquid nitrogen temperature. As a result of these two characteristics, it is possible to operate a neodymium-doped glass laser with little change in performance over a temperature range of −100 to +100 C. Attention should also be paid to intermediate energy levels, to make sure they are not too close to the upper laser level, as high T can favor multiphonon transitions, thus eventually quenching the upper-state lifetime.

A potentially more significant source of line-broadening is caused by phonons. Phonons are, according to quantum mechanics, the quantized microscopic vibrations (sound waves) in solid (or liquid) media. This means that vibration energy can only be exchanged in the form of so-called phonons, which have an energy which is Planck's constant h multiplied by the phonon frequency. For laser atoms in condensed matter, the quantum energy-level spacings and hence the exact transition frequencies of the laser atoms are affected by nearby host atoms, and hence depend on the exact distances to nearby atoms in the host crystal lattice. The term “crystal lattice,” as used here, also applies to the short-range order found in amorphous glass. Acoustical vibrations of the crystal lattice will modulate these distances slightly, and thus modulate the atomic transition frequencies by small amounts with time. This in turn produces a random phase modulation “smearing” of the dipole oscillations in the laser atoms.

These vibrations (thermal and acoustical) can shorten the upper-lifetime of excited atoms and cause the population-inversion to prematurely collapse. The easiest way to compensate is by increasing the pump rate and decreasing the pump time, which, for BSF's laser-diodes, can range from milliseconds (equivalent to NIF's flash lamps) down to microseconds, so that the amount of time in which spontaneous emissions can occur is diminished a thousand fold.

Another way to extend the upper-lifetime of excited atoms is to lower the active ion concentration. Unlike many crystals, the concentration of the active ion can be very high in glass. The practical limit is determined by the fact that the fluorescence lifetime and, therefore the efficiency of stimulated emission, decreases with higher concentrations. In silicate glass, this decrease becomes noticeable at a concentration of 5% Nd₂O₃.

Second, even though giant rods of Nd:glass (10×10×200 cm) have been used, a huge sphere is not be the best shape for a laser cavity, as randomly directed spontaneous emissions could make the amplification process run rampant. Due to high gain in the transverse direction, amplified spontaneous emission (ASE) and parasitic lasing can be difficult to suppress in a high-power slab laser, particularly those operating with high gain e.g. for pulse amplification. After pumping, the chamber of a spherical laser contains lots of excited atoms. These should not be allowed to amplify indiscriminately. If any of these atoms are in close proximity to a reflective inner surface they will “see” their reflections and resonate with them. This phenomenon will grow over time, penetrate deeper, and produce centrally-directed amplified spontaneous emissions (ASE). Some spontaneous emissions will occur in unwanted directions, not centrally focused. A lot of this could be filtered or suppressed using materials that absorb at the laser frequency. Absorption could take place at unpolished areas inside the sphere, or absorbent material could be incorporated into specially designed parts, like the slats of a window blind that block the passage of all light that is not directed toward the sphere's center. Curved dividers could be placed inside of the sphere, oriented like the skin that separates segments of a grapefruit. These dividers would then serve two purposes, removing undesirable spontaneous emissions before they become highly amplified, and making the convection currents smooth and laminar. Another way of preventing excessive amounts of ASE is to use a gain material with a high saturation fluence, but, like in the previous paragraph, the easiest way to prevent ASE from running rampant is simply to shorten the time period in which unwanted spontaneous emissions can occur.

### Breakdown and Heating of a Gas Under the Action of a Concentrated Laser Beam

Unlike a cold gas, a heated gas always absorbs the low energy visible photons (hv˜2-3 eV). In monoatomic gases photons with energies less than the ionization potentials of the atoms i are absorbed by excited atoms, whose excitation energy exceeds i−hv; in accordance with the Boltzmann relation, the concentration of excited atoms is proportional to exp[−(i−hv)/kT], so that the absorption coefficient also increases sharply with temperature following the same Boltzmann relation. In molecular gases, a number of other mechanisms for absorption of visible light exist, but in any case the absorption coefficient for visible light is always very sensitive to temperature and increases rapidly with heating.

IR light is much less effective than UV at heating the targets, because IR couples more strongly with hot electrons which will absorb a considerable amount of energy and interfere with compressing the target.

Experiments show that, under the action of a light flux of sufficiently high intensity, breakdown takes place in gases which are ordinarily transparent to the given radiation, and free electrons are formed. Breakdown requires very large radiant energy fluxes, obtainable only by focusing the laser beam.

The probability of the multi-photon photoelectric effect is proportional to the nth power of the radiant energy flux. The breakdown in comparatively weaker fields does not take place by direct removal of electrons from atoms but instead as a result of the development of an electron avalanche. The prerequisite for starting an electron avalanche is that “priming” electrons should appear in the gas at the beginning of the laser pulse. It should be pointed out that the field is not uniformly distributed over the area of the focal circle. There exist very small regions with local fields which appreciably exceed the average field over the circle. These are the regions in which the first electrons, which start up the avalanche, are born.

Let us consider the manner in which the electron avalanche develops. Neutral atoms are constantly jostling around. When a collision occurs, electrons absorb photons, and thus acquire sufficient energy for ionization. As a result of the ionization there appear in place of the one “fast” electron two “slow” ones, which again acquire energy from the radiation, ionize atoms, and so forth.

The avalanche development is extremely sensitive to the intensity of the light flux and to the gas density. For example, when the flux or the gas pressure is increased by a factor of 2 (the field is increased by 40%) the rate of energy acquisition and the number of generations in the avalanche would have doubled, so that toward the end of a pulse of the same duration 10¹⁴ rather than 10⁷ new electrons would have been born for each “priming” electron. This extreme sensitivity also explains the experimental discovery of the existence of an abrupt threshold for breakdown in a gas, both with respect to the laser pulse intensity and with respect to the gas pressure.

In fact, the development of the electron avalanche is significantly more complex. An appreciable role is played by the excitation of atoms, by electrons with energies insufficient for ionization but sufficient for excitation. In not too strong fields the excitation decelerates the development of the avalanche, since during excitation the electron discards the acquired energy and must start acquiring it anew.

### Absorption of a Laser Beam and Heating of a Gas After Initial Breakdown

If the radiant energy flux in the focus appreciably exceeds the threshold value for breakdown, the gas becomes highly ionized and the plasma thus produced will practically completely absorb the beam, as a result of free-free electron transitions in the ion field. In this case the gas is heated to high temperatures. Thus, for example, measurements of the intensity of x-ray radiation from the region of the focal spot show that the radiation brightness (and color) temperatures, which characterize the electron temperatures, are approximately 600,000° Kelvin (50 eV).

We assume that breakdown takes place at the focal spot, in the narrowest part of the light column, where the radiant energy flux is a maximum, and that a high degree of ionization and a high temperature have already been established. The light is absorbed in a layer of the order of a photon mean free path, and it heats the gas.

As soon as the degree of ionization ahead of the gas layer which is absorbing at the given time becomes sufficiently high, the new layer becomes opaque and it begins to absorb the beam strongly. Thus an “absorption and heating wave” is propagated along the light column back toward the source of the beam.

The heated gas in the absorbing layer expands and sends out a shock wave in all directions, including the direction along the light column toward the beam. Across the shock wave the gas is heated and ionized, so that the zone of light absorption and energy release in the gas is displaced behind the shock front.

Radiation pressure is the pressure exerted upon any surface exposed to electromagnetic radiation. If absorbed, the pressure will equal the power flux density divided by the speed of light. If the radiation is totally reflected, the radiation pressure is doubled. The amount of pressure this contributes to BSF's fuel compression is significant, but it is miniscule compared with other sources, like acoustical pre-compression, laser ablation (trapped rocket model), and differential ionization. For example, if 1 MJ of laser energy is released over a period of 100 ns to impinge upon a 5 mm radius fuel bubble, then the radiation pressure exerted on the bubble's surface would be a mere 200 MPa (=29,000 psi=2 kBar).

### Laser Heat & Pressure

Real objects follow Kirchoff's Law: “emissivity equals absorptivity” on a per wavelength basis, so that an object that does not absorb all incident light will also emit less radiation than an ideal blackbody. When dealing with non-black surfaces, the deviations from the ideal blackbody behavior are determined by both the geometrical structure and the chemical composition. This law can be combined with the Stephan-Boltzmann law, Q/A=σT⁴, so that, for a given laser intensity (W/cm²), the temperature (K) on the surface of a laser heated bubble can be calculated, using the constant σ=5.67×10⁻¹² W/cm²K⁴, thus:

| Laser intensity (in W/cm²) | Temperature (in eV = 11604 K) |
|---|---|
| 10¹⁰ | 17.7 |
| 10¹¹ | 31.4 |
| 10¹² | 55.8 |
| 10¹³ | 99.3 |
| 10¹⁴ | 177 |
| 10¹⁵ | 314 |

If a 5 meter radius sphere is pumped with 2 MJ of laser energy, then, after lasing, whatever amount of radiant energy is not immediately absorbed will circulate inside the sphere, with a cycle time of 55 ns (the time it takes light to make one round-trip). Assuming 0.5 MJ is immediately absorbed (to reach Kirchoff's equilibrium temperature), then 2.73×10¹³ watts (1.5 MJ/55 ns) will be in circulation. If the radius (r) of the fuel bubble is given, then the laser intensity can be calculated, as 2.73×10¹³ W/4πr². In this example, with r=0.5 cm, the laser intensity would equal 8.69×10¹² W/cm², and the corresponding surface temperature would be 96 eV.

When a laser beam is incident on a solid target it heats the surface and creates a high temperature plasma. Under the force of its own pressure the plasma expands into the vacuum to form a low density corona. The laser beam can no longer penetrate to the solid because it cannot propagate beyond the critical surface which occurs where the electron density is n_{crit}=10²¹ (λ₀/μm)⁻² cm⁻³, where λ₀ is the laser wavelength. At this critical surface the electromagnetic wave must be reflected or absorbed. If the energy carried by the laser beam is to reach the solid then it must be transported beyond the critical surface either by radiation or by electron thermal conduction.

Once a substantial plasma corona has been formed, energy transport within the plasma can redistribute energy smoothly around the solid surface.

There are several ways to estimate the ablation pressure. One is based upon the following power balance formula: Pₐυ_{c}=σT⁴, where υ_{c}=[kT/m]^{1/2}. Another slightly more rigorous derivation (Faquinon and Floux, 1970) describes the ablation pressure in planar geometry, assuming energy deposition is at the critical density ρ_{c} of a discontinuity with sonic flow velocity, obeying all the laws of fluid mechanics v₂²=P₂/ρ₂, mass conservation ρ₁v₁=ρ₂v₂, momentum conservation P₁+ρ₁v₁²=P₂+ρ₂v₂², and energy conservation v₁²/2+h₁+I_{inc}/(ρ₂v₂)=v₂²/2+h₂ where h=enthalpy/mass. For γ=5/3 then h=2.5P/ρ. But, the simplest estimate, designed specifically to approximate the ablation pressure resulting from 0.35 μm laser irradiation of beryllium targets, is Pₐ=0.9 I^{2/3}, with units of Mbar and GW/cm². Using this formula with our previously calculated value of intensity, I_{L}=8.69 GW/cm², the estimated ablation pressure turns out to be Pₐ=3.8 Mbar.

But, to be honest, to previous calculations were mostly just hand-waiving, lacking solid foundation. The study of the properties of warm dense matter (WDM) is a very active area of research. WDM is dense matter between the traditional conditions of cold condensed matter and ideal plasma (ideal plasmas are hot enough and sparse enough to have weak particle coupling). In the ICF context, the conditions of WDM occur during the solid to plasma phase transition, at temperatures of a few electron volts. There is no general theory for WDM because the approximations that enable the development of theories in either the condensed-matter or the ideal plasma regimes are invalid in the WDM regime. Both theoretical and experimental efforts in WDM are nascent, with much room to develop and improve tools and techniques. Equally dumbfounding is the finding, based on several recent experiments, that the compressibility of hydrogen in the Mbar range is uncertain to ±50%.

A very simple model of ablation pressure's effect on final fuel pressure comes from considering the work W done in compressing the fuel.

$$W = {\int }_{{r}_{i}}^{{r}_{f}} {P}_{a} {A}_{bubble} d r = {P}_{a} ( {V}_{i} - {V}_{f} ) ,$$

Where Pₐ is the pressure acting on the bubble's perimeter, A_{bubble} is the surface area of the bubble, Vᵢ and V_{f} are the initial and final volume and Pₐ is the ablation pressure, which can be assumed constant for most of the implosion, even for pulse shaped drive. This work goes into compressing the fuel and it is converted into kinetic energy, which heats the fuel.

At stagnation, the energy from acoustical and laser sources is converted into thermal energy inside the fuel. But, only a fraction (η, the coupling efficiency) between zero and one, of total driver energy, actually goes into heating the fuel. The rest (1−η) is lost, heating the surrounding coolant.

The (perfect gas) energy density of ions and electrons is (3/2)nkT×2=(3/2)P_{f}, where P_{f} is the final pressure for the nearly isobaric fuel at stagnation. If r_{f} is the stagnation radius of the fuel then

$$\frac{4 π}{3} {r}_{f}^{3} \frac{3}{2} {P}_{f} = {P}_{a} ( {V}_{i} - {V}_{f} ) ∼ \frac{4 π}{3} {r}_{i}^{3} η {P}_{a} for {V}_{f} ≪ {V}_{i}$$

means that P_{f}≅(2/3)ηPₐ(rᵢ/r_{f})³. So, for example, an ablation pressure Pₐ=3.8 Mbar, amplified by radial convergence (rᵢ/r_{f})=10 cubed, results in a final pressure of P_{f}=1.3 Gbar, assuming η=0.5.

For ICF to achieve ignition pressures, about 100 Mbar ablation pressure is required (assuming convergences are limited to ˜30 by symmetry conditions), implying intensities of 10¹⁴-10¹⁵ W/cm². Currently, X-rays are preferred, they give a slightly higher ablation pressure than 0.35 μm light, and correspondingly higher hydrodynamic efficiency. However, the most important advantage of x-ray drive over direct drive is that in the important range 10¹⁴-10¹⁵ W/cm², the mass ablation rate is much higher for x-ray drive, leading to much more ablative stabilization of the R-T instabilities.

### Interacting Laser Energy (ICF vs. BSF)

At this point, the amount of energy transferred from the laser into the reacting volume needs to be clarified. For ICF, this is expected to be about 5-15% of the total interacting laser energy. The remaining 85-95% of the energy is needed for ablation of the plasma corona to produce the recoil to compress the reacting plasma. Readers familiar with rockets will notice that this is a poor efficiency compared to that of space vehicles, the reason being that the exploding ablator plasma continues to be heated by the laser as it expands, while a rocket's exhaust cools as it expands. In gas-dynamic ablation, the reacting volume receives a higher percentage (45-50%) of the total interacting laser energy, due to nonlinear forces. Besides hydrodynamic expansion losses, ICF has other channels of energy loss, incoming laser light must penetrate through outgoing ablation blow-back on the way to the target, and the fraction of light undergoing backscattering increases over one thousand fold (to ˜20%) as the laser intensity increases 30 fold (from 1.2 to 35×10¹⁴ W/cm²). BSF is unaffected by those types of losses. In addition, when ICF's ablation particles exit the hot-zone, they carry significant amounts of energy with them. The ablation in BSF is trapped locally, heating the fuel and close surroundings.

In an ICF implosion, when the outer surface of a capsule is evaporated, it forms a high-density plasma that screens the interior of the capsule. Laser light in the infrared is reflected by this plasma screen, while light of a shorter wavelength, in the ultraviolet part of the spectrum, can penetrate deeper. The current approach ICF uses takes advantage of the deeper penetration, the wavelength of the neodymium laser light is shifted from the infrared to the ultraviolet using specialized optical components, but some energy is lost in the process.

In BSF, when the amplified blackbody radiation returns, it must either be reflected or absorbed at the bubbles periphery, since it cannot penetrate beyond the critical depth, which for hot, dense DT is only a fraction of a millimeter. The laser's heat and pressure quickly create a powerful shockwave, capable of ionizing everything in its path. Light cannot penetrate beyond the highly ionized leading edge of this shockwave, so the absorption sight for any subsequent laser energy would have to travel outward with the shockwave. Complicating the situation further, an explosive phase transformation is expected to occur in the coolant that surrounds the fuel. The reason for this is that the central focus-point of the reactor gets very hot and the rate of spontaneous nucleation increases exponentially with temperature. It is known that the frequency of spontaneous nucleation is about 0.1 s⁻¹ cm⁻³ at the temperature near 0.89 T_{c} (critical temperature), but increases to 10²¹ s⁻¹ cm⁻³ at 0.91 T_{c}. This indicates that a rapidly heated liquid could possess considerable stability with respect to spontaneous nucleation up to 0.89 T_{c}, with an avalanche-like onset of spontaneous nucleation of the entire high temperature liquid layer at about 0.91 T_{c}. Therefore, at a temperature of about 0.9 T_{c}, homogenous nucleation, or explosive phase transformation occurs.

Another negative effect ICF can expect is filamentation, in which a laser beam tends to separate into filaments as it propagates through a plasma with density less than the critical. This can be a serious source of non-uniformity in implosions. Thermal filamentation occurs when a local hot-spot in the laser beam preferentially heats the part of the plasma through which it passes. The increased temperature results in a pressure enhancement which drives plasma out of the hot-spot producing a density trough. The edges of the density trough refract the laser beam into the trough, thus reinforcing the process.

### Thermal Conductivity

In physics, thermal conductivity, k, is the property of a material that indicates its ability to conduct heat. It appears primarily in Fourier's Law for heat conduction, defined below:

Heat flow=(ΔQ)/(Δt), where ΔQ is in Joules and Δt is in seconds.

Heat flow=kA(ΔT)/x, where k is the thermal conductivity,
A (in m²) is the total cross-sectional area conducting surface,
ΔT (in ° K) is the temperature difference, and
x (in m) is the thickness separating the two temperatures.

Thus, rearranging the equation gives thermal conductivity,

k=(ΔQ)/(Δt)*1/A*x/(ΔT), where (ΔT)/x is the temperature gradient.

In other words, it is defined as the quantity of heat ΔQ transmitted during time Δt through a thickness x, in a direction normal to a surface of area A, due to a temperature difference ΔT, under steady state conditions and when the heat transfer is dependent only on the temperature gradient.

Some common thermal conductivities, listed in Watts/(meter*Kelvin):

| | |
|---|---|
| Fiber Insulation | 0.042 |
| Air | 0.025 |
| Oil | 0.1-0.21 |
| Water (liquid) | 0.6 |
| Glass | 1.1 |
| Stainless steel | 12.11-45.0 |
| Aluminum | 200 |
| Silver | 429 |

In BSF, if the hot surfaces of circulation pipes are allowed to radiate their heat to the environment, a tremendous amount of energy is wasted. For example, even when covered with a 25 cm thick blanket of fiber insulation, a hot (˜700° C.) circulation pipe will still dissipate heat at a rate of about 67 Watts per square meter of surface area.

When the fuel is heated to fusion temperatures, the thermal conductivity of the resulting DT plasma (including some amount of surrounding coolant) determines how rapidly heat dissipates. The fundamental idea behind all approaches to pulsed fusion is to deposit the initial heating energy quickly enough to initiate a fusion burn, with energy gain, before heat losses make further combustion impossible. The following table is from a research report titled “Calculations of Thermal Conductivity of NIF Target Materials using Finite-temperature Quantum Molecular Dynamics” funded by LANL; Inertial Confinement Fusion Program:

| Material | Thermal Conductivity (W/K · m) |
|---|---|
| Be | 2800 |
| CH | 5500 |
| DT | 17600 |
| Be/DT | 3900 |
| CH/DT | 7400 |

The thermal conductivities of the materials listed above were calculated, via simulation, with the starting assumptions: density=10 g/cm³ and temperature=10 eV. Using the table above, we can, for example, calculate the amount of heat flowing per microsecond through a DT plasma that has a 1 cm² surface area and a 10 eV temperature swing over a 3 mm thickness, as Q=(17600 W/K·m, thermal conductivity of DT plasma)*(1 cm², surface area)*(m²/10000 cm²)*(116,040 K, temperature variation)*(thickness/3 mm)*(1000 mm/m)*(Joule/(Watt second))*(1 s/1,000,000 μs)=69.6 J/μs. In the context of BSF, this rate of heat loss is inconsequential, for three reasons: (1) the targets would likely contain over a million joules of laser energy, (2) the target cross sectional surface area through which heat flows is small, and (3) burn-up is likely to occur in less than one microsecond.

A better, more appropriate, example would have assumed a hotter mixture of fuel and coolant (ie. BSF's ideal ignition temperature=1.6 keV), but reliable information for that temperature range is currently unavailable. Regrettably, research toward calculating the thermal conductivities of other mixtures of fuels and ablators at higher temperatures, which was scheduled to take place at LANL on a future date, has been cancelled. As a result, heat loss calculations that require high-temperature thermal conductivity values cannot be accurately estimated at this time.

Less accurate than the quantum molecular dynamics simulation above, Spitzer and Harm derived the following formula that can be used to estimate electron thermal conductivity in fully ionized plasma over a wide range of temperatures, in 1953:

$${κ}_{e} = ξ \frac{{( {k}_{B} {T}_{e} )}^{5 / 2} {k}_{B}}{{m}_{e}^{1 / 2} Z {e}^{4} ln Λ} , where ξ depends weakly on Z \text{:}$$

$${ξ}_{Z = 1 , 2 , 4} = 0.95 , 1.5 , 2.1$$

After plugging in the appropriate constant terms, k_{B}=1.3807×10⁻¹⁶ erg/K, mₑ=9.1096×10⁻²⁸ g, and e²=2.307×10⁻¹⁹ erg cm, the previous formula becomes:

$${κ}_{e} = 1.93 \times {10}^{- 5} ξ \frac{{T}_{e}^{5 / 2}}{Z ln Λ} in units of \frac{erg}{cm \cdot sec \cdot deg}$$

Using the formula above, we can calculate κₑ for a 1.6 keV DT plasma at three times liquid density, thus: For hydrogen, Z=1 and ξ=0.95. The number of electrons per cubic centimeter in a fully ionized DT plasma at three times liquid density is 3*(0.07 g/cm³)(mole of ^{2.5}H/2.5 g)(6.02×10²³ atoms/mole)(1 electron/atom)=5.1×10²² electrons per cm³. The value (5.6) for ln Λₑ was calculated using the expression 7.1−0.5 ln nₑ+ln Tₑ, as given by [Wesson 1987 (see table below)], where nₑ was in units of 10²¹/cm³ and temperature was in units of keV. Finally, at a temperature of 1.6 keV (18,600,000 Kelvin), the expression for κₑ evaluates to 4.86×10¹² erg cm⁻¹ sec⁻¹ deg⁻¹, which, after applying the conversion (J/10⁷ erg)(100 cm/m)(W/J·sec), becomes κₑ=4.9×10⁷ W/m·K.

The following table contains the factor by which small-angle collisions are more effective, at transferring energy, than large-angle collisions. For plasmas of interest to fusion the value of ln Λ ranges between 5 and 15, but large uncertainties justify choosing 10 as a convenient number.

Table of Coulomb Logarithms ‘ln Λ’

| Temperature | Density of electrons (cm⁻³) | | | | |
|---|---|---|---|---|---|
| of electrons (eV) | 10¹⁷ | 10¹⁹ | 10²¹ | 10²³ | 10²⁵ |
| 10 | 7.1 | 4.8 | 2.5 | — | — |
| 10² | 9.4 | 7.1 | 4.8 | 2.5 | — |
| 10³ | 11.7 | 9.4 | 7.1 | 4.8 | 2.5 |
| 10⁴ | 14.0 | 11.7 | 9.4 | 7.1 | 4.8 |

Comparing BSF to ICF: BSF is expected to ignite more massive (˜10 times), lower density (˜1/4800) targets. One of these giant BSF targets would have 1300 times as much surface area as a compressed ICF capsule, so the heat loss rate would be 1300 times higher for BSF than for ICF. However, the thermal conductivity of BSF's plasma (1.6 keV 0.21 g/cm³) is only 1/170 of ICF's (10 keV 1000 g/cm³), so, compared to ICF, BSF's heat loss rate needs to be adjusted downward by a factor of 170. In addition, if BSF fuel occupies 48,000 times as much volume as ICF's, then its radius must be 36 times larger, and BSF's relative temperature gradient would be (1.6/10)*(1/48,000^{1/3})=1/230 of ICF's. In conclusion, the overall rate of heat loss, via thermal conduction, would be 30 times (230*170/1300) greater for ICF than for BSF. But, because pressure equalizes more rapidly than temperature, ICF fuel disassembles before significant cooling can take place.

The preceding analysis could have been made more rigorous. For example, it would have been better to use a fluid model of heat flow set in spherical geometry, and, since thermal conductivity varies with temperature, it should not have been treated as though it were a constant over the entire temperature gradient. Information about the distribution, temporal evolution, velocity, mass density, electron temperature, ion temperature, and pressure could also be included. The properties of the materials could be accounted for by equations of state, including ionization, degeneracy, etc. The model could also take into account transport of energy due to collisions within plasma (thermal flow and electron-ion relaxation) and radiative processes. Laser interaction could be dealt with in the geometric optics approximation, taking both plasma refractivity and collisional absorption into account. Finally, the code could include nuclear fusion reactions, fuel burn-up, and transport of both charged fusion products and neutrons.

The size of a compressed target is important, because surface area plays a major role in determining the rate of heat transfer. Example, if a DT target capable of producing 4.5 GJ of fusion energy is heated and compressed to 0.525 g/cm³ (three times the density of liquid DT), what will be the size of the resulting surface? We will start by calculating the fuel's volume: (1 cm³/0.525 g)(5 g/mole of DT)(mole of DT/6.02×10²³ DT)(DT/22.37×10⁶ eV)(6.24×10¹⁸ eV/1 Joule)(10⁹ Joules/GJ)(4.5 GJ/target)=0.02 cm³. Note, the value (22.37×10⁶ eV/DT) also accounts for the energy released during tritium breeding. With the volume known, we can use V=(4/3)πr³ to solve for radius, r=0.17 cm. And, with the radius known, we can use A=4πr² to solve for surface area, A=0.35 cm².

### Specific Heat Capacity

Specific heat capacity, also known simply as specific heat, is the measure of the heat energy required to increase the temperature of a unit quantity of a substance by a certain temperature interval. More heat energy is required to increase the temperature of a substance with high specific heat capacity than one with low specific heat capacity. For instance, eight times the heat energy is required to increase the temperature of an ingot of magnesium as is required for a lead ingot of the same mass.

For example, the heat energy required to raise water's temperature one Kelvin is 4186 J/kg.

Table of specific heat capacities: (in kJ/kg °K)

| | |
|---|---|
| Glass, flint (solid) | 0.503 |
| Hydrogen (gas) | 14.30 |
| Iron (solid) | 0.450 |
| Water (liquid) | 4.1813 |
| Silver (solid) | 0.233 |

### Thermal Expansion

Nearly all substances expand when they are heated and contract when they are cooled. This is a familiar thermal expansion effect: sidewalks buckle on hot summer days; the mercury column rises in a heated thermometer; etc. In BSF, the circulation system undergoes wide temperature swings (about 400° C.) during both startup and shutdown, causing a large degree of expansion/contraction. One way to compensate for this is to have the circulation pipes connected using overlapping sleeves that slide inside each other, like a telescope. Another way is to have the plant designed like an earthquake-proof skyscraper, with interconnected parts that ride independently on giant sliding rollers.

Different substances expand (and contract) to different extents; a lead rod, for example, changes in length by 60 times as much as a quartz rod of the same initial length when both are heated or cooled through the same temperature interval.

Thermal expansion in a solid also has a straightforward explanation in terms of kinetic theory. Most solids are crystalline in nature, which means that the various atoms that compose them form a regular arrangement in space. The atoms behave as though they are joined together by tiny springs, thereby accounting for Hooke's law, and constantly oscillate about their equilibrium positions. The average interatomic spacing is what determines the dimensions of the solid.

When the internal energy of a solid increases, the atomic spacing alternates through a wider range than before. The attractive and repulsive forces between atoms vary with distance in different ways, with the repulsive force increasing more rapidly as the atoms move closer together than the attractive force increases as the atoms move farther apart. Consequently, the average interatomic spacing increases as the internal energy of the solid increases and the amplitudes of the atomic vibrations increase. As it happens, changes in the average interatomic spacing are very nearly proportional to changes in temperature, leading to the linear thermal expansion formula:

Change_in_Length=Coefficient of expansion*Initial_Length*Change_in_temperature.

Linear expansion coefficient values per degree Kelvin for some common materials:

| | |
|---|---|
| Concrete | 0.7E−5-1.2E−5 |
| Copper | 1.7E−5 |
| Iron/Steel | 1.2E−5 |
| Lead | 3.0E−5 |
| Quartz | 0.05E−5 |
| Silver | 2.0E−5 |

### Chemical Properties

Bond energy is the strength of a chemical bond between atoms, expressed as the amount of energy (in kJ/mol) required to break it apart. It is as if the bonded atoms were glued together: the stronger the glue is, the more energy would be needed to break them apart. A higher bond energy, therefore, means a stronger bond.

Common sense suggests that molecules in which the bonds are all strong will be more stable than molecules having weaker bonds.

The relative strength of a bond can be estimated by how strongly each individual atom holds on to its outer electron. An elements electronegativity is a measurement of how tightly it grips electrons. Metals with one outer electron have a very weak hold and a correspondingly low electronegativity. The strongest bonds occur when the atoms have large differences in there electronegativities. These types of bonds are called ionic bonds. Covalent bonds are weaker bonds that result when the electronegative difference is smaller.

In BSF, there is a potential chemical reaction zone at the interface were the fuel touches the glass containment bubble. The following list of electronegativities (Allen) represents every element having the potential to participate chemically within this zone:

| | |
|---|---|
| Glass + | FLiBe + |
| Nd₂O₃ | NdF₃ |

| | | | |
|---|---|---|---|
| Li | 0.912 | Li | 0.912 |
| Nd | 1.14 | Nd | 1.14 |
| Pb | 1.852 | Be | 1.57 |
| Si | 1.916 | H | 2.3 |
| H | 2.3 | F | 4.19 |
| O | 3.61 | | |

The glass network is composed of metal oxides that have electronegative differences ranging from 2.698 (Li—O) to 1.694 (Si—O). Hydrogen forms a much weaker bond with oxygen, the electronegative difference for H—O is only 1.31, so oxygen should not preferentially bond to hydrogen, and hydrogen should stay in its bubble. Likewise, when FliBe is used as a coolant, the difference in electronegativity for H—F is only (1.89), much less than other fluorine bonds, Li—F (3.278), Be—F (2.62), so fluorine is not likely to combine with the hydrogen inside the fuel bubble.

There is another reaction zone where the coolant touches the metal plumbing, but, if the plumbing is of refractory metal, which is very compatible with liquid metals and molten salts, then erosion is unlikely to be more than a fraction of a millimeter per century of plant operation. Still, there are corrosion issues with FLiBe, coming from free fluorine and hydrogen-fluoride generated during breeding in the neutron field, but these can be prevented by adding a reducing agent (like Be).

### Glass

In the scientific sense the term glass is often extended to all amorphous solids (and melts that easily form amorphous solids).

The fundamental subunit of silica-based glasses is the SiO₄ tetrahedron, in which each silicon atom is bonded to four oxygen atoms. In simple silica glass the tetrahedra are joined corner to corner to form a loose network with no long-range order.

Oxides that break up the glass network are known as network modifiers. Alkali oxides such as Na₂O, K₂O, and Li₂O are added to silica glass to lower its viscosity so it can be worked and formed more easily. The oxygen atoms from these oxides enter the silica network at points joining the tetrahedra and break up the network, producing oxygen atoms with an unshared electron. The Li¹⁺ ions do not enter the network but remain as metal ions ionically bonded in the interstices of the network. By filling in some of the interstices, these ions promote crystallization of the glass.

Lead oxide (PbO) cannot form a glass network by itself but it can join into an existing network to give the glass special properties. In some glasses, the PbO content is as high as 92%.

Pure silica (SiO₂) has a “glass melting point” of over 2300° C. While pure silica can be made into glass for special applications (i.e. fused quartz), other substances are added to common glass to simplify processing. Lead glass, such as lead crystal or flint glass, is more “brilliant” because the increased refractive index causes noticeably more “sparkles”, while boron may be added to change the thermal and electrical properties, as in Pyrex. Large amounts of iron are used in glass that absorbs infrared energy, such as heat absorbing filters for movie projectors, while cerium(IV) oxide can be used for glass that absorbs UV wavelengths.

Industrial producers of laser glass have emphasized phosphate glasses over silicate glasses because silicates have a more rapid decrease of neodymium fluorescence lifetime with increasing neodymium concentration than phosphates. Schott undertook an extensive study, discovering that melts containing greater than 70 mol % P₂O₅ out-performed others in this respect.

Usually, the melts are carried out in platinum crucibles to reduce contamination from the crucible material. Glass homogeneity is achieved by homogenizing the raw materials mixture (glass batch), by stirring the melt, and by crushing and re-melting the first melt.

As in other amorphous solids, the atomic structure of a glass lacks any long range translational periodicity. However, due to chemical bonding characteristics glasses do possess a high degree of short-range order with respect to local atomic polyhedra. It is deemed that the bonding structure of glasses, although disordered, has the same symmetry signature as crystalline materials.

Both in a glass and in a crystal it is mostly only the vibrational degrees of freedom that remain active, whereas rotational and translational motion becomes impossible explaining why glasses and crystalline materials are hard.

Glass's high chemical resistance and ability to form vacuum-tight enclosures makes it useful for laboratory apparatus and corrosion-resistant liners for pipes and reaction vessels in the chemical industry.

It is interesting to note that the international standard treatment (for long-term disposal) of fission waste is to encapsulate it in glass, because of its relative chemical inertness.

Systematic glass research was born in 1879 when young glass engineer Otto Schott and physicist Ernst Abbe studied the special optical properties of lithium silicate glass.

The Glass mixture being considered for BSF might have properties similar to lead crystal.

| | |
|---|---|
| Heat capacity: | ~51 J/mol °K (0.503 kJ/kg °K) |
| Density: | ~3.86 g/cm³ |
| Glass transition temp. | ~540° C. |
| Viscosity | ~depends on temp. (honey - ketchup) |
| Speed of light in glass | ~1.82E8 m/s |
| Refractive index | ~1.65 |
| Young's modulus | ~67 GPa |
| Bulk modulus | ~103 GPa |
| Shear modulus | ~26.8 GPa |

Sound waves are transmitted by solids, liquids, and gases. In general, the stiffer the material, the faster the waves travel, which is reasonable when we reflect that stiffness implies particles tightly coupled together and therefore more immediately responsive to one another's motions. This notion is borne out by a detailed analysis, which shows that the velocity of sound in a fluid medium is given by

Velocity=squareroot (Bulk_modulus/Density).
Sound speed in glass ˜5170 m/s
Sound speed in water ˜1498 m/s
Sound speed in air ˜331 m/s

For BSF, the total volume of glass inside a 5 m radius sphere is 4/3*π*5³=524 cubic meters, thirteen times as much (amplification medium) as National Ignition Facility's laser: 3072 slabs×3.4 cm thick×46 cm wide×81 cm long=38.9 cubic meters.

### Tritium Breeding

Because there is no significant natural supply of tritium, a DT fusion reactor must breed its own tritium. Several neutron reactions produce tritium, but the only tritium-producing reactions with high enough cross sections to be useful are those involving lithium. Since a 1000 MW_{T} plant will burn about 250 g of tritium each operating day, an inventory of several kilograms will most likely be required at every DT based fusion power plant. And, because there are no easily accessed, natural or manmade sources of tritium, the main source of tritium is expected to come from breeding by capture of fusion neutrons in lithium contained in a blanket surrounding the fusion core. Natural lithium is isotopically 7.4% ⁶Li and 92.6% ⁷Li, and tritium can be produced from either isotope by:

⁶Li+n→⁴He+T,

⁷Li+n→⁴He+T+n.

The ⁷Li reaction has a threshold of approximately 4 MeV and a much lower cross section than the ⁶Li reaction: nevertheless, it is very important because it produces a T atom without depleting the neutron population. If the neutrons are moderated before reaching the fertile lithium, the ⁷Li reaction is not utilized (since it requires a high-energy neutron) and any lost neutrons would result in a tritium-breeding ratio less than 1.0. In such cases, the blanket must also contain some sort of neutron multiplier to maintain an adequate breeding ratio. Beryllium and lead with high (n,2n) and low capture cross sections are examples of good neutron multipliers. However, beryllium is an example of a limited resource material whose use could significantly reduce fusion's potential as a long-range source of energy.

The tritium breeding ratio can be enhanced by mixing liquid ⁷Li²H with the gaseous fuel, not only does this increase the fuel's DT density but, because the ⁷Li is located within the detonation zone it will be exposed to a flux of energetic neutrons that is approximately a million times more intense than what lithium in a distant blanket, like ICF's, would be exposed to, so the ⁷Li+n→T+⁴He+n−2.467 MeV reaction rate and overall tritium breeding ratio will be much higher.

The tritium breeding ratio can also be influenced by the fuel compression. Compressing the fuel causes more high-energy fusion neutrons to undergo (n,2n) reactions within the fuel, with both D and T, resulting in an increase of about 6% in the neutron population leaving the fusion target. The multiplied lower energy neutron spectrum results in a larger number of exoergic ⁶Li(n,α)T reactions and a smaller number of endoergic ⁷Li(n,n′α)T reactions than a 14 MeV neutron spectrum would. As a result, the fusion neutron energy leaving the compressed target which accounts for approximately 68% of the total yield, is multiplied by 1.24 in the lithium regions.

It is important that the TBR exceeds unity by a margin, so that: (a) losses from radioactive decay of tritium during the period between production and use can be compensated for; (b) supply inventories for the startup of other reactors can be accumulated; (c) a storage inventory can be kept to provide the reserves necessary to keep the reactor operational during malfunctions of the tritium processing subsystem.

For fusion to be a serious contender for commercial energy production, short tritium inventory doubling times are needed. BSF has a tremendous advantage in achieving a short tritium inventory doubling time compared to an ICF system using a distant blanket, since the amount of structural material in the forward wall of the blanket has a much more severe impact on tritium breeding relative to the structural content in the bulk of the blanket, and BSF has no front wall. Magnetic fusion designs, like ITER, fair no better; detailed engineering design shows that the forward wall may have to be quite thick (˜7 cm). This is a serious problem, since simulations conducted in 2006, in an article titled “Physics and technology conditions for attaining tritium self-sufficiency for the DT fuel cycle,” show that the relative TBR is reduced approximately 15% when the structural material in the forward wall is increased from 0.4 cm to 4.0 cm in thickness.

Tritium absorption and diffusion might cause problems, but, if SiC is used in areas of high tritium concentration, then the tritium permeation rate, which is very low in SiC at temperatures below 1300 K, should be reduced hundreds of times less than in steel. In addition, tritium diffusion can be reduced by laser peening, a process for the densification of metal surfaces and sub-layers and for changing surface-chemistry, to provide retardation of the up-take and penetration of atoms and molecules, particularly hydrogen, which, if allowed to penetrate, would initiate embitterment and leave materials susceptible to cracking.

### Piezoelectricity

When certain crystals are subjected to mechanical force, they become electrically polarized. Tension and compression generate voltages of opposite polarity with magnitudes proportional to the applied forces. These same crystals, when exposed to electric fields, experience elastic strains, lengthening or shortening in accordance with the strength and polarity of the field. These behaviors are labeled the piezoelectric effect and the inverse piezoelectric effect, respectively, from the Greek word piezein, meaning to press or squeeze.

At the time of its discovery, piezoelectricity was just a curiosity, but now it is regarded as a landmark in the evolution of modern technology. Piezoelectric ceramics are physically strong, chemically inert, and relatively inexpensive to manufacture, making them ideal for dynamic pressure studies, i.e. blast gauges. Piezoelectricity has been observed by qualitative tests in about 1,000 crystal species, while more or less complete quantitative data have been taken on about 100 crystals.

To prepare a piezoelectric ceramic, fine powders of the component metal oxides are mixed in specific proportions, then heated (calcined) to form a uniform powder. The powder is mixed with an organic binder and is pressed, calendared, or molded into structural elements having the desired shape (disks, rods, plates, etc.). The “green” ceramic shapes are fired according to a specific time and temperature program, during which the powder particles sinter and the material attains a dense crystalline structure. The shapes are cooled, then further shaped or trimmed, if appropriate, and electrodes are applied to the appropriate surfaces.

A fired ceramic element is a semi-organized mass of fine crystallites (ceramic grains). A typical ceramic sample contains 1E9 to 1E12 grains per cm³.

A piezoelectric ceramic element will generate electrical energy from a mechanical energy input. The charge generation will be directly related to the extent to which the ceramic element is deformed. In a properly designed generator, voltage will increase almost linearly with increasing stress.

Consequently, the configuration of the element and the manner in which it is mounted are important contributors to the performance of the generator. A tall ceramic cylinder, constrained at its ends, will radially expand much more readily than will a short disk of equal volume, under similar constraint, and thus will convert significantly more of the mechanical energy input into electrical energy. The electrical energy must be rapidly dissipated from the generator, or the electric field could partially or completely depolarize the ceramic element.

Piezoelectric constants—Because a piezoelectric ceramic is anisotropic, physical constants relate to both the direction of the applied mechanical or electric force and to the directions perpendicular to the applied force. Consequently, each constant generally has two subscripts that refer to the directions of the two related quantities, such as stress (force on the ceramic element/surface area of the element) and strain (change in length of element/original length of element) for elasticity.

The piezoelectric charge constant, d, is, alternatively, the polarization generated per unit of mechanical stress (T) applied to a piezoelectric material or the mechanical strain (S) experienced by a piezoelectric material per unit of electric field applied. Because the extent of the strain induced in a piezoelectric material by an applied electric field is the product of the value for the electric field and the value for d (S=dE), d is an important value (i.e., a figure of merit) for ascertaining a material's suitability for strain-dependent (actuator) applications.

The piezoelectric voltage constant, g, is, alternatively, the electric field generated by a piezoelectric material per unit of mechanical stress applied or the mechanical strain experienced by a piezoelectric material per unit of electric displacement applied. Because the strength of the induced electric field produced by a piezoelectric material in response to an applied physical stress is the product of the value for the applied stress and the value for g (E=−gT), g is a figure of merit for assessing a material's suitability for sensing (sensor) applications.

Elastic compliance, S, is the strain produced in a piezoelectric material per unit of stress applied. It is the reciprocal of the modulus of elasticity (Young's modulus). Young's modulus, Y, is an indicator of the stiffness (elasticity) of a ceramic material. Y is determined from the value for the stress applied to the material divided by the value for the resulting strain in the same direction.

The electromechanical coupling factor, k, is an indicator of the effectiveness with which a piezoelectric material converts electrical energy into mechanical energy, or converts mechanical energy into electrical energy. Under static or near-static conditions (input frequencies far below the resonance frequency of the piezoelectric material), either electrical to mechanical or mechanical to electrical conversion is expressed by:

k²=converted (stored) energy/input energy.

For ceramic rods,

k₃₃²=d₃₃²/Se₃₃Et₃₃, where
d₃₃ is the piezoelectric charge constant parallel to polarization direction,
Se₃₃ is elastic compliance (constant electric field) parallel to polarization,
Et₃₃ is permittivity (constant stress) parallel to polarization.

The k values quoted in ceramic suppliers' specifications typically are theoretical maximum values. At low input frequencies, a typical piezoelectric ceramic can convert 30% to 75% of the energy stored in one form to the other form, depending on the formulation of the ceramic and the directions of the forces involved. A high k usually is desirable for efficient energy conversion, but k is not in itself a measure of efficiency, because it does not account for dielectric losses or mechanical losses. Further, unconverted energy often can be recovered. The true measure of efficiency is the ratio of converted, usable energy delivered by the piezoelectric element to the total energy taken up by the element. By this measure, piezoelectric ceramic elements in well designed systems can exhibit efficiencies that exceed 90%.

Basic equations—Piezoelectricity connects an elastic variable, stress or strain, with an electrical variable, electric polarization or electric field. Piezoelectric constants may be defined to connect either of the two elastic variables with either electric variable. The most useful piezoelectric constants (usually designated by the letter “d”) relate electric polarization to the stress causing this polarization. It is found from the requirement of conservation of energy that then the same constant also gives the strain caused by an applied electric field.

Examples—The units to be used for expressing piezoelectric constants derive from the units employed for elastic stress and electric polarization. For consistency, the electric and elastic units used must lead to the same unit of energy. Preference is given to the meter-kilogram-second system with rationalized electric units. With this choice, the unit of the piezoelectric d-constant becomes the coulomb/newton or meter/volt. Here a coulomb is an ampere * second and a newton (kg m/s²) of force=0.225 lbs. These two units are equivalent since 1 newton*1 meter=1 joule=1 volt*1 coulomb.

At static or near-static input frequencies, the relationships between a force applied to a piezoelectric ceramic element and the electric field or charge produced are:

E=−g₃₃T, where
E is the electric field (in V/m)
g₃₃ is the piezoelectric voltage constant in parallel direction (in Vm/N)
T is the stress on the ceramic element (in N/m²)

Q=−d₃₃F, where
Q is the generated charge (in C)
d₃₃ is the piezoelectric charge constant in parallel direction (in C/N)
F is the applied force (in N)

The relationships between an applied voltage or electric field and the corresponding increase or decrease in a ceramic element's thickness, length, or width are:

Δh=d₃₃V,

S=d₃₃E,

Δl/l=d₃₁E, and

Δw/w=d₃₁E where
l is the initial length of the ceramic element
w is the initial width of the ceramic element
d₃₃ is the piezoelectric charge constant when the ceramic element is subjected to mechanical stress parallel to the direction of polarization and the induced electric field is the same direction.
d₃₁ is the piezoelectric charge constant when the ceramic element is subjected to mechanical stress parallel to the direction of polarization but the induced electric field is measured perpendicular to the direction of polarization.
V is the applied voltage
S is the strain (Δh/original h)
E is the electric field

Stress applied to a ceramic element parallel to the direction of polarization will deform the element across the direction of polarization and create an electric field with the same polarity as the field used to polarize the element. For an open circuit system, the voltage generated in this manner can be calculated from,

V=−g₃₃hT, where

V=voltage, g₃₃=piezoelectric voltage constant (electric field generated per unit of mechanical stress applied, h=height (thickness) of ceramic element, T=stress on element (applied force/surface area of ceramic element, in square meters.

Some of the mechanical energy applied to the ceramic element will be expended in deforming the element. Assuming no other losses, the remainder of the input energy will be converted to usable electrical energy:

Wₜ=W_{d}+Wₑ, where
Wₜ is the total mechanical energy input,
W_{d} is the energy expended to deform the ceramic element,
Wₑ is the energy in the electric field of the ceramic element.

The volume of the ceramic element and the amount of stress exerted on the element are key factors in the conversion of mechanical input to electrical energy.

Wₜ=[(vol)s₃₃T²]/2

W_{d}=[(vol)s₃₃T²(1−k₃₃²)]/2

Wₑ=[(vol)s₃₃T²k₃₃²]/2

Alternatively, (Wₑ) can be determined from electrical characteristics of the system:

Wₑ=[C₀V²(1−k₃₃²)]/2, where
V is the voltage
C₀ is the capacitance of ceramic element (well below resonance).

The stress on the element, T, is the ratio of the applied force to the surface area of the element. Consequently, when the composition of the ceramic, the volume of the ceramic element, and the applied force are constant, the element that has the smallest surface area will generate the most electrical energy.

Very high voltages are characteristic of an unmodified system. To attain a practical voltage, a capacitor, with a much larger capacitance than that of the piezoelectric generator, can be incorporated into the system in parallel with the generator. Voltage will be reduced linearly with the increase in total capacitance. Further, the capacitor can power an electronic circuit or solid state battery.

Because available energy is related to the square of the voltage, the parallel capacitor described above will greatly reduce available energy in addition to reducing the voltage. There are two approaches to minimizing the energy loss: adjusting the capacitance by constructing the generator from multiple thin layers of ceramic or adjusting the impedance by incorporating a transformer into the system. In the first approach, the generator is constructed from multiple very thin layers of ceramic ( 1/10 mm or less), alternated with electrodes, rather than from a single, much thicker ceramic element. The capacitance will be higher for a generator constructed in this manner and, because the multiple-layer construction creates a large surface area to volume ratio, the generator will generate a high charge and comparatively low voltage:

V=(h/n)(g₃₃T), where
V is the voltage,
h is the height (thickness) of ceramic element,
n is the number of ceramic layers,
g₃₃ is the piezoelectric voltage constant, and
T is the stress on the element.

If a short-circuited piezoelectric ceramic element is stressed, electric charge will be generated by both linear processes (deformation of domains) and nonlinear processes (reversible or irreversible displacements of domain walls). The electric displacement produced by the linear processes is:

Q/A=D=d₃₃T, where
Q is the total generated charge,
A is the surface area of ceramic element,
D is the electric displacement,
d₃₃ electric polarization generated per unit of mechanical stress applied,
T is the stress on the element.

Next-generation piezoelectric materials fabricated from single crystals of lithium niobate can exhibit significantly superior properties, relative to polycrystalline elements.

Most properties of a piezoelectric ceramic element erode gradually, in a logarithmic relationship with time after polarization. Exact rates of aging depend on the composition of the ceramic element and the manufacturing process used to prepare it. A typical element will degrade less than 1% per decade.

Techniques used to make multilayer capacitors can be adapted to make multilayer piezoelectric ceramic generators. By using multilayer technology in combination with the correct size transformers and capacitors, practically all of the energy contained in the PZT transducer can be extracted and used. A large surface area per unit volume makes for a high generated charge and relatively low voltage. Such generators are excellent solid state batteries for electronic circuits. A properly designed transducer can operate at well over 90% efficiency.

Piezoelectric active fibers are ideal for energy harvesting. They are very durable (fatigue life>200 million cycles with no degradation), and their transducer efficiencies have already reached 70%, and with coupling coefficients over 90% there is still room for improvement.

Typical maximum energy density for an open circuit PZT transducer is about 1.2 W/cm³. A 10 meter radius sphere lined with these PZTs will have a maximum open circuit energy density of (1.2 W/cm³)(4π)(1000 cm)²=15 MW per cm of thickness. Harvesting the energy from a 1 GW plant would require a piezoelectric tile 33 cm thick. Fortunately new piezoelectric materials exist with energy densities of over 50 W/cm³, reducing this thickness 40 fold.

As the operating temperature increases, piezoelectric performance of a material decreases, until complete and permanent depolarization occurs at the material's Curie temperature. At elevated temperatures, the ageing process accelerates, piezoelectric performance decreases and the maximum safe stress level is reduced. A piezoelectric ceramic can be depolarized by a strong electric field with polarity opposite to the original poling voltage. The typical operating limit is between 500 V/mm and 1000 V/mm for continuous application. For impact applications, the material behaves quasi statically (non-linear) for pulse durations of a few milliseconds or more. When the pulse duration approaches a microsecond, the piezoelectric effect becomes linear, due to the short application time compared to the relaxation time of the domains.

Single crystal PMN-PT (lead magnesium niobate/lead titanate) elements exhibit ten times the strain of conventional polycrystalline PZT (lead zirconate titanate) elements.

| | PMN-PT | PZT (APC 855) |
|---|---|---|
| Density (g/cm³) | 7.64 | 7.7 |
| k₃₃ | 0.94 | 0.76 |
| d₃₃ (pC/N) | 1500 | 630 |
| g₃₃ (Vm/N) | | 0.021 |
| Curie Temperature (° C.) | 150 | 250 |
| Young's mod. (1E10 N/m²) | 8.2 | 5.1 |

To demonstrate the pressurizing potential of these crystals, consider a sphere: 10 meters in radius, fluid filled, and tiled with PZT (APC 855) crystals. If each crystal is shaped like a one centimeter cube, then they will each produce one atmosphere (14.7 lbs/in²) of pressure when subjected to 21 volts. If all the crystals are triggered simultaneously at full power (5 kV @ 500V/mm), then constructive interference will cause 5 million atmospheres (500 GPa) of pressure to accumulate when the impulse wave reaches one centimeter away from the sphere's center. This is more pressure than at the earth's core (370 GPa).

### Energy Harvesting

Energy harvesting (aka scavenging) refers to the techniques of energy recovery from freely available environmental resources. Typical energy sources include vehicle shock absorbers, specially designed jogging shoes, wind- or traffic-oscillations on bridges, ocean waves, vibrating motors, etc. In general, these are not high-power energy sources. And so, even though the term “scavenging” is incorrect in the context of BSF, the techniques used by BSF for energy recovery are exactly the same as those used in energy harvesting systems.

After detonation, the center of a BSF reactor sends out a high-pressure shockwave. More precisely, the 14 MeV neutrons, which initially travel ˜51 m/μs and have mean free paths of a few centimeters, will deposit 80% of the fusion energy with an exponentially decreasing intensity in a time that is short relative to the hydrodynamic response time and therefore generates pressure waves in the liquid blanket. Note, relativistic velocity=sqr(1−((mₒc²)/(mₒc²+K.E.))²)c. When this pulse propagates through a viscous fluid, the waveform changes. In the case of viscous media the attenuation of the waves is proportional to the frequency squared. At the beginning, the absorption is mainly due to viscosity since thermal agitation takes more time to exert its influence. Each layer of the fluid tends to slow down the displacement of the adjacent layers causing thus the damping of the wave as it penetrates into the fluid. Shock waves are attenuated very rapidly after reaching the metal shell, the amplitude decreases by more than half in 16 μm (3 ns). Besides viscosity, there is appearance of the conduction thermal phenomenon which results from the heat transfer between the regions of dilation and compression. The wave propagation causes a thermal agitation within the fluid characterized by the collisions of the atoms: random motion of particles with different velocities. These collisions lead to increased internal motion (translation, vibration, rotation) and higher temperatures. The local variation of the pressure due to wave propagation involves molecular displacement (rotations+translations). This displacement is caused by the increase in the internal energy of the fluid. The change of the potential energy causes a change of the structure of the fluid because of the modifications of the distances between the different atoms.

Pressure waves that are not absorbed (turned into heat) in the coolant will resonate inside the sphere at ˜500 Hz, assuming radius=5 m and cₛ=5000 m/s. Over time the strength will diminish, depending on the acoustic impedance (z) of the materials through which the wave either passes or reflects. If the reactor is made of glass z=19, metal z=45, and hydraulic fluid z=1.4, then it would take about 1/20 second (25 cycles) for 95% of the blast energy to exit the sphere, losing 12% in strength per cycle. This blast energy, arriving as a string of pressure waves with decreasing amplitudes, is what BSF's piezoelectric transducers extract energy from.

If FLiBe is used as a coolant instead of glass, then the period of 95% acoustical energy extraction will be extended by one half second. There are two reasons for this. First, sound travels 2.7 times slower in FLiBe (cₛ=1820 m/s), so the sphere will resonate slower (185 Hz) and take more time to complete the same number of cycles. Second, there is a larger impedance mismatch between the coolant and the first wall (z_{FLiBe}=3.5, as opposed to z_{glass}=19), so the acoustical transmission coefficient, which equals 2z_{coolant}/(zₘₑₜₐₗ+z_{coolant})), is reduced 4 fold, from 0.59 to 0.14.

The natural oscillations of a structural shell are modified significantly when the shell is surrounded by a liquid because of the transfer of kinetic energy from the shell to the liquid. This energy-loss mechanism is much more effective than the internal damping in the shell material.

Multilayer piezoelectric transducers are suitable for power harvesting under large uniaxial stress conditions, easy to mount, and can operate with low frequencies (˜10 Hz). An alternative to piezoelectric harvesting is electromagnetic harvesting (EMH). Under certain conditions EMH provides the highest level of performance achievable to date, but unfortunately EMH does not scale well and it responds poorly at high frequencies.

Energy Harvesting techniques are rapidly improving. In 2005, a new power flow optimization principle based on a technique called Synchronized Switch Harvesting on Inductor (SSHI), for increasing the converted energy, was developed. The developers claim that the electric harvested power may be increased by as much as 900% over the standard technique. In 2006 this technique has been improved using low-energy dissipation circuits. Recently, Liu et al. (2007), provided an improved analysis for the performance evaluation of a piezoelectric energy harvesting system using a modified SSHI electronic interface. Theoretically their proposed method yields more power than SSHI. They found that the best use of the SSHI harvesting circuit was for systems in the mid-range of electromechanical coupling using quasi-static work cycles. The degradation in harvested power due to the non-perfect voltage inversion is not pronounced in this case, and the reduction in power is much less sensitive to frequency deviations than that using the standard technique.

Our current understanding of vibration energy harvesting is based on the steady-state analysis, which assumes that the excitation is harmonic with a constant frequency. In such a case, one can conclude the following: Maximum transfer of energy from the environment to the electric load occurs when the excitation frequency is very close to the fundamental frequency of the harvester. This stems from the very basic theories of vibration which state that, the energy of an oscillating system may be increased by supplying energy at a frequency equal or very close to the fundamental frequency of the oscillator. When this resonance condition occurs, the amplitude of oscillation increases, thereby producing larger strains in the harvesting element. Since the output voltage is proportional to the strain produced, larger output power is attained near resonance. Therefore, to maximize the output power, energy harvesters should be constructed so that their natural (fundamental) frequency matches the bandwidth of the environmental source of excitation. However, numerical results show that more power is harvested when the excitation is much less than the generator's resonance frequency.

In order to maintain optimal power for any excitation frequency it is essential to maintain an optimal strain rate. As such, the power optimization problem is equivalent to optimizing the strain rate of the mechanical element and is not related to the magnitude of the strain itself. SSHI applied to the motion of a non-resonant steady-state structure allows extracting 10 times more energy than a conventional technique for a given strain. The behavior of a power harvesting system using an SSHI interface is similar to that of a strongly coupled electromechanical system using a standard interface and operated at the short-circuit resonance.

In d₃₃ mode, both the mechanical stress and the output voltage act in the same (3) direction. In d₃₁ mode, the stress acts in the (1) direction and voltage acts in the (3) direction. Operation in the d₃₁ mode leads to the use of thin-bending elements such as bimorphs, in which two separate sheets are bonded together, sometimes with a center shim in between them. The electro-mechanical coupling for d₃₁ mode is lower than for d₃₃ mode. However, d₃₁ systems can produce larger strains with smaller input forces. For a small force, low-vibration level environment, the ₋₃₁ configuration cantilever is most efficient, but in a high-force environment, such as a heavy manufacturing facility or in large-operating machinery, a stack configuration is more durable and generates more energy. Stack actuators have seen little use in energy harvesting applications because typical ambient vibration levels cannot effectively strain the material. However, being in close proximity to a nuclear explosion should produce sufficient stain.

### Degassing

In BSF, after thermonuclear burn, a large volume of the glass will be contaminated with small amounts of ¹H, ²H, ³H, ³He, and ⁴He. These contaminants are the remnants of burnt fuel and transmuted blanket materials, they get mixed and diffuse over time. Processing the tritium is necessary for plant operations.

When the pressure of a fluid is dropping from a certain value (for example residual pressure) to a very low level close to vacuum, all the gas contaminations of the fluid will immediately diffuse in a kind of gas bubble. The inverse process, to provide gas in solution when the pressure is rising, takes a long time and is dependent of the size of the surface area of the bubbles. This is a well known behavior of fluids and gases under the effects of pressure.

There are several factors affecting the amount of gas that remains trapped. Some of these factors are the temperature of the melt, the time allotted to degassing, the ratio of exposed surface to total volume, the degree of agitation, the chemical composition of the melt, the chemical composition of the surrounding atmosphere, and pressure of the surrounding atmosphere.

A recent improvement in the glass making process has the melting step followed by a fining step during which the fused mass is treated with a helium atmosphere which passes into the gaseous inclusions in the glass. As the glass is fined, the individual bubbles are expanded by the diffusion of helium gas, adjacent bubbles coalesce into larger ones, and the relative buoyancy of the larger bubbles increases. These bubbles will then rise more rapidly and escape at the surface of the molten glass.

Helium is the only gas known that can be used effectively for the fining of glass. It is chemically inert and as a result of its molecular size, helium relative to other gases is capable of rapidly diffusing through the glass lattice. Were diffusion the sole criteria, hydrogen which diffuses through glass at a somewhat slower rate, being diatomic and larger in molecular size, might be considered as a substitute. However, the great danger of explosion resulting when hydrogen is bubbled through glass melts at elevated temperatures makes its use impractical for this purpose.

The method of “gas sparging,” where bubbles of inert gas, He, are injected into a molten salt flow, has been used to remove fission products, including volatile fluorides. In this way, ⁸⁵Kr, ¹³³Xe, and ¹³⁵Xe have been removed from FLiBe in an estimated time of 50 seconds.

Because of the low solubility of tritium gas in molten glass, immediate recovery is possible. This allows BSF to maintain a lower tritium inventory than solid lithium breeders, which recover their tritium in bulk.

### Units & Standards

All the values in the following table are written using standard scientific notation. Using standard exponential notation, a number like 123456 is written 1.23456E5, where the “E5” stands for multiplication by ten raised to the fifth power.

| | |
|---|---|
| Faraday constant | 9.6485E4 J/V or C/mol |
| Mass-Energy | (Δ energy) = 9.00E10 (Δ mass) kJ/g |
| | 1 J = 1E7 erg |
| Avogadro's number | 6.023E23 molecules/mole |
| Plank's constant (h) | 6.62606896(33) × 10⁻³⁴ J·sec |
| Boltzmann's constant (k) | 1.380E−23 J/°K |
| Van Der waals constants | The equation, P = RT/(V − b) − (a/V²), |
| | where a = .244, b = .027, and V is |
| | molar volume, is considerably better than the |
| | Ideal Gas Law for predicting the properties of |
| | H₂ gas at high pressures. |
| Force | 1 N = 1 kg m/s² |
| | 1 lb = 453.6 g |
| Pressure | 1 mmHg = 133.322 Pa |
| | 1 Pa = N/m² |
| | 1 atm = 1.01325E5 Pa |
| | 1 bar = 1E5 Pa |
| | 1 lb/in² = 6894.8 Pa |
| Temperature conv. | °K = ° C. + 273.15 |
| | 1 eV = 11604°K |
| Velocity of light | c = 2.998E8 m/s |
| Electronic charge | e = 1.602E−19 C |
| Power | 1 W = 1 J/s |
| Energy | 1 J = N × m |
| | 1 cal. = 4.184 J |
| | 1 J = 6.24E18 eV |
| Neutron mass | 1.674927 × 10⁻²⁷ kg |

### BRIEF DESCRIPTION OF THE SEVERAL VIEWS OF THE DRAWING

FIG. 1 is the conceptual layout of a BSF plant reactor, optical fiber hookups, coolant circulation paths, degassing tank & pumps, secondary sphere with piezoelectric transducers, raised cooling tank with heat exchangers, turbine generators, and other structural components. It shows how, after the coolant is lifted into the tower, gravity is used for circulation. In this way, mechanical pumps are not directly exposed to the harsh shock waves generated by the reactor. In addition, the pipes connecting the various components (sphere, degassing tank, heat exchangers, etc.) are connected in such a way (the various components might be situated on movable foundations, like the seismic isolation mounts on earthquake-proof buildings) so that thermal expansion and shock can be compensated for. Some of the features shown are inaccurate. For example, the Rankine steam cycle depicted should be replaced by the more efficient high-temperature Brayton power cycles.

FIG. 2 is a cut-away view showing how the metal sphere is situated inside of the piezoelectric sphere, and where the spiral detectors are located. It also shows several modular laser pumps and the fiber optic cables associated with them. In an actual reactor there would be more fiber optic cables, probably around one thousand, and each module would contain a single stacked laser diode array and photo-detection and control circuitry. The modules would connect to fiberoptic cables so they could transmit their laser output to the inside of the metal sphere. It might be possible to power these modules locally by using energy harvested piezoelectrically. The cables (fiber optic bundles) depicted are not to scale, as they are only estimated to be about one inch in diameter. Cable attachments made to the sphere's surface must be able to withstand tremendous stresses. One way to cope with the stress is to have the ends of the fiberoptic cables fused so that they would form durable silica plugs that could be inserted into the shafts that were drilled to let light in/out of the sphere. The ends of the cables could then be attached to the outside of the sphere using springs that would allow the plugs to function like shock absorbing pistons. This gives the connecting parts some flexure, and minimizes the jarring stress and strain that would otherwise interfere with and inhibit the sphere's natural resonance. Also shown are the large cone-shaped pipes that lead into and out from the sphere. These function as low-speed settling chambers, reducing turbulence and making the flow more laminar.

FIG. 3 is a brief, cartoon-like, descriptive overview of the BSF process, using panel artwork.

FIG. 4 is a Flow chart for a BSF plant.

FIG. 5 a graph comparing total lithium volume requirements for three types of fusion reactors.

FIG. 6 shows the Archimedean Spiral Array which is made from two thick metal plates that have a pattern of holes drilled into them. The plates are located at the top and bottom of the reactor. The tiny black dots in the figure are the apertures of holes where the end of a fiberoptic filament protrudes. Each fiber leads back to circuitry that can generate and/or detect optical pulses traveling between opposite plates.

FIG. 7 is a graph showing the reflectivity of different mirror elements vs. electromagnetic frequency. This information was used when running computer simulations of the optical conditions found inside the sphere after a gold (Au) or silver (Ag) electroplate was applied.

FIG. 8 is the probability frequency distribution that was used for the Monte Carlo simulation that modeled the reflective characteristics inside the sphere. The same distribution was used for all three (HIGH=0.0001, MEDIUM=0.001, LOW=0.01) mirror surface qualities, where the numbers are the maximum (3 standard deviation) error (deviation in gradient) values. The data from the simulation was used to make the charts in FIG. 11. The simulation estimates the effectiveness, toward retaining radiant energy, of these somewhat arbitrarily chosen finishes. Note—for comparison, the gradient of a typical reflecting telescope mirror will not deviate from a perfect sphere (parabola) by more than 0.000001, so fabricating a HI finish only requires removing surface defects having errors in gradient that are over 100 times larger than those found on a typical telescope mirror. The bottom scale is the error in surface gradient (how much the local plane of tangency of a random surface point deviates from that of a (perfect sphere) and the side scale is the likelihood of that deviation.

FIG. 9 is top down view of the metal sphere. It shows four, paired sets (F, G, H, and I) of fiberoptic bundles arranged in vertical columns. Each of the vertical, paired columns functions as one Vertical Linear Sensor Array (VLSA). An actual reactor would probably require more than the 40 fiberoptic bundles depicted here, since the VLSAs are designed to function as the primary source of laser pump energy. For example, there would be a total of 1008 fiberoptic bundles in a system having 18 VLSAs of 28 vertical elements, since 1008=2*18*28.

FIG. 10 is a vertical x-section of the metal sphere. It shows a rising bubble of fuel as it travels through the detection zone of the F-VLSA (Verticle Linear Sensor Array), causing an occultation to occur between elements F5 & F7.

FIG. 11 shows how the four different parameters (fuel size, fuel offset from the center, number of reflections, and mirror surface quality) effect the amount of radiant energy that gets reabsorbed by a hot radiating bubble of fuel located within a 5 meter radius reflective silver-plated sphere. The charts are arranged in a 3×3 array, to show that increasing the mirror surface quality increases the total amount of reabsorption and that, contrary to common sense, the probability of absorption immediately following the second reflection is several times higher than the absorption following the first reflection.

FIG. 12 is a graph showing that the ideal ignition temperature is 1.6 keV for BSF and 4.3 keV for ICF. See the section on Volume Ignition for more details.

FIGS. 13, 14 & 15 Shows points that can be detected by the spiral array at various cross-sectional depths.

FIG. 16 This is an example of a graph showing bubble size vs. rate of ascent.

FIG. 17 shows that pressure gradients control the direction of a bubble's movement. It also shows that the background pressure controls the bubble's size, which indirectly controls the bubble's speed.

FIG. 18 shows the expected blackbody radiation spectrums for a range of plausible coolant and bubble temperatures. The values plotted were calculated using Planck's equation, P_{λ}=2πhc²/λ⁵(e^{hc/λkT}−1), in standard SI units, and divided by 10¹³ to convert for (W/m² per m) into (W/cm² per nm). This graph is important to BSF for two reasons. First, it shows that the amount of blackbody radiation (which corresponds to the coolant temperature) inside the laser cavity is not significant toward triggering laser amplification, since the intensity of blackbody radiation occurring at the laser frequency is much less than the lasing threshold. Second, it shows that temperatures inside the compressed bubble would be sufficiently hot to cause a significant levels of blackbody radiation at the laser frequency, enough to trigger a laser amplification cascade.

FIG. 19 is a chart of Binding Energies vs. Mass Number.

FIG. 20 is a graph depicting the Strong Nuclear Force.

FIG. 21 is a map of Stable Isotopes.

FIG. 22 is a graph of Fusion Rates for various fuels.

FIG. 23 is a chart constructed using simulation data for a 5 meter silver-plated (92% reflectivity) sphere. It is based on the fraction of light that returns to the fuel after two bounces when the inside surface of the metal sphere has a “MEDIUM” surface quality finish. Each bar of this 60 bar chart corresponds to a 50,000 trial Monte Carlo simulation. Each trial tracks one randomly directed ray of light coming from a random location on the fuel's surface, and follows it until it gets absorbed (by either the mirror or fuel) or times-out. Each time the ray encounters the mirror's surface, a random number is generated to determine the chance of it being absorbed and/or how much deviation to add to the ray's angle of reflection.

FIG. 24 is a graph showing the relationship between the incident laser intensity and the fraction of light that is absorbed by the fuel for a variety of wavelengths. The most interesting trend is that absorption increases with decreasing laser intensity, so that a long, low-intensity pulse would be the most efficient method of supplying energy to the target.

FIG. 25 is a chart showing the final phase of a bubble implosion, covering only the last 200 ns. The acoustical compression that precedes this might last several hundred microseconds, depending on bubble size and pressure.

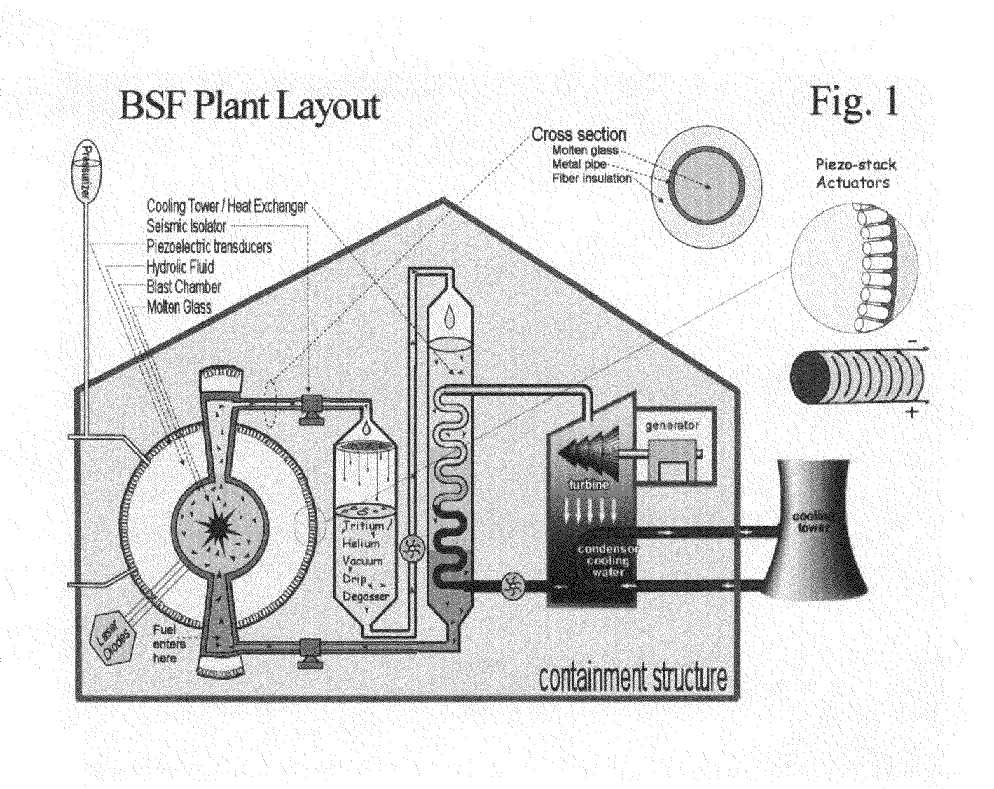

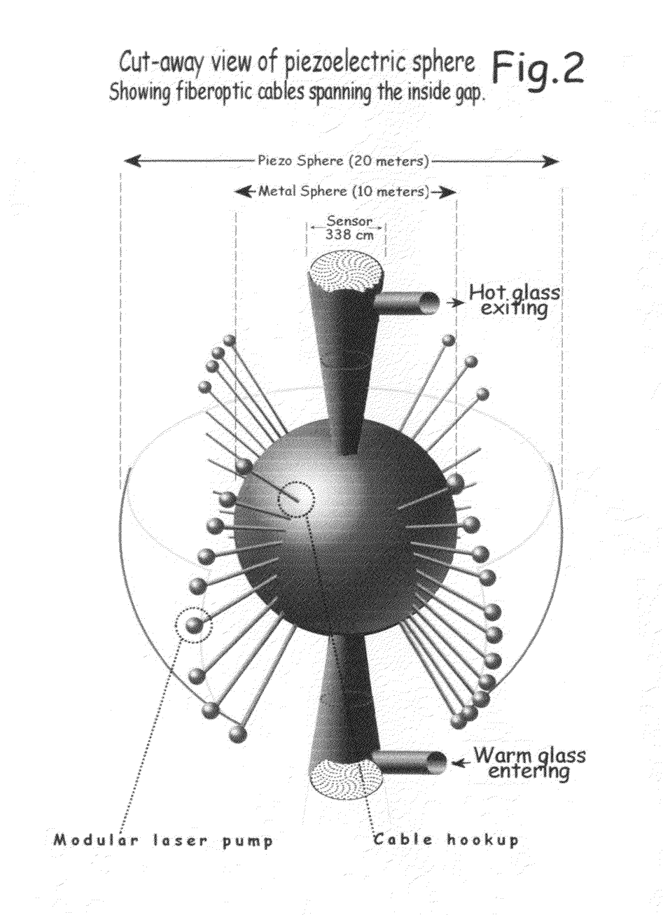

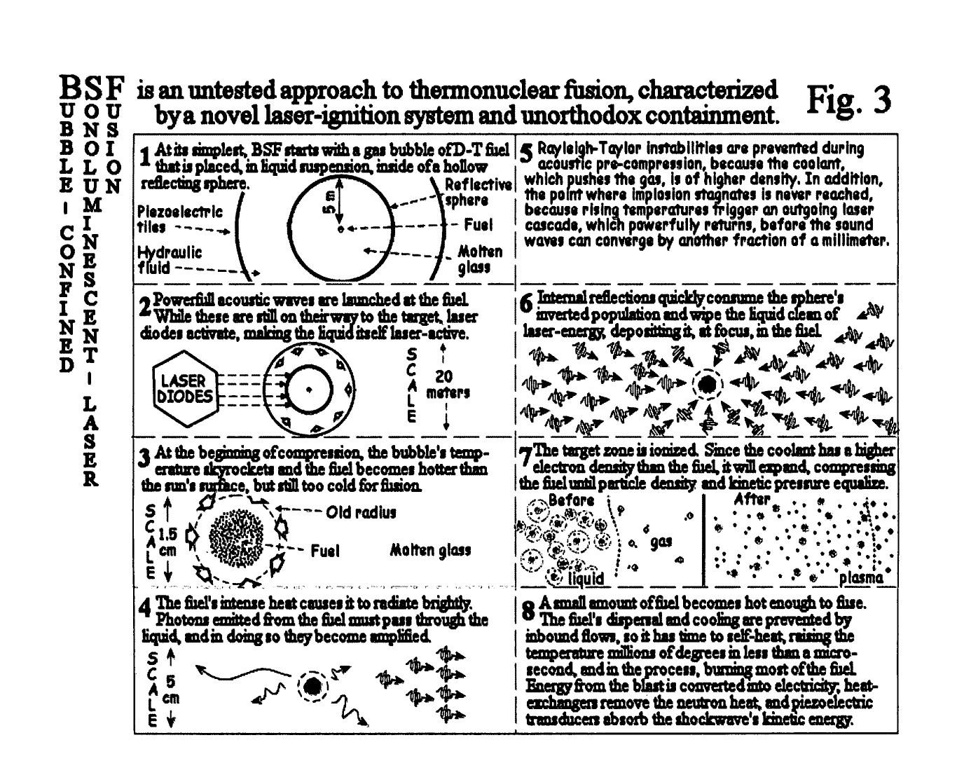

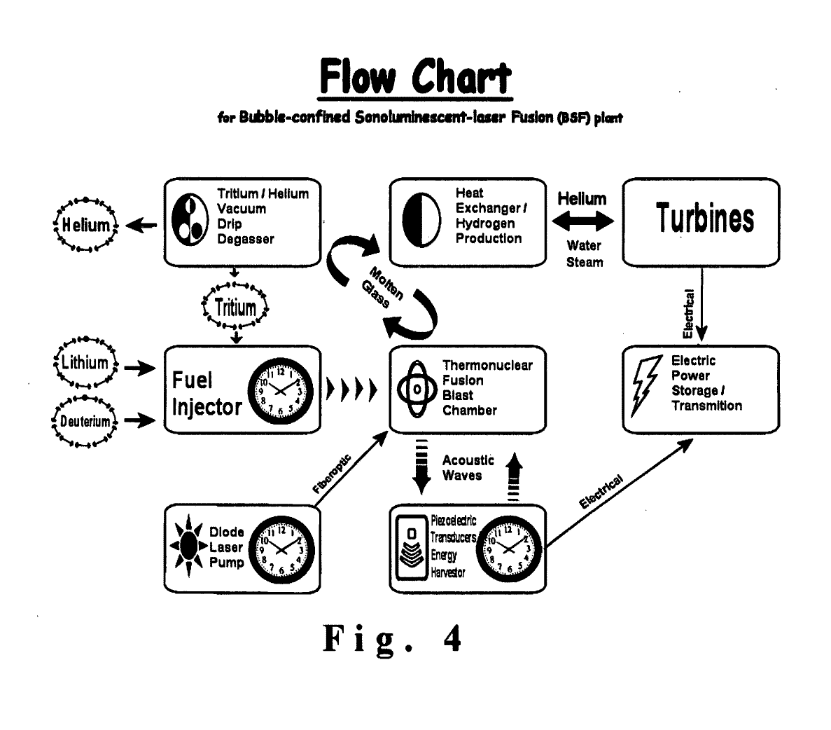

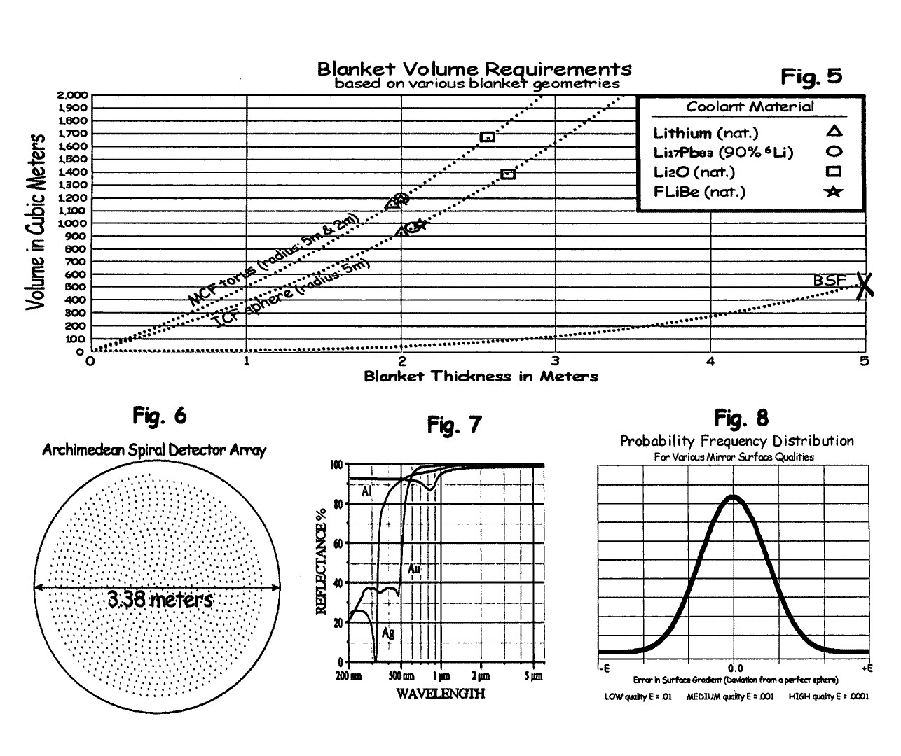

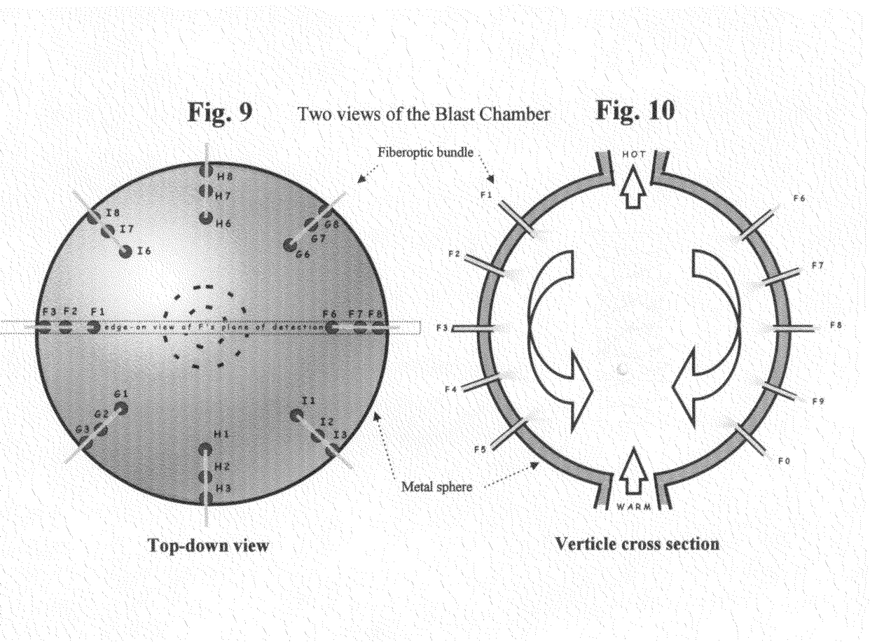

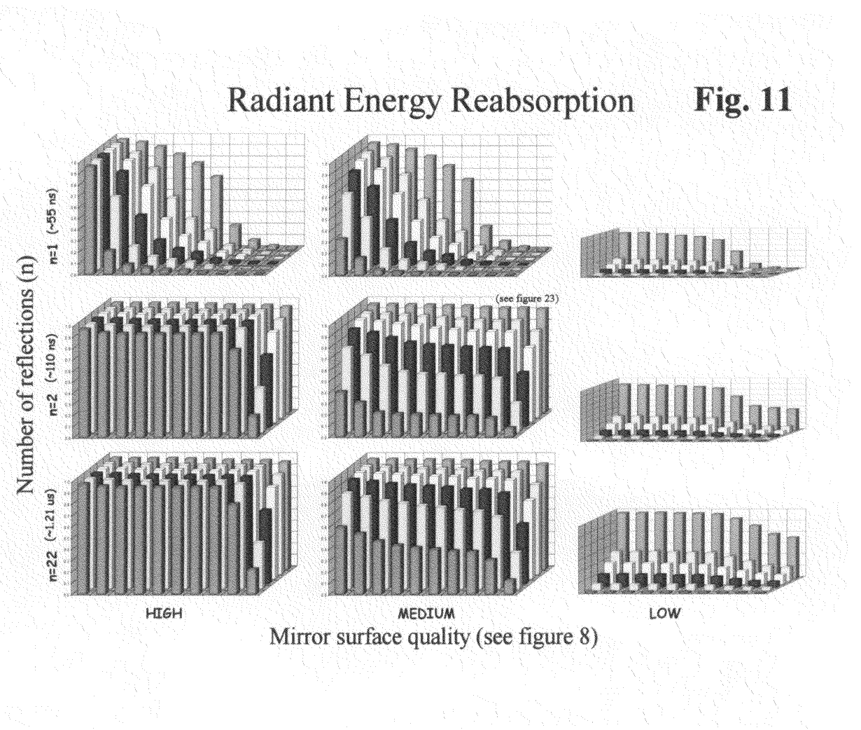

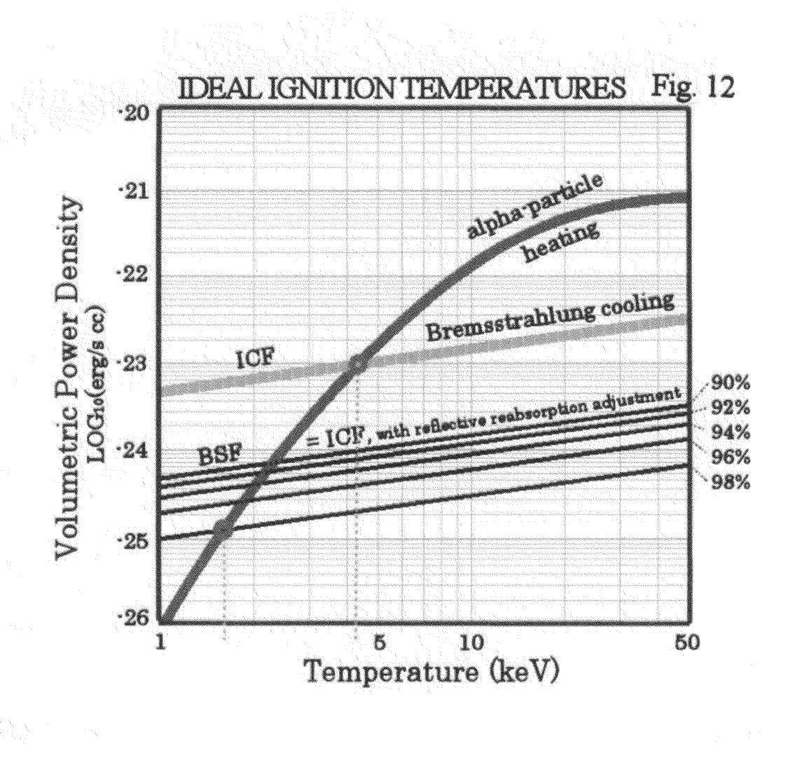

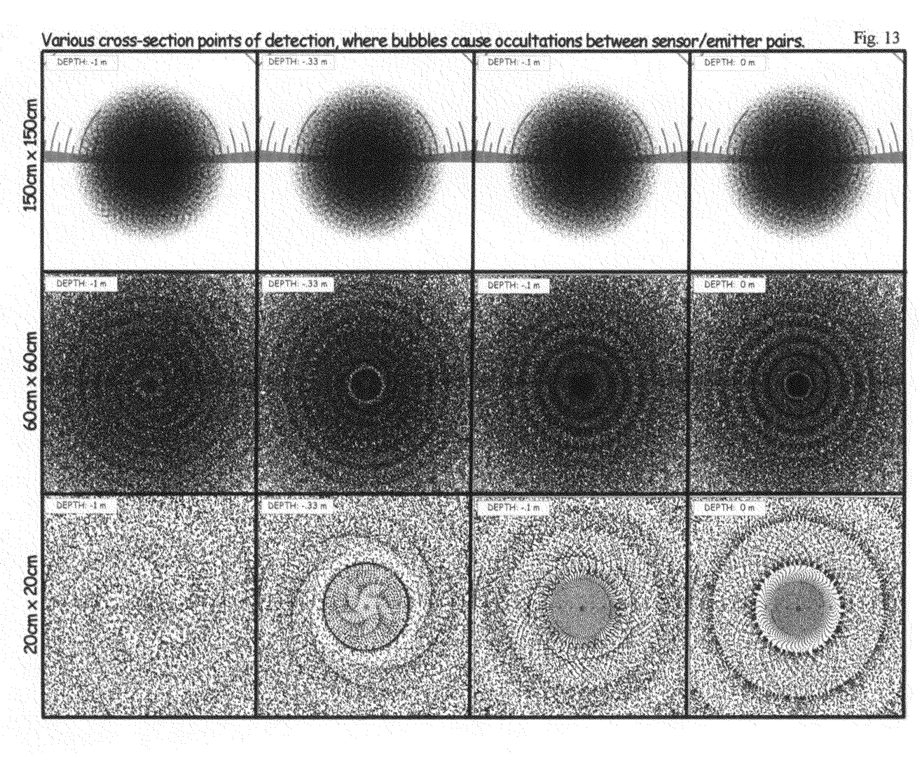

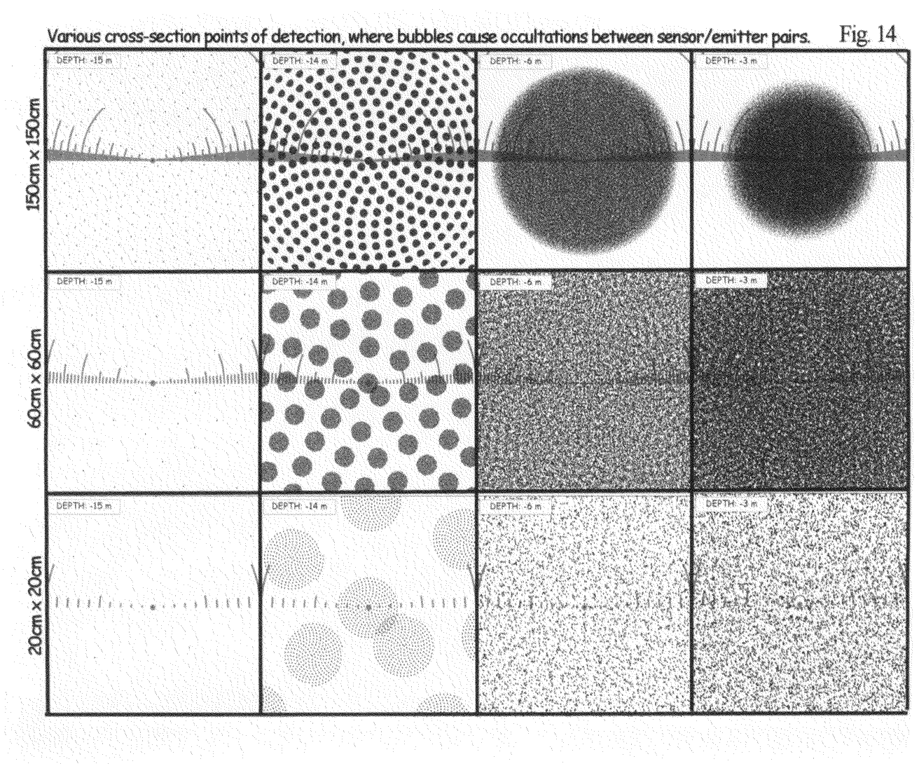

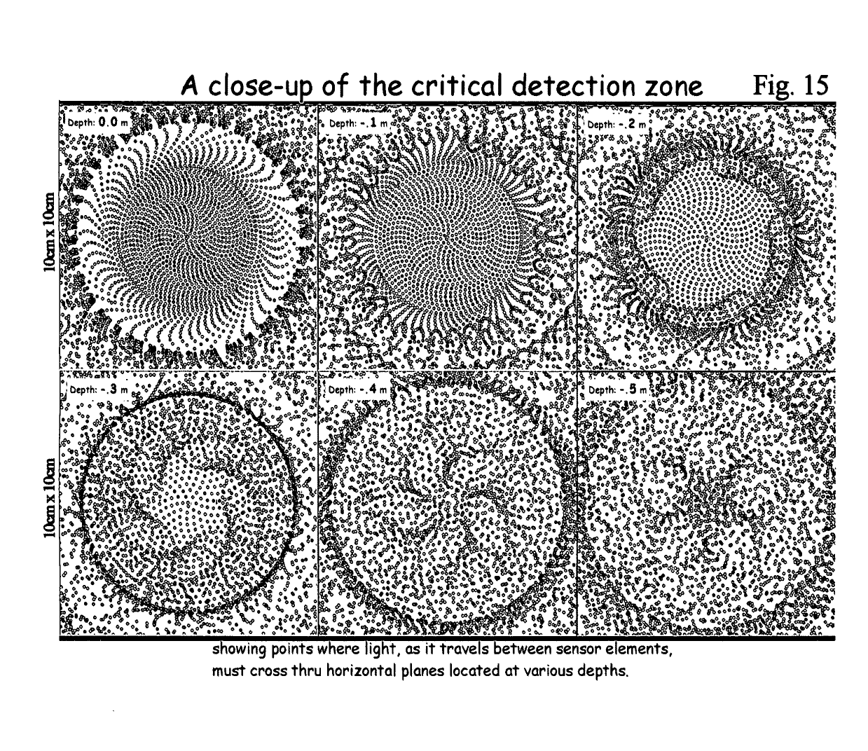

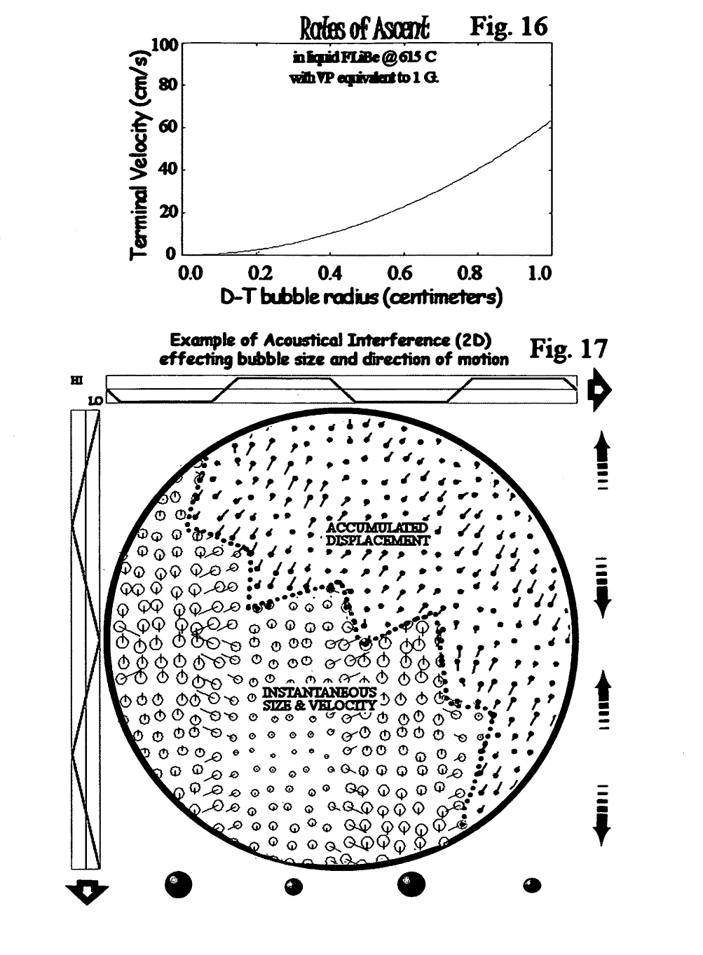

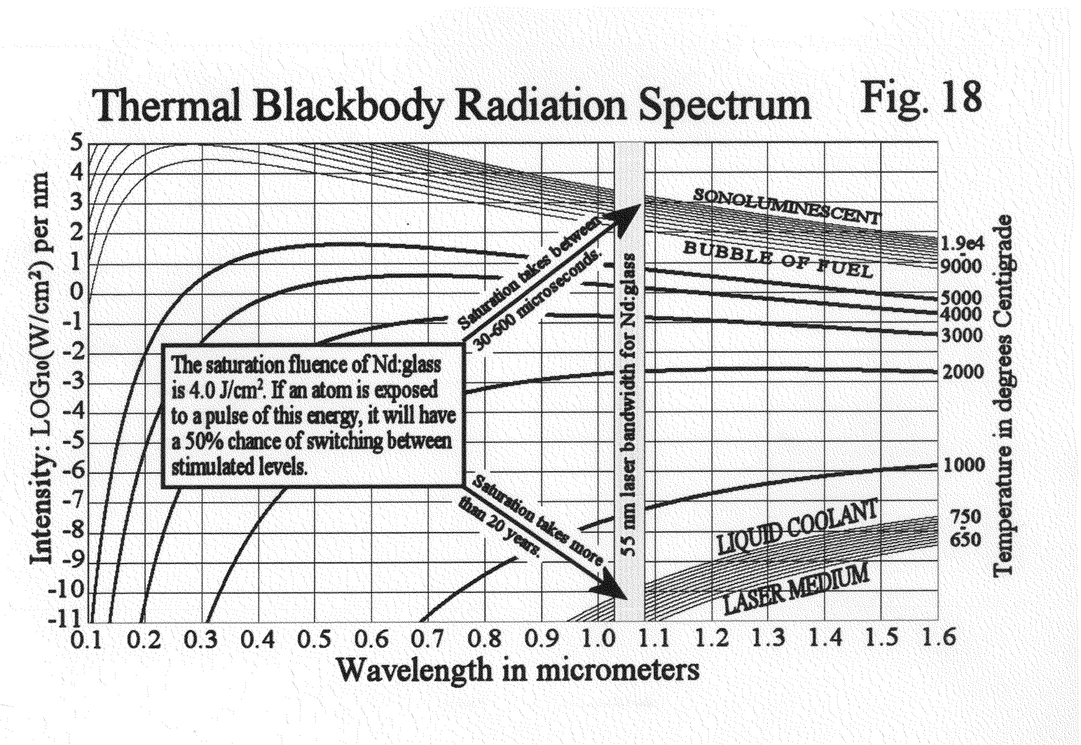

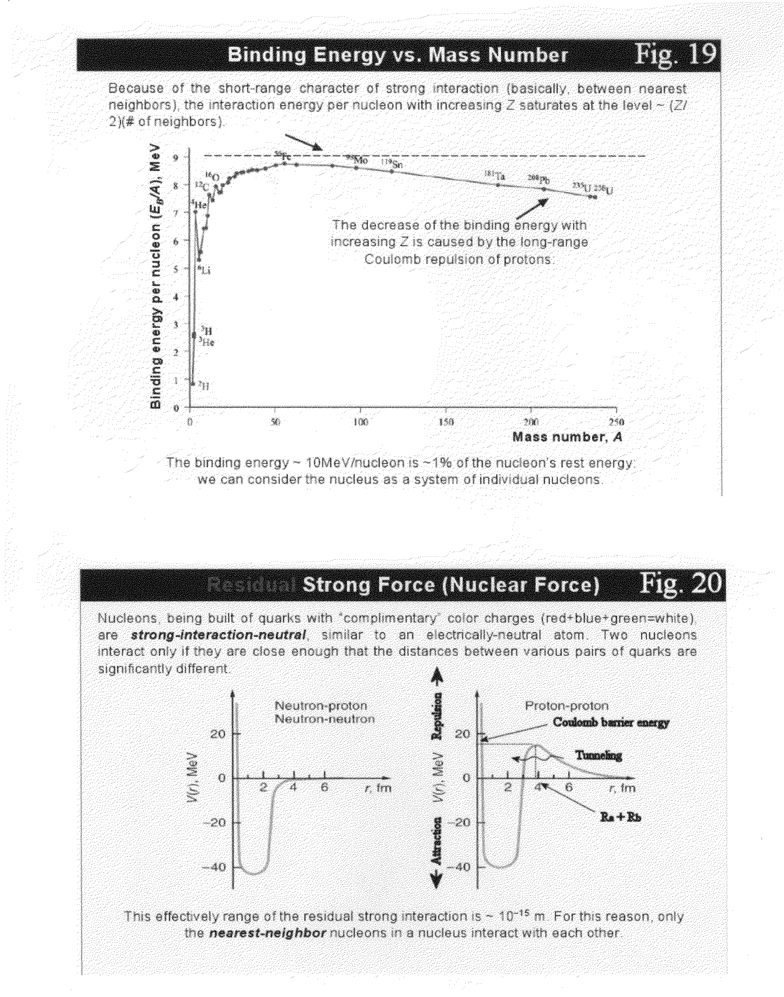

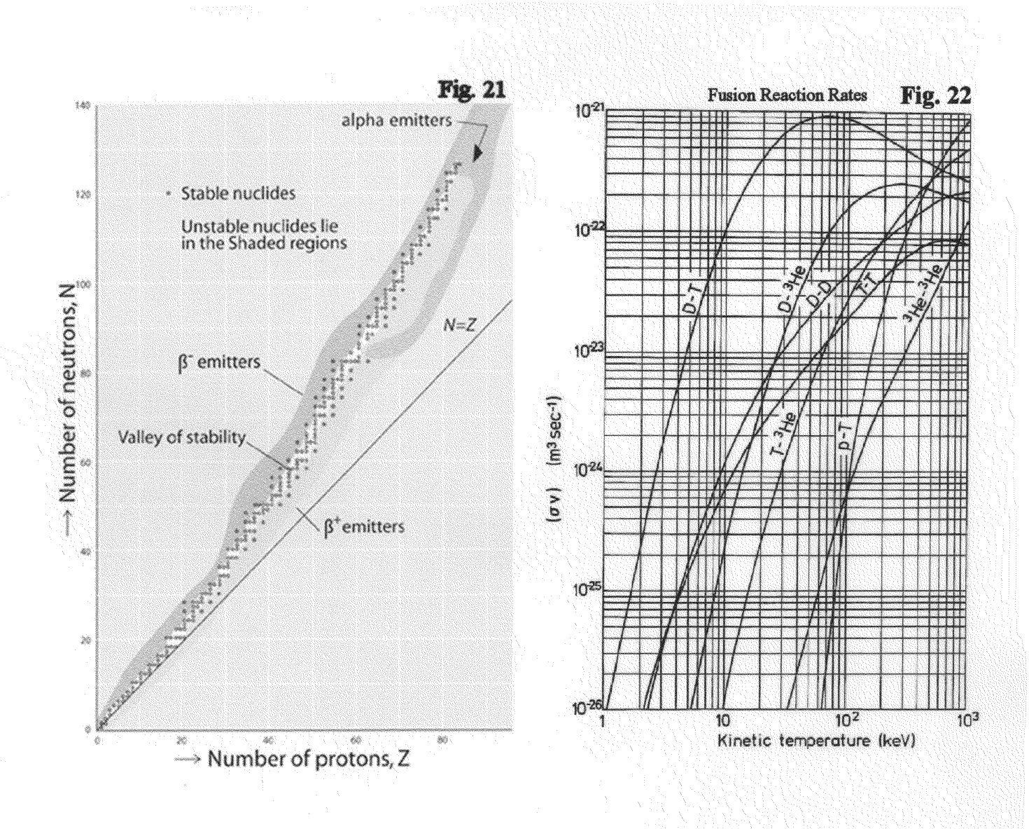

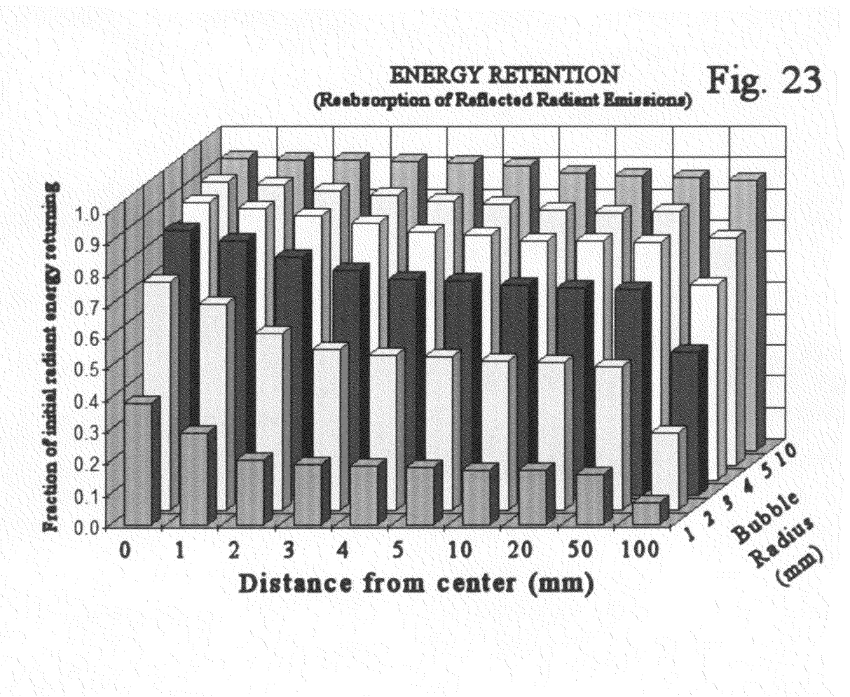

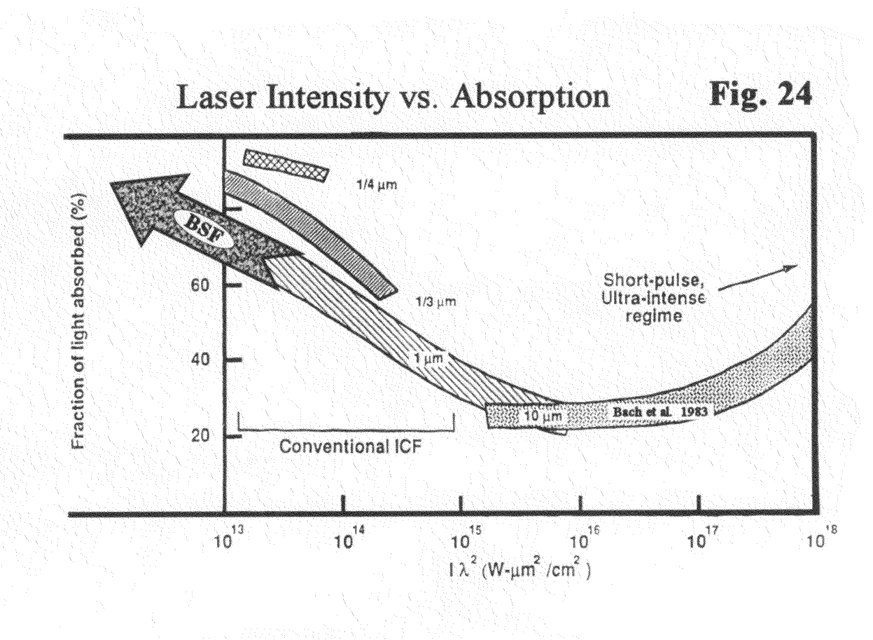

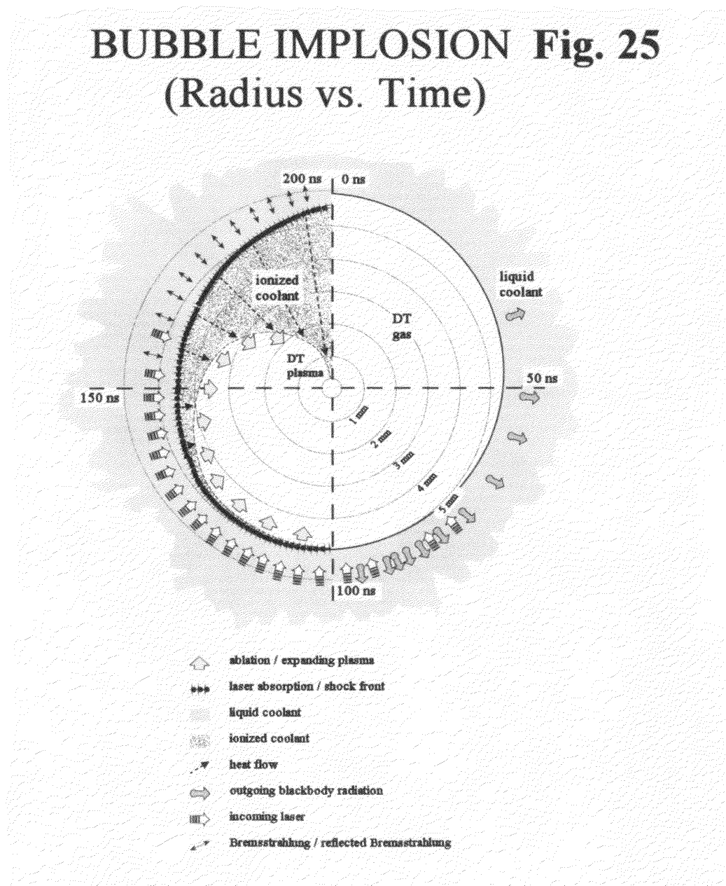

### DESCRIPTION OF THE PREFERRED EMBODIMENTS

Throughout this disclosure I've tried to stay consistent, using a single embodiment example. The primary role this served was to make explanations and calculations easier, it was not meant to imply that the details specified in that embodiment were necessary, optimal, or otherwise preferred.

Some of the details given in my examples of BSF were not optimal, for example, a glass mixture was specified for use as the coolant, but it is more likely that some other liquid satisfying all the appropriate characteristics would function better. Some other examples that might improve performance are that a swarm of tiny bubbles might work just as effectively as one big bubble, the firing rate could be increased significantly by using faster coolant circulation, and the reactor size can be scaled up or down depending on the intended power production capacity.

I have not calculated a preferred embodiment for BSF, but I believe that, in theory, a set of optimal parameters can be calculated using a computer program. To do this, the program would first have to assign numerical values to every trade-off option. These numerical values are critical for making quantitative evaluations. Unfortunately, only a few of these parameters have been numerically quantified and are readily available; some can only be accessed using high-priced or high-security databases, while others must await future experimental results.

I claim:

1. A device for generating fusion energy comprising:
a.) spherical inner chamber
I. with a reflective interior surface, for the purpose of preventing heat loss and lowering the temperature in which ignition occurs
II. with provisions for pumping electromagnetic radiation inside the chamber, so that the fluid inside can be used as a laser gain medium and also for the purpose of optically tracking the fuel
b.) spherical outer chamber
I. surrounding the inner chamber
II. with provisions for acoustic & electric transduction, enabling pre-ignition movement and compression of the fuel and also enabling post-ignition harvesting of the blast's kinetic energy
c.) space between the two chambers
I. filled with a fluid
i. that is an acoustical medium
ii. that cools the inner chamber
d.) space inside the inner chamber
I. filled with a fluid that
i. circulates as an efficient high-temperature coolant
ii. encapsulates gaseous fusible fuel inside of a bubble
iii. is transparent to selected electromagnetic frequencies
iv. is a laser gain medium that can amplify selected frequencies, so that the inner chamber can function as a spherical laser cavity
v. is an acoustical medium, enabling fuel transport and compression
vi. blocks x-rays, preventing damage to the chamber walls
vii. absorbs neutrons, preventing the escape of hazardous radiation
viii. breeds tritium, replenishing the supply of easily ignitable fuel
ix. slows fuel dispersion during combustion, increasing burn-up fraction

2. A method applying to the device according to claim 1 where said method accurately determines the location of a bubble using the technique of multi-occultation triangulation.

3. A method applying to the device according to claim 1 where said method is used to move a bubble by manipulating the pressure in its local environment, based on the ideas that
a.) a bubble's size is determined by the background pressure
b.) a bubble's direction of motion coincides with the buoyant force and is determined by the pressure gradient
c.) the interplay between the buoyancy force and drag force causes large bubbles to move faster than small bubbles when subjected to the same pressure gradient
d.) fluctuations in the background pressure can be synchronized with fluctuations in the pressure gradient, so that, even though the bubble is pulsating backwards and forwards in tiny steps, large overall displacements can be accumulated.

4. A method applying to the device according to claim 1 where said method causes thermonuclear ignition in a bubble of fuel, comprising
a.) positioning the fuel at the focus of a spherical laser cavity so that
i.) the fuel will not be able to effectively cool by radiating away light
ii.) the reactors structural components are well shielded from the explosion, making larger yields and higher gains possible
b.) making the cavity laser-active, by pumping it with enough light to cause an upper-state population inversion
c.) squeezing the fuel, so that
i.) the fuel becomes hot and radiates brightly (sonoluminescence)
ii.) the fuel's radiation creates an outgoing laser cascade
iii.) the fuel is in a state of pre-compression when the cascade returns
iv.) the fuel is further heated and compressed by the powerful laser effect
d.) containing (preventing dispersion of) the fuel, so that
i.) the fuel can self-heat, lowering the energy required for drivers
ii.) a greater fraction of the fuel gets burnt, increasing the gain
iii.) low-temperature volume ignition is possible
